(19) United States
(12) Patent Application Publication
(10) Pub. No.: US 2024/0334867 A1
(43) Pub. Date: Oct. 10, 2024

(54) HEIGHT POSITIONING AND ADJUSTMENT SYSTEM FOR AN AGRICULTURAL IMPLEMENT

(71) Applicant: HONEY BEE MANUFACTURING LTD., Frontier (CA)

(72) Inventors: Glenn Raymond HONEY, Bracken (CA); Lee Glenn HARPER, Shaunavon (CA); Barry LINDMARK, Coronation (CA)

(21) Appl. No.: 18/749,351

(22) Filed: Jun. 20, 2024

Related U.S. Application Data
(63) Continuation-in-part of application No. 18/088,465, filed on Dec. 23, 2022.

(51) Int. Cl. A01D 34/24; A01D 34/00; A01D 34/04; A01D 34/40

(52) U.S. Cl. CPC A01D 34/246; A01D 34/006; A01D 34/04; A01D 34/40

(57) ABSTRACT

An agricultural implement comprises: a main frame, an operational unit interconnected to the main frame, and a height adjustment apparatus interconnected to the main frame and the operational unit. The height adjustment apparatus comprises a terrain contact element that can be positioned to contact a terrain surface such that the contact element supports the operational unit at a vertical separation distance of the operational unit above the terrain surface. The height adjustment apparatus can adjust the vertical separation distance of the operational unit above the terrain surface. A shock absorbing assembly is operationally positioned between the main frame and the terrain contact element and provides for resilient deformation in response to forces transmitted during operation to the terrain contact element, from contact with the terrain surface. The shock absorbing assembly may absorb and/or cushion forces imparted to a component of the height adjustment apparatus.

### CROSS-REFERENCE TO RELATED APPLICATION

This application is a continuation-in-part of U.S. patent application Ser. No. 18/088,465 filed on Dec. 23, 2022. The contents of the aforementioned application are incorporated by reference herein.

### TECHNICAL FIELD

This invention relates generally to height positioning and adjustment systems for agricultural implements, including in particular for agricultural implements used for harvesting crops.

### BACKGROUND

Some types of known harvesting equipment employ harvesting headers to cut crops for various purposes, such as for windrowing or swathing, or for the feeding of a combine harvester.

Attached to or forming part of the front/forward portion of a combine harvester or other equipment (such as for example a swather) is the portion that is referred to as the header. A typical header may include a support frame equipped with a crop cutting system. The header may also include a crop moving system such as an auger or a conveyor deck/surface located behind the cutting system onto which cut crop material can be deposited to be moved to for example to a windrow discharge or into the intake of a combine. The header may also include a reel which has a reel shaft mounted between rotational mounts at either end of the header with a rotational power drive interconnected thereto. The reel typically has rotating bats having fingers/tines attached thereto. Rotation of the bats assists in moving standing crop material toward the cutting system, so the crop material can be cut, and then the cut crop material is deposited on the crop moving system.

Some agricultural implements such as headers also have cutter bars which provide the implement with the ability to cut a crop as the implement is moved across a crop field. The cutter bar may have a plurality of cutting blades/devices and extend transversely across the width of the header, and the cutter bar may be interconnected to the main frame of the header. The ability to cut the crop material close to the terrain surface may be particularly important in cutting certain types of crops like pulse crops which include chickpeas, peas, and lentils which have seed pods that mature close to, or within a couple of inches above the terrain surface. In other crop situations, it is desirable to cut the crop a fixed distance above the terrain surface, the distance may depend in part upon the type and condition of the crop. For example, it may be desirable for the cutter bar to be maintained at a fixed distance from the terrain surface, while still remaining relatively close to the terrain surface, for example to leave a stubble of crop behind which may assist in reducing soil erosion. Accurate control of the height of the cutter bar relative to the terrain surface/crops may result in higher crop yields for harvesting. Therefore, controlling the position of the cutting blades above the terrain surface is typically important.

In some cases, as the implement moves across a field during operation, the cutter bar may, at least in some modes of operation, rest on the terrain surface and float with the rest of the implement over the terrain surface. While some cutter bars are mounted to the main frame of the header in a fixed or rigid manner and do not, during operation, move upwards and downwards relative to the supporting implement framework to which it is attached, other systems are operable to permit the cutter bar to be able to move vertically upwards and downwards relative to the supporting framework of the header during operation.

It may be challenging to maintain the cutter bar at a fixed distance/position from the terrain surface due to variations in the terrain surface (for example localized higher or lower regions of the terrain surface). With the cutter bar raised off the terrain, the height of the cutter bar may be affected by any wheels or other terrain contacting components on the header or propulsion unit, which raise or lower the header and possibly also the cutter bar relative to the terrain. This could lead to inconsistent cutting heights and/or to the cutter bar being exposed to impacts with the terrain that could lead to premature wear or failure.

Known cutting systems also typically include one or more protection plates (often referred to as “skid shoes”) that are mounted and positioned beneath a cutter bar the cutting blades and may provide some degree of wear protection for the cutter bar and the cutting blades of a cutting system. This is of particular importance when the cutter bar is extended periods of contact with the terrain surface during operation.

It is desirable to improve on the design of such agricultural implements.

### SUMMARY

In an embodiment, an agricultural apparatus comprises: a propulsion unit and an implement connected to the propulsion unit. The implement comprises: (i) a main frame having a main frame weight, the propulsion unit configured and operable to support at least a portion of the main frame weight; (ii) an operational unit; (iii) a unit support apparatus configured to interconnect the operational unit to the main frame; (iv) a height adjustment apparatus comprising at least one terrain contact element, the height adjustment apparatus connected to the unit support apparatus, the at least one terrain contact element operable to be positioned to contact the terrain surface level at a terrain contact element contact region such that the at least one terrain contact element supports the unit support apparatus at a vertical separation distance of the unit support apparatus above the terrain surface. The height adjustment apparatus is operable to adjust the vertical separation distance of the unit support apparatus above the terrain surface, and thereby adjust the position of the operational unit to adjust a vertical separation distance of the operational unit above the terrain surface.

The main frame may be generally transversely extending, and the operational unit may be generally transversely extending. The unit support apparatus has a weight, and the operational unit has a weight, and wherein during operation in a flex mode of operation, the terrain surface may support a portion of the weight of the operational unit and a portion of the weight of the unit support apparatus. During operation in a flex mode of operation, the unit support apparatus may support a portion of the weight of the operational unit. In a flex mode, the unit support apparatus may facilitate the operational unit to move upwards and downwards relative to the main frame. In a flex mode of operation, a portion of the weight of the operational unit and a portion of the weight of the unit support apparatus may be supported with a spring device operationally interconnected to the unit support apparatus. During the upwards and downwards movement of the operational unit relative to the main frame, the spring device may provide a counter-acting force to counter-act a portion of the weight of the operational unit and a portion of the weight of the unit support apparatus. During a range of upwards and downwards movement of the operational unit relative to the main frame, the spring device may provide a substantially constant counter-acting force to counter a portion of the weight of the operational unit and a portion of the weight of the unit support apparatus.

The operational unit may have an operational unit terrain contact region, and wherein the height adjustment apparatus may be operable to adjust the vertical separation distance of the unit support apparatus above the terrain surface, and thereby adjust the position of the operational unit to adjust a vertical separation distance between the operational unit terrain contact region of the operational unit and the terrain surface.

The operational unit may comprise a transversely extending cutter bar, and the cutter bar may comprise a plurality of cutting devices disposed transversely along the cutter bar and operable for cutting crop material. The operational unit support apparatus may comprise a cutter bar support apparatus configured to interconnect the transversely extending cutter bar to the main frame and permit upward and downward movement of the cutter bar relative to the main frame; and the height adjustment apparatus may be operable to adjust the magnitude of the vertical separation distance between the cutter bar support apparatus and the terrain surface and thereby adjust the vertical separation distance between the cutter bar and the terrain surface. The cutter bar support apparatus may be configured and operable to permit for upwards and downwards movement of the cutter bar relative to the main frame during operation of the agricultural apparatus when cutting a crop material.

During operation of the agricultural apparatus in cutting crop material such that the propulsion unit and the agricultural implement move over the terrain surface, the at least one terrain contact element of the height adjustment apparatus may be configured and operable for upwards and downwards movement relative to the main frame in synchronized upwards and downwards movement with the cutter bar.

The height adjustment apparatus may be operable to adjust the height of the terrain contact element of the height adjustment apparatus such that the terrain contact element of the height adjustment apparatus establishes a minimum cutter bar separation distance extending between the cutter bar and the terrain surface beneath the cutter bar. The terrain element contact region of the at least one terrain contact element of the height adjustment apparatus may be located longitudinally proximate to the cutter bar and may be located longitudinally behind the cutter bar.

The unit support apparatus may comprise a plurality of transversely spaced, longitudinally oriented paddles, each of the paddles being rigidly interconnected to the transversely extending cutter bar proximate a forward end region of each of the paddles and pivotally interconnected to the main frame proximate an inward end region of each of the paddles.

The height adjustment apparatus may comprise a plurality of terrain contact assemblies each of the terrain contact assemblies mounted to one of the paddles and each of the terrain contact assemblies having a terrain contact element, the terrain contact element of each of the plurality of terrain contact assemblies being transversely spaced and being interconnected to a respective one of the plurality of paddles, and each of the terrain contact elements of the plurality of terrain contact assemblies operable to be positioned by the height adjustment apparatus at a level below the cutter bar at transversely spaced locations, such that each terrain contact element of the plurality of terrain contact elements can be positioned to contact the terrain surface at a level beneath the cutter bar.

The height adjustment apparatus is operable to set the position of each of the plurality of terrain engaging elements below the cutter bar at transversely spaced locations, to establish a minimum cutter bar separation distance extending between the cutter bar and the terrain surface beneath the cutter bar across substantially the entire transverse width of the cutter bar.

The unit support apparatus may be pivotally connected to the main frame and fixedly connected to the operational unit. The unit support apparatus may comprise a plurality of transversely spaced and longitudinally extending paddles which are pivotally interconnected to the main frame, and wherein the at least one terrain contact element comprises a plurality of terrain contact elements, and wherein each of the plurality of terrain contact elements may be at least partially mounted on a paddle of the plurality of paddles. Each terrain contact element of the plurality of terrain contact elements may be at least partially mounted on the operational unit. The plurality of terrain contact elements may be transversely spaced across the operational unit. Each of the plurality terrain contact elements is pivotally connected to the operational unit.

The height adjustment apparatus may comprise a plurality of linkages, and wherein each linkage of the plurality of linkages is mounted to a respective one of the paddles, each linkage of the plurality of linkages may be operable to support and facilitate upwards and downwards movement of each terrain engaging element relative to its respective paddle. The height adjustment apparatus may further comprise a plurality of actuators, an actuator of each of the plurality of actuators being operably interconnected to each linkage and the terrain engaging element, each actuator operable to adjust the vertical position of each respective terrain engaging element, to adjust the vertical separation distance between the operational unit and the terrain surface beneath operational unit. Each of the actuators may be a hydraulic fluid cylinder that forms part of a height adjustment hydraulic fluid control and supply system. The height adjustment hydraulic fluid control and supply system circuit may be fluidly interconnected to a bi-directional hydraulic fluid circuit of the propulsion unit and the implement. The bi-directional hydraulic fluid circuit of the propulsion unit and the implement may comprise a hydraulic fluid supply and control system operable to move a reel of the agricultural apparatus in a forward direction and an aft direction.

The implement and the propulsion unit are configured and operable for upwards and downwards movement of the main frame of the implement relative to the propulsion unit.

The apparatus may comprise a frame height positioning system operable to control and adjust the height of the main frame relative to the propulsion unit. The apparatus may further comprise a sensor system operable to provide signals to the frame height positioning system indicative of the height of the operational unit above the terrain surface.

The operational unit is a transversely extending cutter bar and the unit support apparatus comprises a plurality of transversely spaced, longitudinally oriented paddles, each of the paddles being rigidly interconnected to the transversely extending cutter bar proximate a forward end region of each of the paddles and pivotally interconnected to the main frame proximate an inward end region of each of the paddles; and wherein the sensor signals are dependent upon the pivot angle of the paddles relative to a component of the main frame. The frame height positioning system may be calibrated using the sensor system. A height set point is established by the frame height positioning system and the frame height positioning system may be operable to adjust the height of the main frame relative to the propulsion unit to seek the height set point. Operation of the height adjustment apparatus may not influence the frame height positioning system in operating to seek the height set point. The operation of the height adjustment apparatus may have the effect of artificially adjusting the level of the terrain surface beneath the operational unit.

The apparatus may further comprise a pneumatic system comprising a plurality of pressurized cutter bar float gas bags that may be spaced transversely along the cutter bar. Each of the plurality of paddles may comprise a pivot mechanism comprising a pivot arm mounted for pivotal movement relative to the main frame; wherein each the cutter bar float gas bag may be mounted between the paddle device and a component of the main frame, wherein during a flex mode of operation the plurality of cutter bar float air bags may be pressurized to a first pressure such when the cutter bar is subjected to a downwardly directed force, the pivot arm pivots upward compressing the cutter bar float gas bag to compress the cutter bar gas bag thereby permitting flexing of the cutter bar in at least a region relative to the main frame.

The apparatus may further comprise a hydraulic fluid supply and control system operable to actuate the height adjustment apparatus to adjust the vertical separation distance of the unit support apparatus above the terrain surface.

In another embodiment, an agricultural implement for use with a propulsion unit is disclosed, the agricultural implement configured to be connected to the propulsion unit. The agricultural implement comprises: a main frame having a main frame weight, the propulsion unit configured and operable to support at least a portion of the main frame weight; an operational unit; a unit support apparatus configured to interconnect the operational unit to the main frame; and a height adjustment apparatus comprising at least one terrain contact element, the height adjustment apparatus connected to the unit support apparatus, the at least one terrain contact element operable to be positioned to contact the terrain surface level at a terrain contact element contact region such that the at least one terrain contact element supports the unit support apparatus at a vertical separation distance of the unit support apparatus above the terrain surface, the height adjustment apparatus being operable to adjust the vertical separation distance of the unit support apparatus above the terrain surface, and thereby adjust the position of the operational unit to adjust a vertical separation distance of the operational unit above the terrain surface.

In another embodiment, an agricultural apparatus comprises: a propulsion unit; an implement connected to the propulsion unit. The implement comprises: a main frame having a main frame weight, the propulsion unit configured and operable to support at least a portion of the main frame weight; an operational unit; a unit support apparatus configured to interconnect the operational unit to the main frame; and a height adjustment apparatus comprising at least one terrain contact element, the height adjustment apparatus connected to the unit support apparatus, the at least one terrain contact element operable to be positioned to contact the terrain surface level at a terrain contact element contact region such that the at least one terrain contact element supports the unit support apparatus at a first vertical separation distance of the unit support apparatus above the terrain surface and supports the operational unit at a second vertical separation distance above the terrain surface, the height adjustment apparatus being operable to adjust the first vertical separation distance of the unit support apparatus above the terrain surface, and thereby adjust the position of the operational unit to adjust the second vertical separation distance of the operational unit above the terrain surface.

In another embodiment, a method of operating an agricultural apparatus is disclosed. The agricultural apparatus comprises: a propulsion unit; an implement connected to the propulsion unit. The implement comprises: a main frame having a main frame weight, the propulsion unit configured and operable to support at least a portion of the main frame weight; an operational unit; a unit support apparatus configured to interconnect the operational unit to the main frame; and a height adjustment apparatus comprising at least one terrain contact element. The height adjustment apparatus is connected to the unit support apparatus, the at least one terrain contact element is operable to be positioned to contact the terrain surface level at a terrain contact element contact region such that the at least one terrain contact element supports the unit support apparatus at a vertical separation distance of the unit support apparatus above the terrain surface, the height adjustment apparatus being operable to adjust the vertical separation distance of the unit support apparatus above the terrain surface, and thereby adjust the position of the operational unit to adjust a vertical separation distance of the operational unit above the terrain surface. The method comprises operating the height adjustment apparatus to vary the vertical separation distance between the unit support apparatus above the terrain surface and thereby adjust a vertical separation distance between the operational unit and the terrain surface. The apparatus may further comprise a frame height positioning system operable to control and adjust the height of the main frame relative to the propulsion unit. The method may further comprise operating the frame height positioning system and the height adjustment apparatus contemporaneously. The operation of the height adjustment apparatus may have the effect of artificially adjusting the level of the terrain surface beneath the operational unit.

In another embodiment, an agricultural apparatus comprises a propulsion unit and an implement mounted on the propulsion unit. The e implement comprises: a main frame having a main frame weight, the propulsion unit configured and operable to support at least a portion of the main frame weight; a terrain surface following apparatus comprising at least one terrain contact element having at least one terrain contact region, the terrain contact element being forced towards the terrain surface; and a height adjustment apparatus comprising at least one terrain contact element, the at least one terrain contact element of the height adjustment apparatus having a terrain contact region operable to be positioned to contact the terrain surface level at a terrain contact location such that the terrain contact element of the height adjustment apparatus is operable to support the terrain contact element such that the least one terrain contact region of the terrain following apparatus is positioned at a vertical separation distance above the terrain surface, the height adjustment apparatus operable to adjust the magnitude of the vertical separation distance; and a frame height positioning system operable to control and adjust the height of the main frame relative to the propulsion unit; and a sensor system operable to provide sensor signals to the frame height positioning system dependent upon a position of the terrain contact element of the terrain surface following apparatus and indicative of the level of the terrain surface. The apparatus is operable: to determine a height set point for the frame height positioning system; using the height adjustment apparatus, adjust the position of the terrain contact element of the height adjustment apparatus in relation to the terrain surface such that the terrain contact region of the terrain contact element of the height adjustment apparatus follows the level of the terrain surface and the at least one terrain contact element region of the terrain following apparatus follows a path vertically offset from and above the path of the terrain contact element region of the height adjustment apparatus. At least one terrain surface following apparatus may comprise at least one transversely spaced, longitudinally oriented paddle, the at least one of paddle being rigidly interconnected to a transversely extending cutter bar proximate a forward end region and pivotally interconnected to the main frame proximate a rearward end region.

The sensor signals may be dependent upon a pivot angle of the at least one paddle relative to a component of the main frame. The paddle may be pivotally interconnected to the main frame proximate an interior end region. The terrain surface following apparatus may further comprise the at least one paddle having a paddle contact element.

In another embodiment, a method of operating an agricultural apparatus is disclosed. The agricultural apparatus comprises: a propulsion unit; an implement mounted on the propulsion unit. The implement comprises: a main frame having a main frame weight, the propulsion unit configured and operable to support at least a portion of the main frame weight; a terrain surface following apparatus comprising at least one terrain contact element; a height adjustment apparatus comprising at least one terrain contact element, the at least one terrain contact element of the height adjustment apparatus operable to be positioned to contact the terrain surface level at a terrain contact location such that the terrain contact element of the height adjustment apparatus is operable to support the terrain contact element such that the least one terrain contact region is positioned at a vertical separation distance above the terrain surface, the height adjustment apparatus operable to adjust the magnitude of the vertical separation distance; a frame height positioning system operable to control and adjust the height of the main frame relative to the propulsion unit; and a sensor system operable to provide sensor signals to the frame height positioning system dependent upon a position of the terrain contact element of the terrain following apparatus and indicative of the level of the terrain surface. The method comprises: (I) establishing a height set point for the frame height positioning system of the position of the main frame relative to the propulsion unit; (II) after having established the set point, then using the height adjustment apparatus to adjust the height of the terrain contact region of the terrain contact element of the height adjustment apparatus above the terrain surface such that the terrain contact region of the terrain contact element of the height adjustment apparatus follows the level of the terrain surface and the terrain contact element of the terrain following apparatus follows a path vertically offset from and above the path of the terrain contact element of the height adjustment apparatus. Step (II) may be performed while moving the implement with the propulsion unit to perform an agricultural operation, and while the frame height positioning system is seeking the heigh set point.

In another embodiment, a method of operating an agricultural apparatus is disclosed. The agricultural apparatus comprises: a propulsion unit; an implement mounted on the propulsion unit. The implement comprises: a transversely extending main frame having a main frame weight, the propulsion unit configured and operable to support at least a portion of the main frame weight; a transversely extending cutter bar, the cutter bar comprising a plurality of cutting devices disposed transversely along the cutter bar and operable for cutting crop material, the cutter bar having a terrain contact surface region; a cutter bar support apparatus configured to interconnect the transversely extending cutter bar to the main frame, the cutter bar support apparatus comprising a plurality of transversely spaced, longitudinally oriented paddles, each of the paddles being rigidly interconnected to the transversely extending cutter bar proximate one distal end region and pivotally interconnected to the main frame proximate an interior end region; a height adjustment apparatus comprising at least one terrain contact element, the at least one terrain contact element of the height adjustment apparatus being operable to be positioned to contact the terrain surface level at a terrain contact location such that the terrain contact element will contact the terrain surface to support the cutter bar contact region at a vertical separation distance above the terrain surface, the height adjustment apparatus operable to adjust the magnitude of the vertical separation distance; a frame height positioning system operable to control and adjust the height of the main frame relative to the propulsion unit; and a sensor system operable to provide signals to the frame height control positioning system indicative of the height of the cutter bar above the terrain surface, wherein the sensor signals are dependent upon the pivot angle of the paddles relative to a component of the main frame. The method comprises: (a) establishing a set point for the frame height positioning system; (b) while the frame height positioning system is operating to move the main frame towards the set point and maintain the set point, then using the height adjustment apparatus to adjust the height of the terrain contact element relative to the terrain surface. The use of the height adjustment apparatus may not impact the operation of the frame height positioning system in seeking the height set point. The using of the height adjustment apparatus may have the effect of artificially adjusting the level of the terrain surface beneath the cutter bar.

In an embodiment, a method of operating an agricultural apparatus is disclosed. The agricultural apparatus comprises: a propulsion unit; an implement mounted on the propulsion unit. the implement comprises: a main frame having a main frame weight, the propulsion unit configured and operable to support at least a portion of the main frame weight; a terrain surface following apparatus comprising at least one terrain contact element; a height adjustment apparatus comprising at least one terrain contact element, the at least one terrain contact element of the height adjustment apparatus operable to be positioned to contact the terrain surface level at a terrain contact location such that the terrain contact element of the height adjustment apparatus is operable to support the terrain following apparatus such that the least one terrain contact element of the terrain surface following apparatus is positioned at a vertical separation distance above the terrain surface, the height adjustment apparatus being operable to adjust the magnitude of the vertical separation distance; a frame height positioning system operable to control and adjust the height of the main frame relative to the propulsion unit; and a sensor system operable to provide sensor signals to the frame height positioning system dependent upon a position of the terrain contact element of the terrain following apparatus and indicative of the level of the terrain surface. The method comprises: (a) establishing a set point for the frame height positioning system; (b) while the frame height positioning system is operating to move the main frame towards the set point and maintain the set point, then using the height adjustment apparatus to adjust the height of the terrain contact element of the height adjustment apparatus relative to the terrain surface.

In another aspect of the disclosure, there is provided an agricultural apparatus comprising an agricultural implement. The agricultural implement comprises: (i) a main frame; (ii) an operational unit interconnected to the main frame; (iii) a height adjustment apparatus interconnected to the main frame and the operational unit, the height adjustment apparatus comprising at least one terrain contact element, the at least one terrain contact element operable to be positioned to contact a terrain surface level at a terrain contact element contact region such that the at least one terrain contact element supports the operational unit at a vertical separation distance of the operational unit above the terrain surface, the height adjustment apparatus being operable to adjust the vertical separation distance of the operational unit above the terrain surface; (iv) a shock absorbing assembly operationally positioned between the main frame and the at least one terrain contact element, the shock absorbing assembly operable to provide for resilient deformation in response to forces transmitted during operation to the at least one terrain contact element, from contact of the at least one terrain contact element with the terrain surface.

In another aspect of the disclosure, there is provided an agricultural apparatus comprising: (a) a propulsion unit; (b) an implement interconnected to the propulsion unit, the implement comprising: (i) a main frame having a main frame weight, the propulsion unit configured and operable to support at least a portion of the main frame weight; (ii) an operational unit interconnected to the main frame; (iii) at least one terrain contact element operable to contact the terrain surface level at a terrain contact element contact region such that the at least one terrain contact element supports the operational unit at a vertical separation distance of the operational unit above the terrain surface; (iv) a shock absorbing assembly located between the main frame and the at least one terrain contact element, the shock absorbing assembly operable to resiliently deform in response to forces transmitted to the at least one terrain contact element from contact of the at least one terrain contact element with the terrain surface.

In another aspect of the disclosure, there is provided an agricultural apparatus comprising: (a) a propulsion unit; (b) an implement interconnected to the propulsion unit, the implement comprising: (v) a main frame having a main frame weight, the propulsion unit configured and operable to support at least a portion of the main frame weight; (vi) an operational unit interconnected to the main frame; (vii) a skid shoe assembly comprising at least one skid shoe which is operable to contact the terrain surface level at skid shoe contact region such that the at least one skid shoe supports the operational unit at a vertical separation distance of the operational unit above the terrain surface; (viii) a force absorbing assembly operationally located between the main frame and the at least one skid shoe, the shock absorbing assembly operable to provide for resilient and/or elastic deformation of at least one component of the shock absorbing assembly in response to forces transmitted to the at least one skid shoe from contact of the at least one skid shoe with the terrain surface, to thereby cushion and/or absorb the resultant forces transmitted to at least one component of the skid shoe assembly.

In another aspect of the disclosure, there is provided an agricultural apparatus, comprising an agricultural implement. The agricultural implement comprises: (i) a transversely extending main frame; (ii) an operational unit interconnected to the main frame; (iii) a height adjustment apparatus interconnected to the main frame and the operational unit, the height adjustment apparatus comprising at least one terrain contact element, the at least one terrain contact element operable to be positioned to contact a terrain surface level at a terrain contact element contact region such that the at least one terrain contact element supports the operational unit at a vertical separation distance of the operational unit above the terrain surface, the height adjustment apparatus being operable to adjust the vertical separation distance of the operational unit above the terrain surface; (iv) a shock absorbing assembly operationally positioned between the main frame and the terrain contact unit of the height adjustment apparatus, the shock absorbing assembly being capable of at least one of cushioning, absorbing and dampening forces transmitted to at least one component of the height adjustment apparatus; wherein, during operation, the shock absorbing assembly at least one of cushions, absorbs and dampens forces transmitted to at least one component of the height adjustment apparatus resulting from contact of the at least one terrain contact element with the terrain surface.

### BRIEF DESCRIPTION OF THE DRAWINGS

In drawings which illustrate embodiments of the invention,

FIG. 1 is a perspective view of a crop harvesting header in accordance with one disclosed embodiment being carried by a combine harvester propulsion unit;

FIG. 1A is a front side perspective view of the agricultural implement of the agricultural apparatus of FIG. 1, with some parts being shown exploded;

FIG. 1B is a rear side perspective view of the agricultural implement of the agricultural apparatus of FIG. 1, with some parts being shown exploded;

FIG. 1C is an opposite rear side perspective view of the agricultural implement of the agricultural apparatus of FIG. 1;

FIG. 2A is a front perspective view of the main frame, paddles and cutter bar components of the agricultural implement of FIGS. 1A, 1B and 1C;

FIGS. 2B and 2C are rear perspective views of some main frame components of the agricultural implement of FIGS. 1A, 1B and 1C;

FIG. 2D is a front perspective view of a drive paddle, a knife drive and skid shoe assemblies comprising components of the agricultural implement of FIG. 1;

FIG. 2E is a side elevation view of the components shown in FIG. 2D;

FIG. 3A is an enlarged rear lower perspective view of some other components of the agricultural implement of the agricultural apparatus of FIG. 1;

FIG. 3B is an enlarged rear perspective view of some components shown in FIG. 3A;

FIG. 3C is an enlarged upper exploded perspective view of components shown in FIG. 3A;

FIGS. 3D and 3E are enlarged upper exploded and assembled perspective views of alternate components similar to the components shown in FIG. 3A; and

FIG. 4 is a schematic view of the system of FIG. 1 according to one embodiment;

FIG. 5 is a schematic view of the system of FIG. 1 according to one embodiment;

FIG. 6 is a side view of the propulsion unit of FIG. 1;

FIG. 7A is a front top perspective view of part of a paddle and a skid shoe assembly of the agricultural implement of the agricultural apparatus of FIG. 1, with the skid shoe assembly in a fully retracted position;

FIG. 7B is a rear bottom perspective view of the paddle part and skid shoe assembly of FIG. 7A;

FIG. 7C is a side elevation view of the paddle part and skid shoe assembly of FIG. 7A;

FIG. 8A is a front top perspective view of the paddle part and skid shoe assembly of FIG. 7A, with the skid shoe assembly in a fully extended position;

FIG. 8B is a rear bottom perspective view of FIG. 8A of the paddle part and skid shoe assembly of FIG. 7A, with the skid shoe assembly in the fully extended position;

FIG. 8C is a side elevation view of FIG. 8A of the paddle part and skid shoe assembly of FIG. 7A, with the skid shoe assembly in the fully extended position;

FIG. 8D is an opposite side elevation view of components shown in FIG. 8C, with the skid shoe assembly in the fully extended position;

FIG. 8E is a front top perspective view of a paddle art and skid shoe assembly that is substantially the same as the paddle part and skid shoe assembly of FIG. 7A, with the skid shoe assembly in a fully extended position, but with an alternate skid shoe arrangement;

FIGS. 9A and 9B are front and rear top perspective views of another embodiment of a paddle and skid shoe assembly of the agricultural implement of the agricultural apparatus of FIG. 1, with some components removed;

FIG. 9C is lower rear perspective view of the embodiment of FIGS. 9A and 9C;

FIGS. 10A and 10B are front and rear top perspective views of yet another embodiment of a paddle and skid shoe assembly of the agricultural implement of the agricultural apparatus of FIG. 1, with some components removed;

FIG. 10C is lower rear perspective view of the embodiment of FIGS. 10A and 10C;

FIG. 10D are isolated top perspective views of the paddle and skid shoe assemblies of FIGS. 9A-9C and of FIGS. 10A-10C;

FIG. 10E is another top perspective view of the paddle and skid shoe assemblies of FIGS. 10A-10C;

FIG. 10F is a side elevation view of the paddle and skid shoe assemblies of FIGS. 10A-10C;

FIG. 11A is a schematic view of a control system for a skid shoe adjustment system of the present disclosure with the hydraulic pistons in a first position and the skid shoe hydraulic fluid circuit block in an unpowered state;

FIG. 11B is a schematic view of the hydraulic fluid supply and control system of FIG. 11A with the hydraulic pistons in a first position and the skid shoe hydraulic fluid circuit block in a powered state;

FIG. 11C is a schematic view of the hydraulic fluid supply and control system for a skid shoe adjustment system of FIG. 11A with the hydraulic pistons in a second position and the skid shoe hydraulic fluid circuit block in a powered state;

FIG. 11D is a schematic view of a single hydraulic piston of the hydraulic flid supply and control system of FIGS. 11A, 11B and 11C, with the hydraulic piston at the approximate mid-point of hydraulic fluid chamber;

FIG. 11E is a schematic view of the hydraulic piston of FIG. 11D, with the hydraulic piston in a first (fully extended) position;

FIG. 11F is a schematic view of the hydraulic piston of FIG. 11D, with the hydraulic piston in a second (fully retracted) position;

FIG. 12A is a front perspective view of the main frame of the agricultural implement of FIGS. 1A, 1B and 1C with the main frame in a first position;

FIG. 12B is a front perspective of the main frame of FIG. 12A, with the main frame in a first position;

FIGS. 13A, 13B and 13C are schematic drawings illustrating steps for setting up a header and its cutter bar for operation;

FIG. 14A is a front perspective view of another embodiment of a paddle and skid shoe assembly for use with agricultural implement of the agricultural apparatus of FIG. 1, with some components removed and the skid shoe assembly in the fully retracted position;

FIG. 14B is a side elevation view of the paddle part and skid shoe assembly of FIG. 14A, with the skid shoe assembly in the fully retracted position;

FIG. 14C is a side elevation view of the paddle part and skid shoe assembly of FIG. 14A, with the skid shoe assembly in the fully extended position;

FIG. 14D is an opposite side elevation view of components shown in FIG. 14B, with the skid shoe assembly in the fully retracted position;

FIG. 14E is a front perspective view of components shown in FIG. 14A;

FIG. 14F is a cross sectional view of components shown in FIG. 14E;

FIG. 14G is an exploded front perspective view of components shown in FIG. 14E;

FIG. 15A is a front perspective view of another embodiment of a paddle and skid shoe assembly for use with agricultural implement of the agricultural apparatus of FIG. 1, with some components removed and the skid shoe assembly in the fully retracted position;

FIG. 15B is a side elevation view of the paddle part and skid shoe assembly of FIG. 15A, with the skid shoe assembly in the fully retracted position;

FIG. 15C is a side elevation view of the paddle part and skid shoe assembly of FIG. 15A, with the skid shoe assembly in the fully extended position;

FIG. 15D is an opposite side elevation view of components shown in FIG. 15B, with the skid shoe assembly in the fully retracted position;

FIG. 15E is a front perspective view of components shown in FIG. 15A;

FIG. 15F is a cross sectional view of components shown in FIG. 15E; and

FIG. 15G is an exploded front perspective view of components shown in FIG. 15E.

### DETAILED DESCRIPTION

In an embodiment, a height adjustment system is disclosed which may be used to adjust and set the height (vertical separation distance) of a portion of an agricultural implement relative to the terrain surface beneath it. By way of example, a height adjustment system is disclosed which may be used to adjust and set the height/minimum vertical separation of an operational unit such as a cutter bar and its cutting blades relative to the terrain surface beneath the cutter bar and its cutting blades. This minimum vertical separation distance may be set and provided when the cutter bar is operating in a flex mode of operation (as described hereinafter). In a flex mode of operation, a cutter bar is able to move upwards and downwards relative to the frame of the agricultural implement-typically within a limited range of movement. This movement of the cutter bar relative to the frame of the agricultural implement, is separate from the upwards/downwards movement of the frame of the agricultural implement relative to a propulsion unit to which the frame may be mounted. Such a height adjustment system of the cutter bar relative to the header main frame may be used to set a minimum vertical separation of the cutter bar and its cutting blades relative to the terrain surface beneath the cutter bar. Additionally, the height adjustment system may function and behave as an adjustable terrain reference system, that has the effect of artificially adjusting the terrain height up or down to create a physical terrain offset relative to a height sensed nominal terrain level referenced and calibrated by a main frame height control system.

A system and associated method are disclosed which provide for a terrain surface level offset for a terrain following/engaging element on an agricultural implement and its associated terrain following elements and sensor(s), which maintains the sensor(s) terrain height calibration in a frame/implement height control system. The frame/implement may be mounted to a propulsion unit. The header height control system may operate in a manner such that the sensor(s) associated with one or more terrain following elements provide signals to a controller of the frame/implement height control system that indicates a level of the terrain surface that is offset from the actual level of the terrain surface. The frame/implement height control system can be set at a baseline position/set point with a terrain following/engaging element in contact with the terrain surface and the sensors providing particular sensor signals/data to the height positioning controller of the frame/implement height. The height adjustment system can then be activated and the height of the terrain following element can be raised relative to the actual terrain surface by a height adjustment device that may be directly connected to the terrain following element. The header height control system of the frame/implement may then respond and raise the frame/implement to target the set point again. The result is that a vertical height offset of the terrain surface level is created such that the header/implement height control system will be controlling the height of the frame/implement relative to an artificial terrain surface level that is vertically offset from and above the actual terrain surface level. The magnitude of that vertical offset may be readily varied by an operator operating/activating the height adjustment system. This may be done while the frame/agricultural implement is being operated-such as for example while a harvesting header is cutting crops. A benefit of this approach is that it is easy for an operator to vary the actual target height of the frame/agricultural implement without having to recalibrate the height control system. Such a system and associated method may be utilized for agricultural implements beyond harvesting headers with cutter bars, where the height of an operational component of an agricultural implement relative to the terrain surface level is important to be controlled and varied. For example, such a system and method may be employed with seeding apparatuses, where it is typically important to control the depth at which seeds are placed relative the terrain surface level.

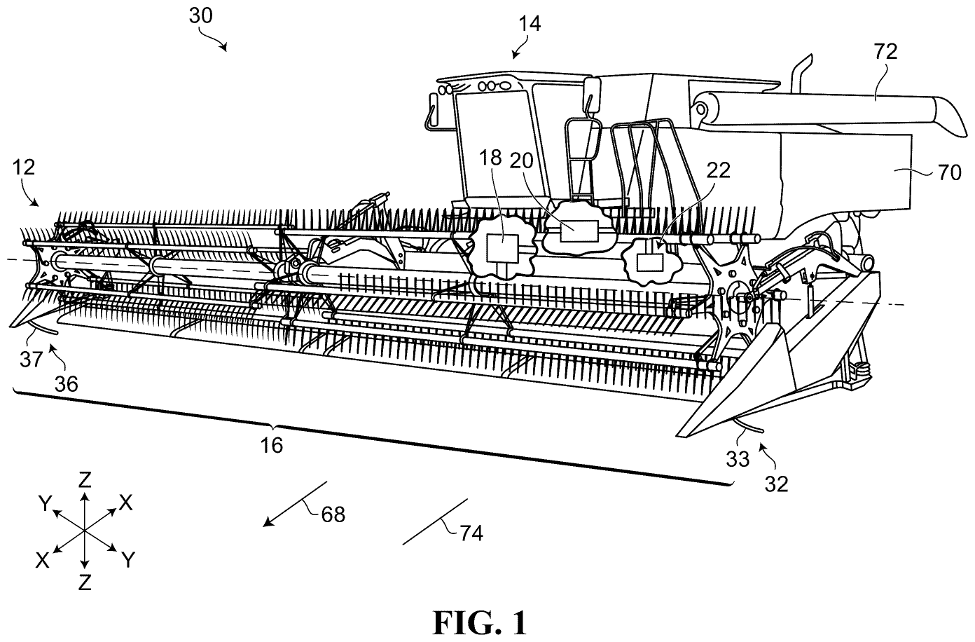

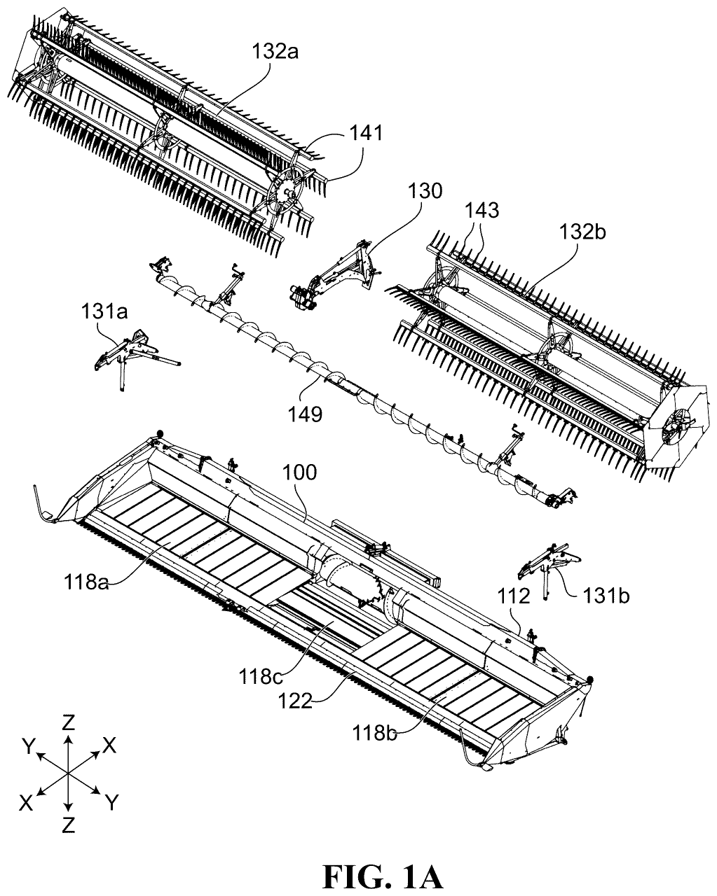

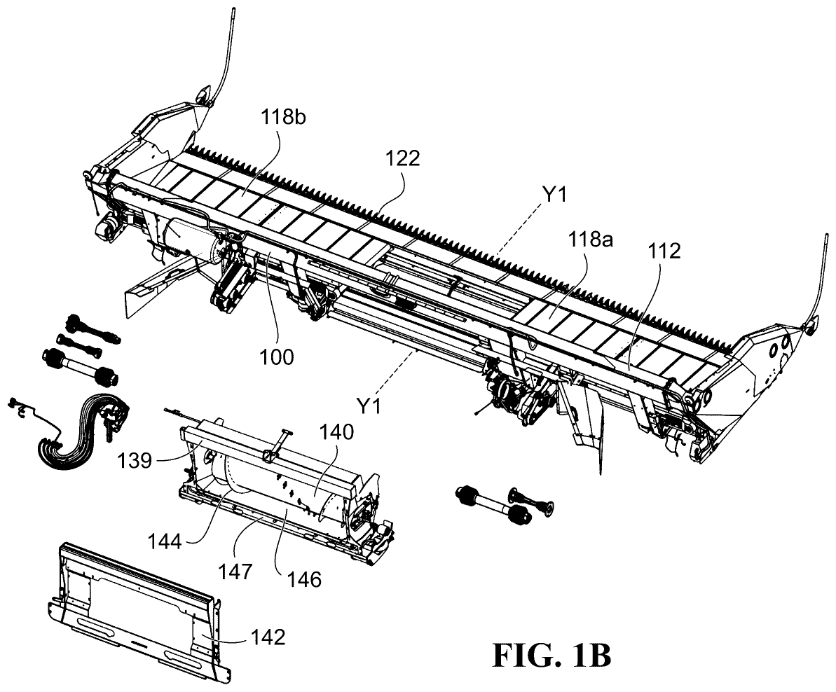

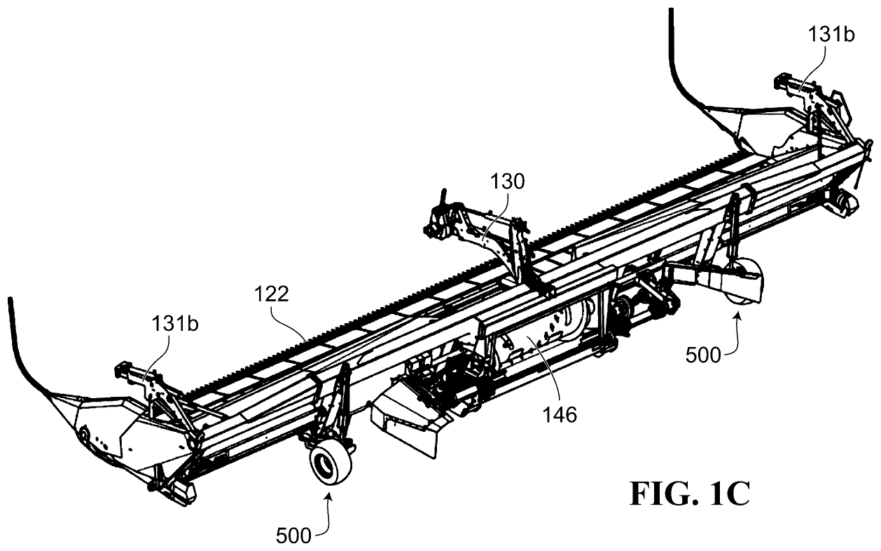

Referring to FIG. 1, an agricultural apparatus in accordance with one embodiment is shown at 30. Agricultural apparatus 30 may be an agricultural combine harvester including an operational unit such as a harvesting header 12 mounted to a propulsion and processing unit 14 (hereinafter referred to as a “propulsion unit”) such as a known type of tractor or combine propulsion machine.

Propulsion unit 14 provides support for header 12 and is operable to propel the movement of header 12 and provide power and other utilities to header 12 during operation. Header 12 may be configured to harvest crop material from crops growing in a field while the apparatus 30 is driven across a terrain surface 74 (e.g., a field) by propulsion unit 14 in a direction indicated by the arrow 68. Header 12 may be configured to cut and collect the crop material and transfer the crop material to propulsion unit 14, which may be configured to further process the cut crop material. The header 12 is generally oriented transverse to the direction of movement 68.

Propulsion unit 14 may include a processing portion 70 that performs some processing of the crop being harvested. The propulsion unit 14 may also include a discharge chute 72 for discharging the processed crop into a cargo area of a truck for transport. During harvesting operations, the propulsion unit 14 moves across terrain surface 74 in a direction indicated by the arrow 68 while gathering, cutting, and processing crops growing in the field.

With particular reference to FIGS. 1A to 1C, header 12 may include a main frame generally designated 100 and may also include first and second lateral draper decks 118a, 118b supported on main frame 100 and located on opposite transverse sides of a central draper deck 118c. Draper decks 118a, 118b, 118c may be mounted to header main frame 100 in a known manner and may be operable to collect and feed cut crop material to propulsion unit 14 for further processing, in a known manner. Header 12 may also include a cross auger device 149 which may be mounted on main frame 100 in a known manner and may assist in moving cut crop material on draper decks 118a, 118b to central draper deck 118c, and into central feed auger drum 144.

Header 12 may also include a center reel arm 130 and right and left side reel arms 131a, 131b which may be mounted to and supported by main header frame 100 in a known manner. Center reel arm 130 and right-side reel arm 131a may support, for rotation about a reel axis, a right reel section 132a. Center reel arm 130 and left-side reel arm 131b may support, for rotation about the same common transversely extending reel axis, a left reel section 132b. Right and left reel sections 132a, 132b may be driven about their common transversely oriented reel axis with known reel drive systems. For example, the center reel arm 130 may house a reel drive mechanism (not shown) for delivering a drive torque to the reel sections 132a and 132a to cause rotation of the reels about their common transversely oriented reel axis. In other embodiments a single pickup reel may span substantially the entire width of the header 12.

Each of the reel sections 132a, 132b may include a plurality of reel bats 141 peripherally disposed on the reel, each reel bat having a plurality of fingers 143 extending outwardly from the bats that act to engage and sweep the crop through the header 12.

Rotation of reel sections 132a, 132b with bats 141 and their fingers 143 assists crop material engaged by the combine harvester as it moves in a forward direction 68 (FIG. 1) being brought into contact with cutter bar 122 located at a forward, lower edge region of header 12. Reel sections 132a, 132b with bats 141 and their fingers 143 may also assist in moving crop material once cut by cutter bar 122 directly onto central draper deck 118c and also onto the draper decks 118a, 188b for transport to central draper deck 118c.

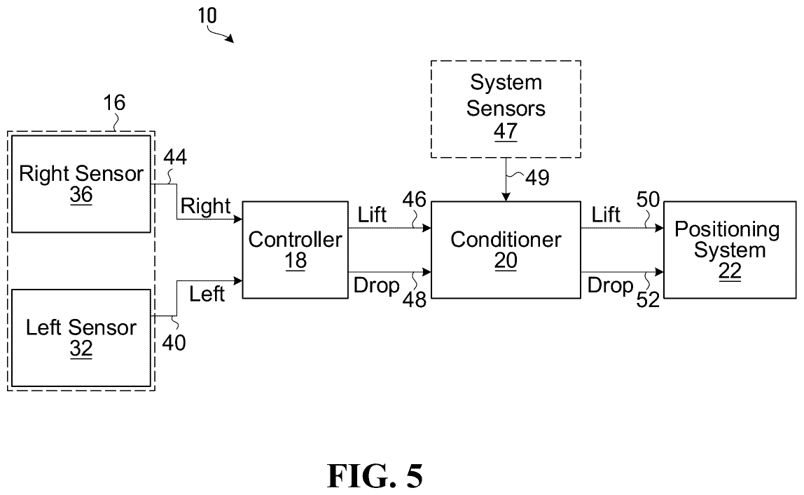

With particular reference to FIGS. 1A and 1B, interconnected to header main frame 100 may be a generally rectangular shaped sub-frame 140. Main frame 100 and the header components supported thereon, may in turn be supported by sub-frame 140. The upper, lower and side members of sub-frame 140 may be formed from suitably strong and rigid members such as for example, hollow section rectangular/square tubular structural steel members made from ASTM A36 steel that may be welded together to form an integral weldment unit. Sub-frame 140 may also be fixedly secured, such as for example with bolts, to a generally rectangular shaped adapter plate 142. The upper, lower and side members of adapter plate 142 may also be formed from suitably strong and rigid members such as hollow section rectangular/square tubular structural steel members made from ASTM A36 steel. Adapter plate 142 may in turn be fixedly secured, such as for example via a latching coupling mechanism that is compatible with the type/brand/model of propulsion unit 14 being utilized. Adapter plate 142 and the components supported thereon, may in turn be supported by a feeder house 60 associated with propulsion unit 14 (FIG. 6). Feeder house 60 may be part of and pivotally connected to the rest of propulsion unit 14 at pivot point 62.

A feed auger drum 144 may be fixedly mounted transversely to sub-frame 140 within a central feed opening 146 of sub-frame 140. Adapter plate 142 may also have a complementary sized and shaped opening to central feed opening 146 in sub-frame 140. Feed auger drum 144 may be powered in a known manner and may be operable to assist in feeding cut crop delivered by central draper deck 118c to the feeder house 60 associated with propulsion unit 14.

The connection between sub-frame 140 and main header frame 100 may be a three-point pivotal connection that permits a limited degree of lateral (side-to-side) tilting in upward and downward lateral directions of main header frame 100 relative to sub-frame 140, about an upper pivotal connection, and thus relative to adapter plate 142 and feeder house 60. This connection between sub-frame 140 and main header frame 100 may be provided with a header air suspension system to resist/absorb/cushion/dampen the forces acting on the header frame 100 and cutter bar 122, including forces acting in lateral tilt directions, which are transferred to sub-frame 140.

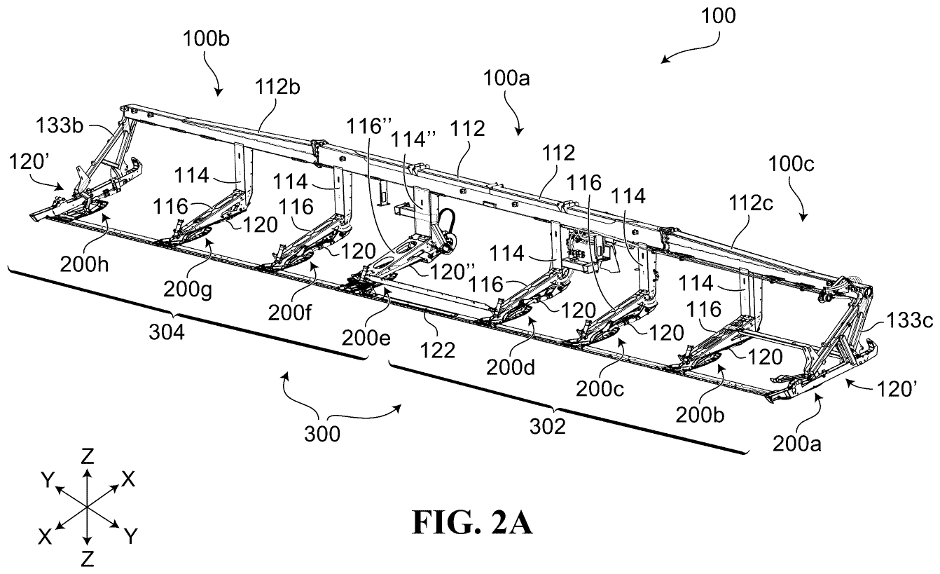

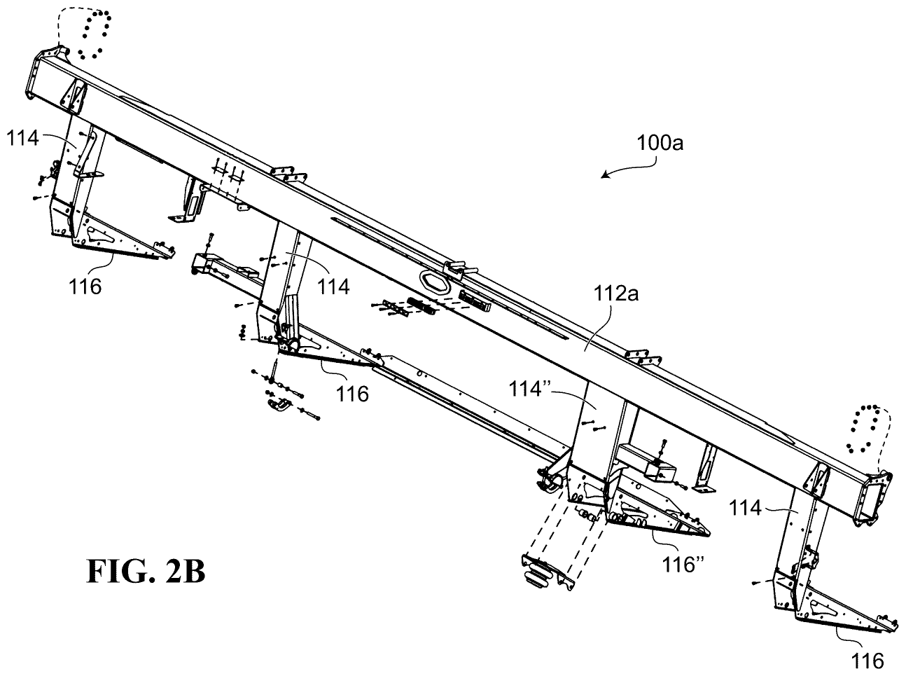

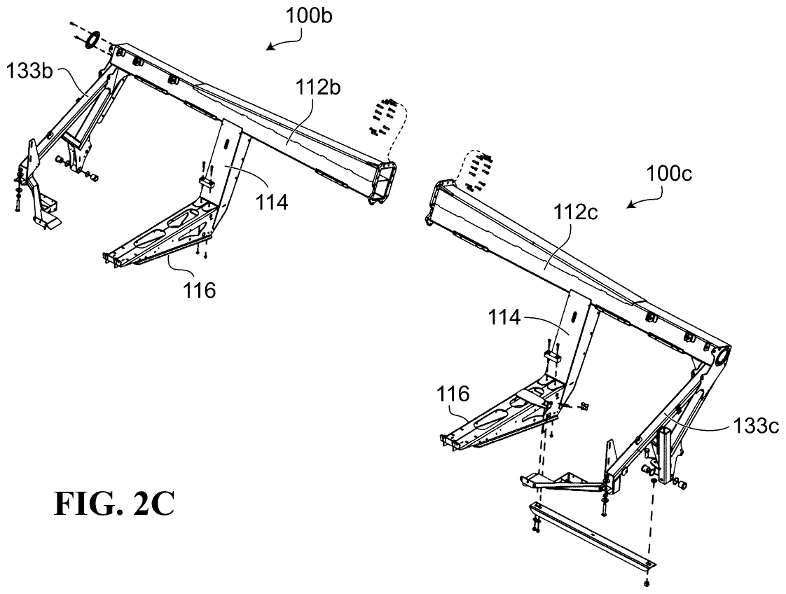

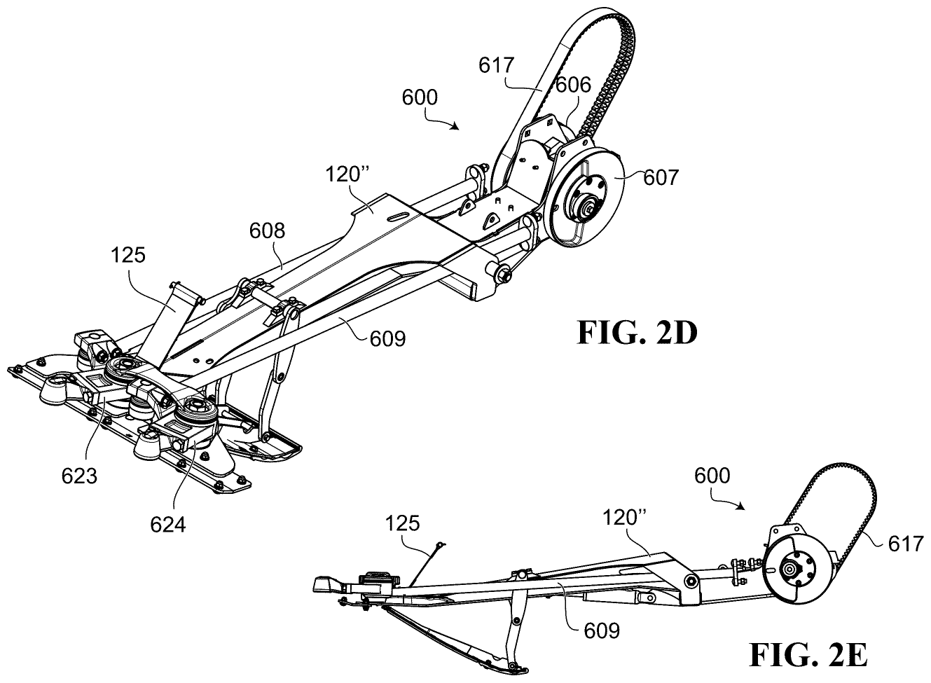

With reference to FIGS. 2A-2C, main frame 100 may include a main transverse support beam 112 (FIG. 2A), which may include a central support beam component 112a, and right and left side support beam extensions 112b, 112c. Support beam components 112a, 112b, 112c, may be fixedly connected to each other (for example with bolted flanges) in an end-to-end relation with longitudinal alignment to create a transversely extending composite continuous transverse support beam 112. Transverse support beam 112 may be made from any suitably strong and configured material such as a steel hollow sectional tube member such as ASTM A36 steel. Fixedly secured to transverse support beam 112, such as for example with fasteners or by welding may be a plurality of transversely spaced, generally downwardly depending, vertical struts 114. At the outer ends of each of right and left side support beam extensions 112b, 112c may be downwardly depending struts 133b, 133c respectively, which may each comprise a pair of diverging tubular members.

Fixedly secured, such as for example with fasteners or by welding, to a bottom end region of each vertical strut 114 may be a generally forwardly extending horizontal strut 116. Each vertical strut 114 may be made from any suitably strong and configured material such as a steel hollow sectional tube member such as ASTM A36 streel. Each horizontal strut 116 may be a steel structural open member such as an open structural member made from ASTM A36 steel.

Main frame 100 may thus be formed as a central frame section 100a (FIG. 2A) with opposite side frame sections 100b and 100c (shown in isolation in FIG. 2C). For each frame section, 100a, 100b, 100c, the main support beams and vertical and horizontal struts may be fastened or welded together to form a single assembly/weldment. The center, right and left frame sections 100a, 100b, 100c can then be bolted together. Depending upon the required overall transverse width, the right and left frame sections may vary in width such that headers may range in total width of between about 25 ft and 60 ft, or possibly more.

Frame 100 may be interconnected by an operational unit support apparatus which may in an embodiment comprise a plurality of cutter bar float paddles 120, 120′, 120″ (as detailed below) to a transversely extending cutter bar 122 (FIG. 1C), which may have mounted thereto a series of cutting knives/blades of a cutter bar 122 driven in transverse reciprocating motion by a knife drive apparatus (also as detailed below). Cutter bar 122 may be fixedly and structurally connected to cutter bar float paddles 120, 120′, 120″ such that the cutter bar can't be physically displaced relative to the paddles.

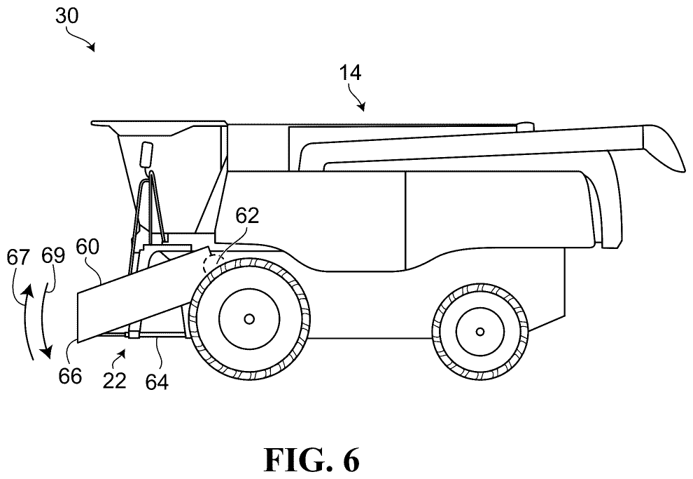

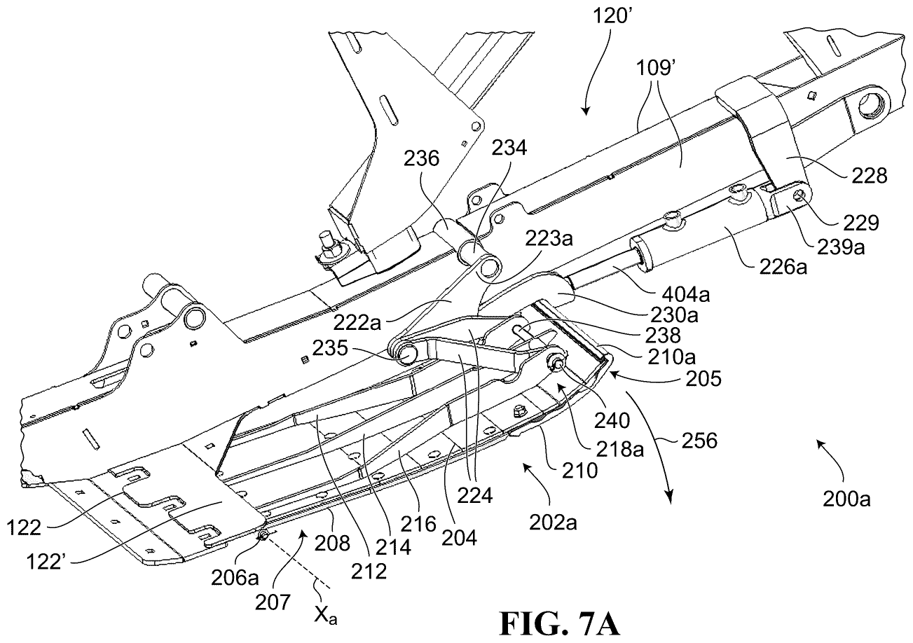

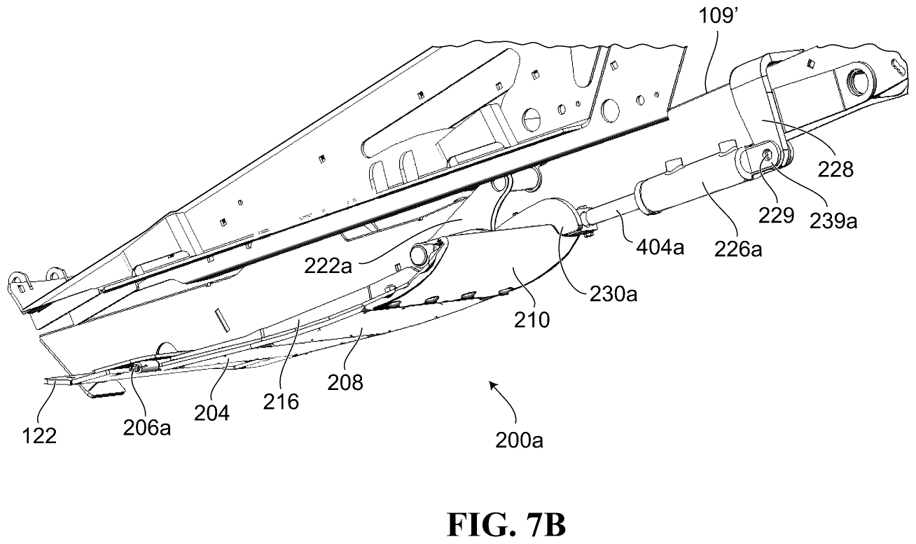

Cutter bar 122 may be constructed from any one or more suitably strong and wear resistant materials. For example, cutter bar 122 may be a roll formed section of high strength steel with for example, a shallow S or Z bend profile. Cutter bar 122 may be a single piece of steel secured, for example by welding and/or with bolts, to a lower portion of the frame 100 of header 12. Cutter bar 122 may be designed to be used for a significant amount of time (e.g. for the projected life span of header 12) without significant amounts of repair work being required. In some designs, cutter bar 122 may be formed in discrete sections, with sections being bolted on to the frame sections 100a, 100b, 100c. Providing a cutter bar 122 that is formed in discrete, easily removable sections, facilitates the manufacturing and use of varying length/sized cutter bars with common parts and/or it can facilitate easier repair. Cutter bar 122 may include a (FIG. 7C) which may extend transversely the length of cutter bar 122 and may be made of a suitably strong material such as UHMW plastic. Cutter bar skid plate 1123 may provide protection for other components of cutter bar 122 including the knife devices from potential problems associated with the cutter bar contacting the terrain surface during operation.

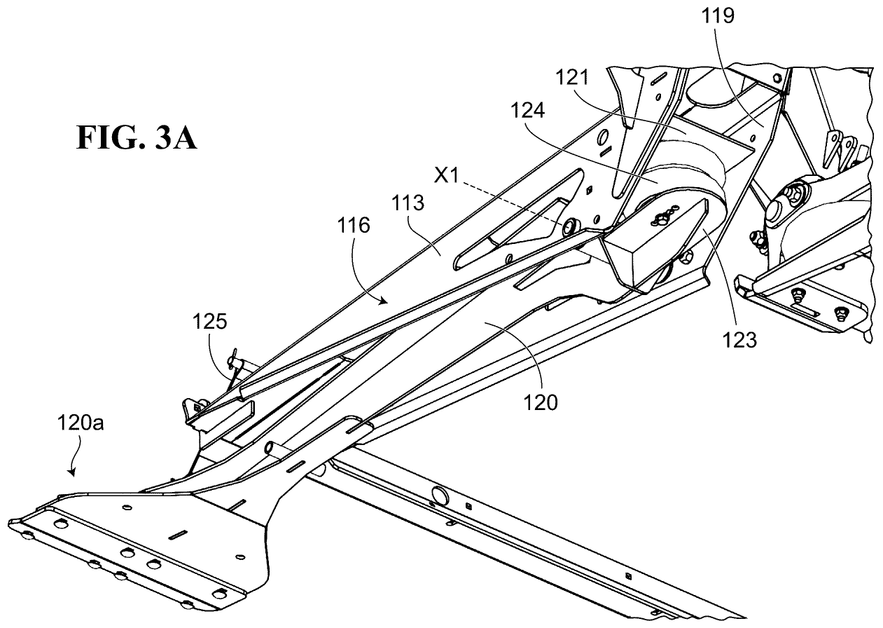

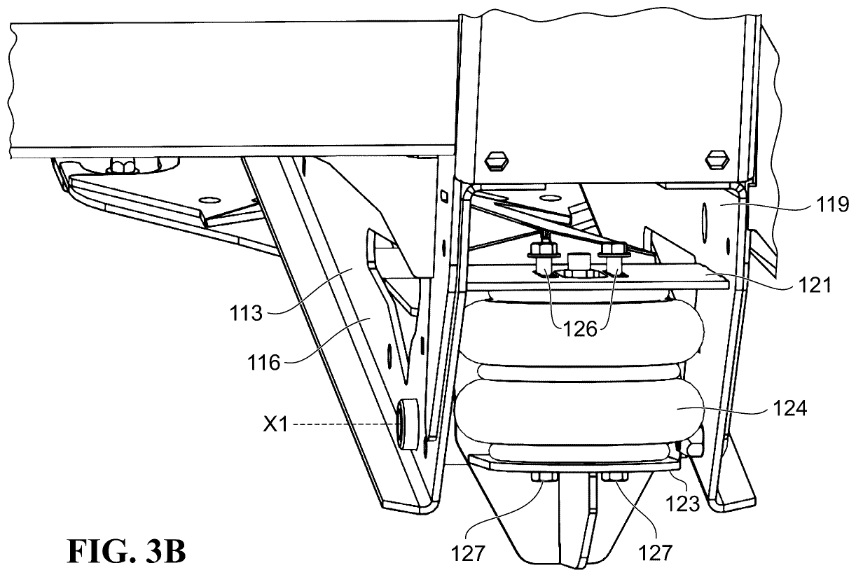

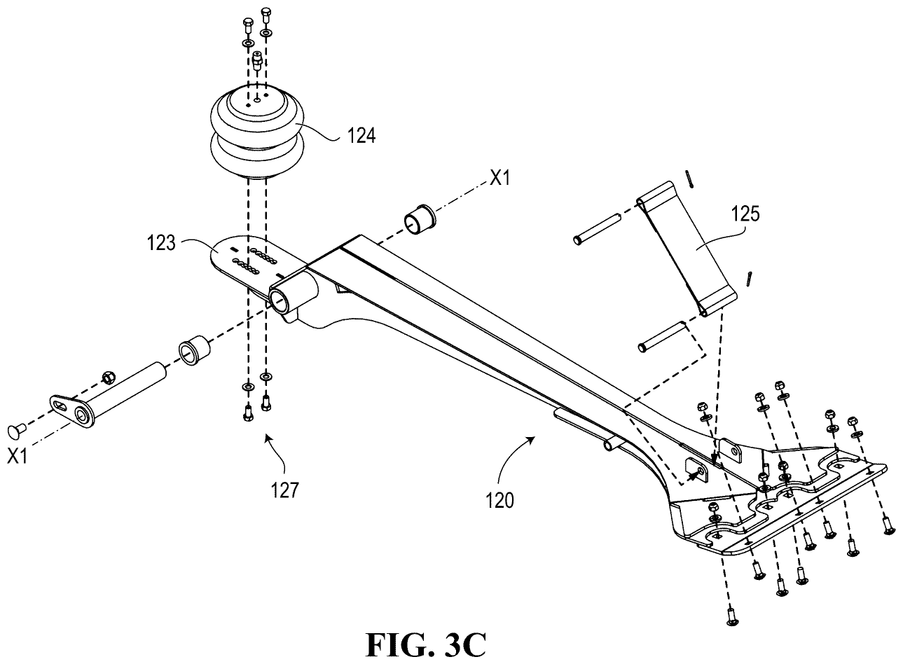

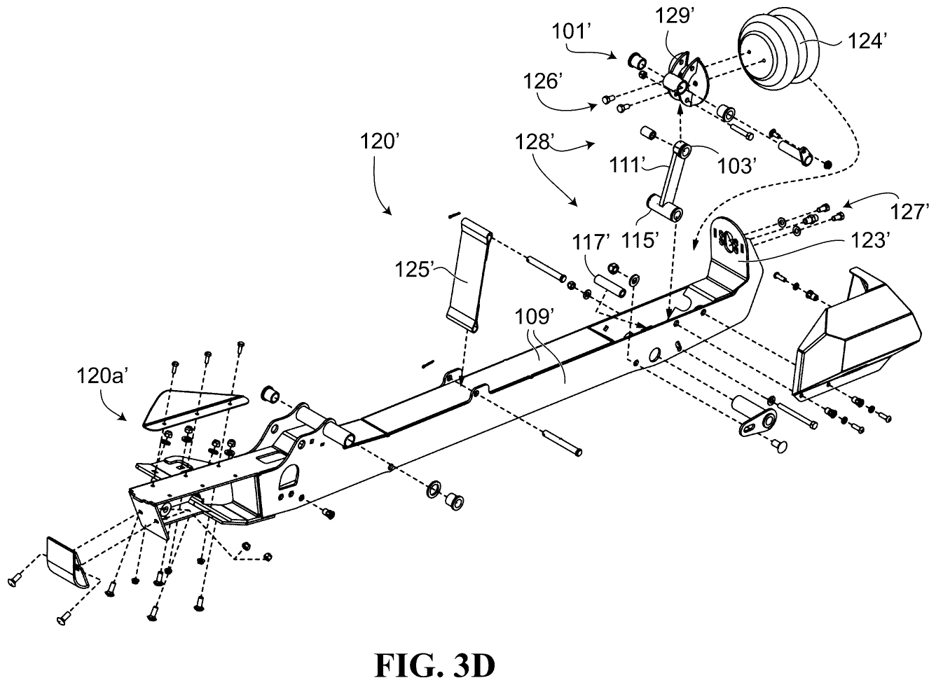

With reference now to FIGS. 2A-C and FIGS. 3A-3E, pivotally mounted to each horizontal strut 116 of frame 100, may be a forwardly and generally horizontally extending intermediate cutter bar float paddle 120 (which includes a cutter bar float drive paddle 120″) which has a portion that extends beyond the front edge of each horizontal strut 116. Each cutter bar float paddle 120 (including drive paddle 120″) may be made of any suitably strong and configured material(s) such as ASTM A36 steel and may be open section members which permit some significant degree of twisting movement about a longitudinal axis during operation. Each cutter bar float paddle 120 (including drive paddle 120″) may be configured and mounted to be able to pivot about a transverse axis X1 (eg. FIG. 3A) at its rearward end region relative to its respective horizontal strut 116. A forward end region of each cutter bar float paddle 120 (including drive paddle 120″) may be interconnected to cutter bar 122. Thus, cutter bar 122 may be connected to, and at least partially supported by, a plurality of transversely spaced cutter bar float paddles 120/120″, and each cutter bar float paddle 120/120″ may be configured and operable for independent upward and downward movement within an angular range that enables cutter bar 122 to have an upward/downward range of translation of several inches (e.g. an upwards/downwards translation of about nine inches). Paddles 120/120′/120″ and connected cutter bar 122 provide a terrain surface following apparatus that due to the forces resulting from their weight (or possibly in other embodiments by other forces), will be forced downward such that the cutter bar 122 will be normally be in contact with the terrain surface if the main frame 100 is appropriately positioned to allow the same. A paddle travel limiting strap 125 (FIG. 3A) may be secured between each paddle end region 120a and the end of horizontal strut 116. Each paddle travel limiting strap 125 may act to limit the downward movement of paddle regions 120a relative to the end of horizontal strut 116. The upward movement of paddle 120 may be limited by contact between surfaces of paddle 120 and surfaces of horizontal strut 116. Cutter bar 122 may be a known type of crop cutting apparatus that extends laterally substantially the entire width of header 12 and may include reciprocating cutting blades that may be powered in a known manner.

FIG. 3D depicts a variation of a type of cutter bar float paddle—an end region cutter bar float paddle 120′-which functions substantially the same as cutter bar float paddles 120 but which may be deployed at the right and left end regions of main frame 100, for securing to right and left end regions of cutter bar 122. Each end region cutter bar float paddle 120′ may also be made of any suitably strong and configured material(s) such as ASTM A36 steel and may be open section members which permit some significant degree of twisting movement about a longitudinal axis during operation. Each cutter bar float paddle 120′ may be configured and mounted to be able to pivot about a transverse axis at its rearward end region relative to a respective horizontal strut 116. A forward end region 120a′ of each opposed end cutter bar float paddle 120′ may be interconnected to end regions of cutter bar 122. Thus, cutter bar 122 may also be connected to, and at least partially supported by, cutter bar float paddles 120′ and each cutter bar float paddle 120′ may also be configured and operable for independent upward and downward movement within an angular range that enables cutter bar 122 to have an upward/downward range of translation of several inches (e.g. an upwards/downwards translation of about nine inches)—like intermediate cutter bar float paddles 120/120″. A paddle travel limiting strap 125′ may be secured between a middle area of cutter bar float paddle 120a′ and a middle region of a horizontal strut 116. Each paddle travel strap 125′ may act to limit the downward movement of paddle 120a′ relative to the end of horizontal strut 116. The upward movement of paddle 120′ may be limited by contact between surfaces of paddle 120′ and surfaces of a horizontal strut 116.

As depicted in FIGS. 2A, 2B, one of the medial vertical struts maybe a somewhat stronger, wider and/or deeper medial vertical strut 114″ which supports a somewhat stronger, wider and/or deeper horizontal strut 116″. Vertical strut 114″ and horizontal strut 116′ can be designed to be able to support a particular type of intermediate cutter bar float paddle 120—drive paddle 120″—and together may support a knife drive mechanism generally designated 600 (FIGS. 2D and 2E). The general components of the knife drive assembly 600 of the present invention may include: drive paddle 120″, a drive arm and a drive pulley (not shown for simplicity), left and right eccentric wheels or discs 606 and 607 (referred to herein as an “eccentric” or “eccentrics” for simplicity), and left and right push rods 608 and 609. Drive paddle 120″ may be made of any suitably strong and configured material(s) such as ASTM A36 steel and may comprise an open section member which permits some significant degree of twisting movement about a longitudinal axis during operation. The drive paddle 120″ may extend beneath the draper table of the harvesting header 12. The drive arm may extend upward pivotally from the end of the drive paddle 120″ towards a drive pulley (also not shown) and the eccentric 606 may be coupled to the drive pulley by a drive belt 617 and receives the rotational power from the rotational power source through the drive belt 617. The drive belt 617 thus rotates the eccentric 606. The drive pulley can be attached to the rotational power source on propulsion unit 14. The left and right eccentrics 606 and 607 are connected to the left and right push rods 608 and 609. The left and right eccentrics 606 and 607 are also connected, via the left and right push rods 608 and 609, to left and right ball joints and bell cranks 623 and 624 at the outward end of the drive paddle 120″, such that they will exert reciprocating horizontal movement on two knife assembly sections forming a knife blade device (not shown). Left and right push rods 608 and 609 are pivotally connected to the eccentrics 606 and 607, such that the push rods are 180° out of phase with each other. Accordingly, when the eccentrics 606, 607 on their shaft are rotated, by virtue of the connection point of each of the push rods to their respective eccentric, reciprocating movement in opposite direction, fully synchronized, will be provided. For example, a first knife assembly section will reciprocally move towards the outer end of the header at the same time that the other knife section moves towards the opposite end of the header.

The embodiment shown in FIGS. 2D and 2E is illustrated in such a way that it may be connected to a rotational power source of propulsion unit 14. More details of such an example knife drive mechanism are disclosed in U.S. Pat. No. 10,433,479 issued Oct. 8, 2019, the entire contents of which are hereby incorporated herein by reference

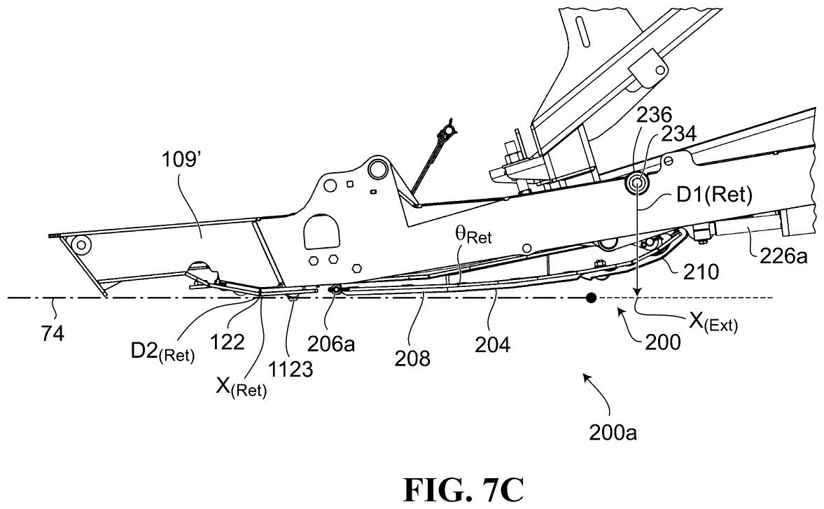

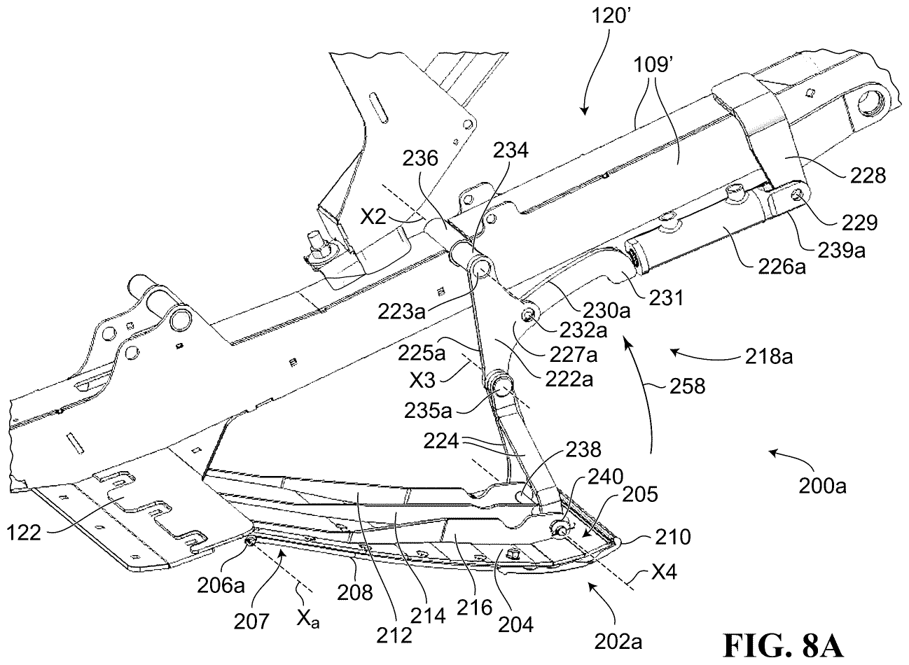

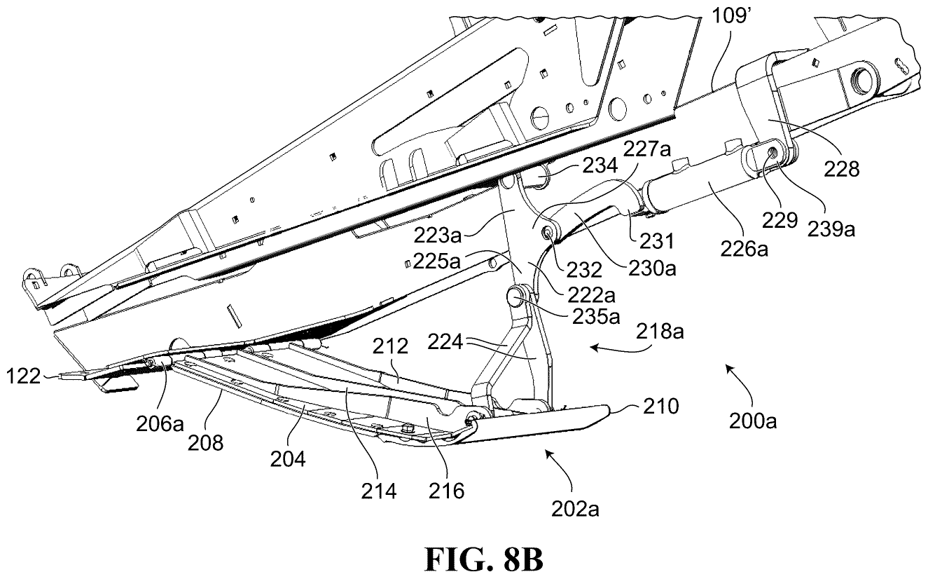

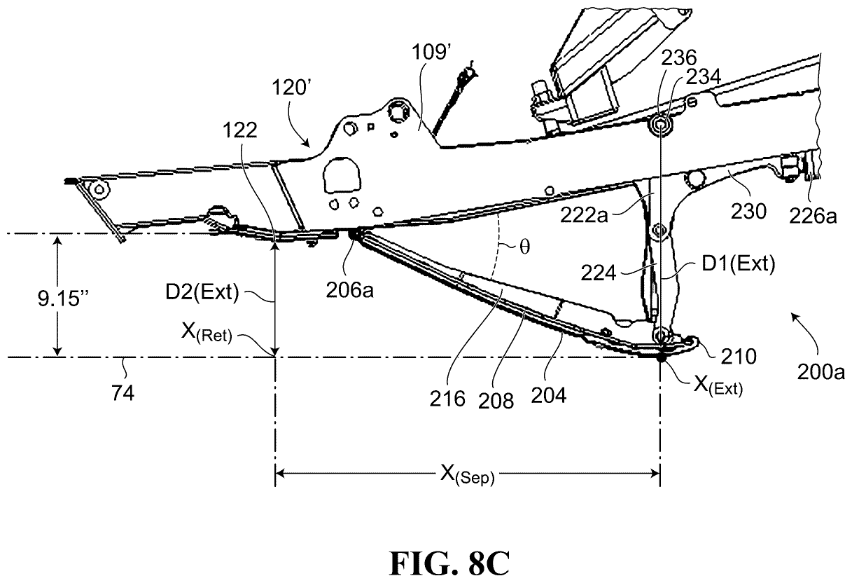

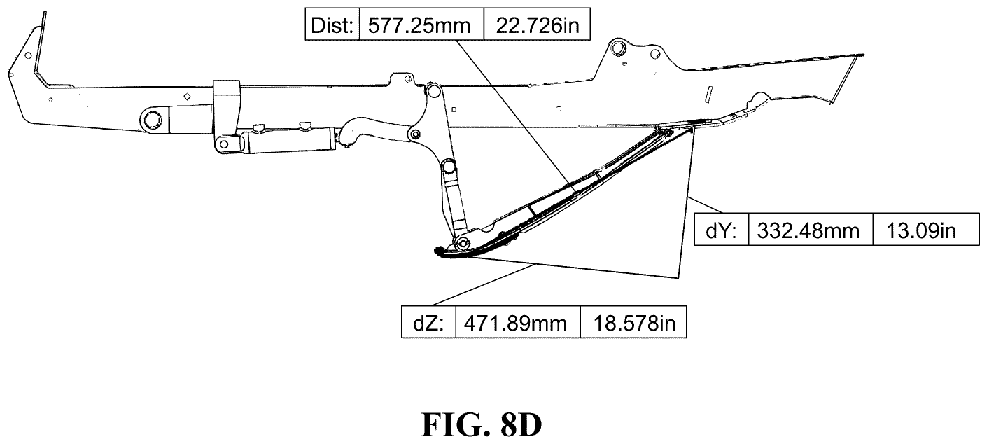

With particular reference to FIGS. 3A, 3B, 3C and 3D, in some embodiments, at least one cutter bar gas actuator device/float gas bag, which may be a cutter bar float air bag 124, provided with pressurized gas (such as air) may be mounted between a rearwardly generally horizontally extending plate member 123 of each intermediate cutter bar float paddle 120/120″ and a rearwardly positioned, upper generally horizontal rigid support plate 121 of the respective horizontal strut 116, behind the pivot axis X1. The support plates 123 may extend between inward facing support surfaces 119 of vertical side walls 113 of each horizontal strut 116. Each plate member 123 may be formed integrally at a rearward region of cutter bar float paddle 120 and may pivot about axis X1 (FIG. 8C) with the rest of its respective cutter bar float paddle 120 relative to its respective horizontal strut 116. Each cutter bar float air bag 124 may have a lower integral rigid plate portion that may be fixedly secured to a respective plate member 123 with a bolt mechanism 127 and may be held in lateral position relative to support strut plate 121 with guide bolts 126 passing through an opening with the support strut plate 121. Bolt holes in the plate portion of the air bag 124 can be appropriately sealed in a known manner from the inner pressurized air cavity of the cutter bar float air bag 124 (e.g. blind mounting nuts/bolt holes). The rigid upper plate portion may also provide for an air inlet/outlet which can be pneumatically connected to a pneumatic/air hose.

Similarly, with reference to FIGS. 3D and 3E, at least one cutter bar float gas bag, which may be a cutter bar float air bag 124′ (and which hereafter may at times also be referred to collectively with cutter bar float air bag 124 simply as cutter bar float air bag(s) 124), may be supplied with pressurized air, and mounted between a rearwardly generally vertically extending plate member 123′ of each cutter bar float paddle 120′ and a front side, generally vertically extending mounting plate 129′ of cutter bar float paddles 120′ located at each of the right and left end regions of main frame 100. Mounting plate 129′ is part of a pivoting mounting bracket assembly 128′. Bracket assembly 128′ may include a pivot arm 111′ having a lower pivot cylinder 115′ that is pivotally mounted with a transverse pin 117′ between vertical side walls 109′ of cutter bar float paddle 120′. An upper pivot assembly 101′ pivotally interconnects an upper end 103′ of pivot arm 111′ to both mounting plate 129′ of cutter bar float air bag 124′ and to a portion of vertical strut 114 of main frame 100. Each cutter bar float air bag 124′ may have a rear integral rigid plate portion that may be fixedly secured to a respective plate member 123′ with a bolt mechanism 127′ and may be held in vertical position with guide bolts 126′. Bolt holes in the forward rigid plate portion of the air bag 124′ can be appropriately sealed in a known manner from the inner pressurized air cavity of the cutter bar float air bag 124′ (e.g. blind mounting nuts/bolt holes). This rigid forward plate portion may also provide for an air inlet/outlet which can be pneumatically connected to a pneumatic/air hose. Increasing the pressure within cutter bar float air bag 124′ will cause cutter bar float air bag 124′ to pivot about transverse axis of upper pivot assembly 101′.

In an embodiment of FIGS. 3A-3C, the majority of the weight of the paddle 120/120″ and components supported thereon, will act to pivot paddle 120/120″ downwards, its range of downward movement restricted by strap 125. When cutter bar 122 (or other contact element) is in contact with the terrain surface, the terrain surface will experience a certain downward force (weight) acting on it. The amount of downward weight will be limited by the extent of the counteracting force imparted by the air bag 124, and/or if it is at its fully downward extent, also possibly strap 125. In this embodiment, when the paddle 120/120″ encounters rising terrain, the paddle will move upwards and that will cause the air bag to expand. As the force of the air bag may decrease significantly as it is expanded, this creates a smaller counteracting force, with the result that the weight experienced by the terrain that is in contact with the cutter bar 122 at that transverse location will be significantly greater—and so the paddle 120 and interconnected components will have a heavier weight on the terrain surface contact location as the paddle 120/120″ moves upwards. Downward movement in the opposite direction has the opposite weight/force effects so that as the bag is compressed, the counteracting force imparted by the air bag 124 increases and the weight on the terrain surface contact surface decreases. Thus, air bag 124 acts like a spring device and can be considered to have a varying spring rate—as the position of the paddle 120/120″ changes between its lowest position to its highest position.

In the embodiment of FIGS. 3D and 3E, the majority of the weight of the paddle 120′ and components supported thereon, will similarly act to pivot paddle 120′ downwards, its range of downward movement also restricted by a strap 125′. When cutter bar 122 (or other contact element) is in contact with the terrain surface, the terrain surface will experience a certain downward force (weight) acting on it. The amount downward weight will also be limited by the extent of the counteracting force of the air bag 124′ and if it is at its fully downward extent, possibly also strap 125. In this embodiment, when the paddle 120′ encounters rising terrain, the paddle 120′ will move upwards and that will expand the air bag 124′. However, the pivot linkage arrangement described above and illustrated in FIGS. 3D and 3E results in the height of the air bag 124′ changing only to a small extent during the movement upwards and downwards of paddle 120′ during its range of pivoting motion. This results in much smaller changes (possibly substantially no changes) in the counteracting force exerted by air bag 124′. The result is that the weight experienced by the terrain surface that is in contact with the cutter bar 122 (or other contact element) at that transverse location will be maintained at substantially the same amount throughout the range of pivoting movement of paddle 120′. Thus, the air bag 124′ acts like a spring device that has a substantially constant spring rate, as the position of the paddle changes from its lowest position to its highest position.

It will be appreciated that airbags 124, 124′ can be configured so that, especially when operating in “flex” mode, where the air pressure in cutter float air bags 124, 124′ is relatively low (e.g. 30-50 psi) and the corresponding relatively small changes in the height of air bags 124, 124′ (e.g. 0.5-1 inch), will result in relatively small changes in the counteracting forces of cutter float air bags 124, 124′ described above.

There may be a mechanical benefit to this mechanism for cutter bar float air bag 124′ compared to the corresponding mechanism for cutter bar float air bag 124 as described above, in that the spring rate response/behavior of the pivot mechanism for cutter bar float air bag 124′ in combination with the pressurized air provided by the pressurized air delivery system, provides a more constant spring rate/counteracting imparting forces over the full range of pivoting motion of the paddle 120′ about the transverse pivot axis. This means that the paddle weight counteracting forces provided by the action of the cutter bar float air bag 124′ over the entire range of pivoting movement of the paddles 120′ may be remain substantially the same, in particular when the header is operating in flex mode as described herein.

As indicated above drive paddle 120″ may also have a cutter bar float air bag that is also supplied with pressurized gas (e.g. air) and may have a mounting mechanism like that of paddle 120′ and cutter bar float air bag 124′ or that of intermediate paddle 120 and cutter bar float air bag 124. The cutter bar float air bag and mounting mechanism for drive paddle 120″ may be appropriately configured to be able to appropriately support not just the drive paddle 120″ itself and a portion of the weight of cutter bar 122, but also some of the additional significant additional weight of the knife drive mechanism as described above.

Also, in an alternate embodiment of cutter bar float paddles 120/120″, a different arrangement for the cutter bar float air bags 124 and their mounting mechanisms may be provided. This alternate mechanism may be like the mechanism for end region paddle 120′ and its cutter bar float air bag 124′ and will in combination with the pressurized air delivery system also provide a mechanism that creates a spring rate response/behavior of the pivot mechanism for cutter bar float air bag 124 of all paddles 120/120′/120″ that provides close to a constant spring rate over the full range of pivoting motion of each paddle 120/120′/120″ about the transverse pivot axes. This means that the counteracting forces provided by the action of the cutter bar float air bag over the entire range of pivoting movement of all the paddles 120/120′/120′ will remain substantially the same, in particular when the header is operating in flex mode as described herein.

By adjusting the pressures in the air bags 124/124′ it is possible to adjust the weight of the paddles 120, 120′, 120″ and the cutter bar 122 and other components supported thereon that is felt on the terrain surface. Also, as will become evident, this can also result in or permit the setting of the weight that will be felt be each skid shoe 202a-h that is in contact with the terrain surface when the skid shoe adjustment system 300 described herein is activated to extend the skid shoes 202a-h.

Each cutter bar float air bags 124, 124′ (including the drive paddle air bag) may be operable to provide an air suspension/force cushioning effect to the pivoting movement of each cutter bar float paddle 120/120/120″ about axis X1 relative to the horizontal strut 116, when forces are imparted upon cutter blade 122 and thus on the paddles 120, 120′ 120″, including the downward acting force of gravity on the cutter bar 122 and paddles 120,120′,120″ and components supported thereon, and upward acting forces imposed by rising terrain as cutter bar 122 moves across the terrain surface during operation of agricultural apparatus 30.

Each cutter bar float air bag 124, 124′ (including the drive paddle air bag) may, through a plurality of hoses and valves, be in pneumatic communication with, and be a part of, a pneumatic system (which may be compressed air or possibly another suitable gas) that also includes a gas (air) compressor and a gas (air) storage/working tank. While in some embodiments, the pneumatic system uses pressurized air as the pressurized gas, other embodiments may utilize other suitable gases such as gases that may be less thermally expansive than air (e.g. for use in some climatic environments). For example, the pneumatic system may utilize pressurized nitrogen gas.

Each cutter bar float air bag 124 (including the drive paddle air bag) may be inflated and deflated by the pneumatic system over a range of air pressures such as for example between 30 psi and 100 psi. or between 30/40 psi. and 120 psi. Each cutter bar float air bag 124 (including the drive paddle air bag) may be made of a generally tubular side wall made of a resiliently expandable material such as a rubber. The sidewall material may be permanently bonded to/crimped with metal generally cylindrical, flat end plates at opposite ends. Cutter bar float air bags 124 (including the drive paddle air bag) may also be sized, configured and positioned to be able to exert appropriate forces/pressures (also known as resistance forces) on the surface of each plate member 123 and opposed facing surface of horizontal strut plate 121 of respective horizontal strut 116 when the interior cavity of the cutter bar float air bag 124 is pressurized by the pneumatic system. Each cutter bar float air bag 124′ may be constructed like and also operate in a similar or substantially the same manner. An example of a known type of air bag that might be employed as a cutter bar float air bag 124 is the model FD 70-12 CI Double Convolution Air Acutator made by ContiTech AG and/or one of its affiliated companies or a comparable AIRSTROKE™ actuator made by Firestone Industrial Products, LLC. Such an air suspension bag may have upper and lower plates with a diameter of about 4.25 inches and the interior of the bag may have operating internal volumes of between about 40 cubic inches to 110 cubic inches over operating pressures of between about 30/40/50 psi and 120 psi.

It should be noted that a pressurized gas bag, such as cutter bar float air bags 124, 124′ may function like a spring device in which the spring rate is able to be varied by the air pressure inside the air bags. The higher the internal air pressure, then the stiffer the spring force action of the air bags.

It should also be noted that all such pressurized gas bags may, in addition to being capable of resisting and imparting varying forces may also be capable of functioning to act as vibration isolators/dampeners.

The level of the air pressure within each cutter bar float air bags 124/124′ including the air bag of drive paddle 120″ provided by the pneumatic system (as well as the height of main frame 100 relative to the terrain surface) can be varied to alter how much of the weight of the cutter bar 122 is carried on the frame 100 and how much is supported by the contact (if any) between the cutter bar 122 and by the stabilizer apparatuses 500 (as referenced below) and the terrain surface. When each of the transversely spaced float air bags 124/124′ and the drive paddle air bag is inflated to a relatively high, typically the same, initial setup pressure by the pneumatic system (e.g. a maximum pressure such as 100 psi) each cutter bar float air bag 124 then all of the float air bags 124/124′ will have expanded, and the cutter bar float paddles 120/120′/120″ will be forced to pivot about their respective axes X1 relative to the horizontal strut 116 to a maximum upwards extent permitted. A stop member may be provided to limit the upwards movement of the forward portion of cutter bar float paddle 120/120′/120″. The pressure in each of the cutter bar float air bags 124/124′ (including the drive paddle air bag) may be set to such a high level that the float air bags will be very difficult to compress during operation of agricultural apparatus 30 as header 12 moves through a crop field. Thus, if the height of header main frame 100 is set at a particular desired cutting height above the terrain, cutter bar 122 will, when travelling over flat terrain surface, have most, or at least the majority, of its weight carried by the main header frame 100. This is because, each cutter bar float paddle 120/120′ and the drive paddle air bag will be unable to pivot to move the cutter bar 122 downwards, to any significant extent relative to horizontal strut 116 and cutter bar 122 will typically not be providing any support for the weight of header 12. This creates a relatively high degree of stiffness of the entire cutter bar 122 which results in the entire cutter bar 122 being substantially rigid, and substantially fixed in upward/downward movement relative to horizontal struts 116, and consequently also relative header main frame 100. None of cutter bar float paddles 120/120′/120″ will be able to pivot to any significant extent about their respective axes X1, and cutter bar 122 will behave substantially like a cutter bar this is fixedly connected to, and unable to move relative to, header main frame 100. This mode of operation may be referred to as the cutter bar 122 operating in a “rigid mode”. In this mode, the height of the header main frame 100 and of cutter bar 122 can be set to a desired cutting height relative to, and typically a few inches above, the terrain surface. In this mode of operation, the weight of the cutter bar 122 is not generally being carried by the contact between the cutter bar and the terrain surface.

However, by varying/lowering the pressure in each of the cutter bar float air bags 124/124′ including the drive paddle air bag, each cutter bar float paddle 120/120′/120″ and cutter bar float air bag 124/124′ arrangement referenced above, can also be operated in a different manner such that cutter bar 122 can “flex” transversely across its width relative to main support frame 100 (i.e., along its entire length or at one or more certain sections across its width). If each of the float air bags 124/124′ (including the drive paddle air bag) is inflated to a specified lower pressure level (e.g. at an initial setup pressure such as about 30, 40 or 50 psi) then the float air bags 124/124′ including the drive paddle air bag), will act more like a spring that allows each cutter bar float paddle 120/120′ to pivot about axis X1 when the cutter bar 122 is subjected to upward and downward variations in forces, such as the force of gravity acting on the cutter bar and the result of the interaction of the cutter bar 122 with a changing level of the terrain surface. The pressure in the float air bags 124/124′ and the drive paddle air bag may be at a level that the cutter bar float air bags 124/124′ including the drive paddle air bag will be able to be resiliently compressed during operation of agricultural apparatus 30 as the header 12 moves through a crop field. This pressure level creates a lower degree of stiffness in the cutter bar float air bags 124 (which results in each cutter bar float paddles 120/120′/120″ being able to pivot about their respective axes X1) and cutter bar 122 will be able to move upwards and downwards within a range of movement when subject to variations in upwardly/downwardly acting forces, typically caused by changes in the level of the terrain surface. This may be referred to as the cutter bar operating in a “flex mode”.

At a relatively lower air pressure level in the cutter bar float air bags 124/124′ including the drive paddle air bag (e.g. 30, 40, 50 psi), the header frame height may be selected such that a relatively high proportion of the weight of cutter bar 122 (and the paddles 120/120′/120″ that support it on frame 100) is being carried by the cutter bar's contact with the terrain surface and a lower proportion, if any, of the weight of the cutter bar 122 (and paddles 120/120′/120″) being supported by header frame 100. Even in flex mode, the forces acting on header frame 100 itself (including the weight of header main frame 100) will be carried mostly by the propulsion unit 14 but may in part also be carried by stabilizer apparatuses 500 (FIG. 1C) which may possibly be in contact with the terrain surface.

In flex mode of operation of header 12, it may be quite typical for the terrain surface to be supporting at least 75% of the entire weight of the cutter bar 122 and the paddles 120, 120′, 120″ and components attached thereto, when for example operating on generally level terrain with the remaining portion of that weight carried by the propulsion unit 14 and no proportion of the weight of the cutter bar 122 and paddles 120, 120′, 120″ being carried by the stabilizer apparatuses 500. In flex mode, depending on the air pressure level in the cutter bar float air bags 124/124′, all or some of the paddle and cutter bar weight may be carried by the main frame 100 and then in turn, by the propulsion unit 14. The air pressure in cutter bar float air bags 124/124′ including the drive paddle air bag can be adjusted to make the cutter bar/skid shoes 202a-h (as discussed below) light enough on the terrain contact point [e.g. 50 pounds at the contact location of each cutter bar/skid shoe on the surface terrain]. In this case the total paddle/cutter bar mass-minus-50 pounds, would be carried by the header main frame and propulsion unit 14 in a flex mode of operation.

In a rigid mode of operation of header 12, it may be quite typical for the terrain surface during normal operation to be supporting no proportion of the entire weight of the cutter bar and the paddles 120, 120′, 120″ when for example operating on generally level terrain. Instead that entire weight will be carried in large part by the propulsion unit 14, and in a smaller proportion by the stabilizer apparatuses 500. For example, in rigid mode, the load carried by the stabilizer apparatuses 500 (e.g. gauge wheels)—which may ˜300-900 pounds for each stabilizer apparatus-would be subtracted from the entire weight of header 12. This load carried by the stabilizer apparatuses 500 can vary with the pressure in the frame gas suspension bags (that operate between main frame 100 and subframe 142 as referenced below) and cutting height in rigid mode. The higher the pressure in the frame gas suspension bags the less load carried by stabilizer apparatuses 500; and the lower the pressure in the frame gas suspension bags the higher the load carried by stabilizer apparatuses 500.

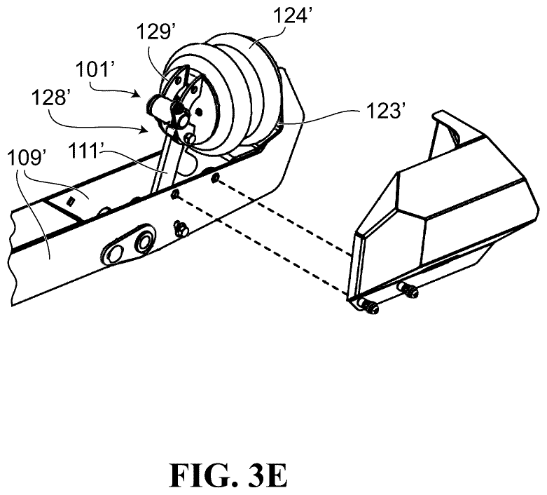

When during operation, agricultural apparatus 30 is moving through a field, cutter bar 122 may be configured in “flex mode” and the main frame 100 height may be selected (as described further below) so that the cutter bar 122—or more specifically the cutter bar skid plate and/or the skid shoes as described below-particularly when on level terrain—are generally in contact with the terrain surface. The header frame 100 may have been positioned at a particular desired position relative to the propulsion unit 14. For example, if the cutter bar 122 has a range of relative upward and downward movement relative to header main frame 100 of 9 inches, the header height control system 10 (FIG. 4) may be set such that when the cutter bar is resting on a level terrain surface, the cutter bar may be set at a desired cutting position of 2 inches down from the uppermost zero-inch position. This means that that each cutter bar float paddle 120, 120′, 120″ is able to independently move upwards 2 inches and downwards 7 inches relative to the header main frame 100. This may be the baseline set point configuration for header height in flex mode. When cutter bar 122—or a portion of cutter bar 122 encounters a portion of rising terrain surface, if the height control system for header main frame 100 does not raise the entire header 12 relative to the propulsion unit 14, the cutter bar 122 may rise relative to the header main frame 100, as the forward regions of one or more cutter bar float paddles 120/120′/120″ pivot upwards relative to and about the pivot connection with its respective horizontal strut 116. This allows the respective float air bags 124/124′ including the drive paddle air bag to expand, reducing the air pressure therein. During such operation in flex mode, the main header height control system 10 which controls the height of main frame 100 relative to propulsion unit 14, may continue to be utilized to try to maintain main frame 100 at such a position that the entire cutter bar 122 is generally during operation being maintained at about a 2-inch desired cutting position, on level terrain.

However, when cutter bar 122—or a portion of cutter bar 122—encounters a portion of terrain surface at a lower level, the header height control system 10 (FIG. 2) may not need to respond to lower header main frame 100 relative to the propulsion unit 14, and may remain at its set cutting position. Instead, cutter bar 122 (or a portion of the cutter bar) may lower relative to the header main frame 100, as forward regions of one or more cutter bar float paddles 120/120′/120″ pivot downwards (and may twist about a longitudinal axis) relative and about the pivot connection with its respective horizontal strut 116 due to the weight of the cutter bar 122. If all of the cutter bar float paddles 120, 120′, 120″ are provided with the constant spring rate mechanism described above in relation to FIGS. 3D and 3E, then as the cutter bar float paddles 120/120′/120″ pivot downwards at the front regions with cutter bar 122, the rear plate member 123 (or corresponding components) will compress the float air bag(s) 124/124′ and drive paddle air bag but not substantially changing the interior volume or the air pressure therein, and thus maintaining at substantially constant level of the counteracting forces being exerted back by the air float bags 124/124′ including the drive paddle air bag against the cutter bar float paddle 120, 120′, 120″. This maintains a cushioning effect by a portion of the weight of the cutter bar 122 is being carried by the header main frame 100 and a portion of the weight of the cutter bar 122 is being carried by the terrain surface—and also maintains the load proportions substantially the same during upward and downwards movement of the paddles and cutter bar 122.

It should be noted that this response of the cutter bar 122 to the downward change in surface level can occur more quickly than header height control system 10 as the response is direct, as compared to the response of the header height control system 10 which acts in response to header height signals that control hydraulic cylinders to adjust the position of the header frame 100.

Referring now to FIG. 4, to control the position of header 12, apparatus 30 as shown in FIG. 1 may include a header height control system 10 for controlling the movement/position of the header and in particular the movement and position of main frame 100, relative to the propulsion unit 14. The system 10 may include a controller system 11 including a sensor system 16, a controller 18, and a header positioning system 22. The controller system 11 may be a known controller system such as supplied by a manufacturer of the apparatus for controlling movement of the agricultural implement.

Referring to FIG. 4, sensor system 16 may be configured to sense a position of the agricultural implement (e.g. of the sub-frame 140 relative to main frame 100) and to transmit position signals representing the sensed position to controller 18. Controller 18 may receive the position signals representing the sensed position and compare the sensed position to a desired position to determine a difference. Controller 18 may then produce control signals, based on the difference. Controller 18 may be configured to transmit the control signals to header positioning system 22 which may control hydraulic actuators, for example to cause movement of the sub-frame 140 and main frame 100 of header 12 towards a desired position relative to propulsion unit 14. While the embodiments herein are described with reference to hydraulic actuators, in some embodiments, other types of actuators such as electrical actuators may be employed to cause movement of the sub-frame 140 along with main frame 100 of header 12.

Header positioning system 22 may have a positioning response time for causing the agricultural implement to respond to the control signals. In cases where the positioning system 22 has a positioning response time that results in excessive movement or “hunting” for the desired position, system 10 may be provided with a signal conditioner 20, which is configured to condition the control signals transmitted by controller 18 and normally received by header positioning system 22. The conditioner 20 may be configured to intercept the control signals transmitted by the controller 18 and to transmit conditioned control signals or output signals to the positioning system 22 instead of the control signals, in response to the control signals transmitted by controller 18.

Referring back to FIG. 1, system 10 of FIG. 4 may be mounted on apparatus 30. In the embodiment shown, sensor system 16 may include left, and right sensors 32 and 36 located at first and second locations on left and right ends respectively of main frame 100 of header 12. Sensors 32 and 36 may be sensors utilized by controller 18 when header 12 is operating in a rigid mode as referenced above.

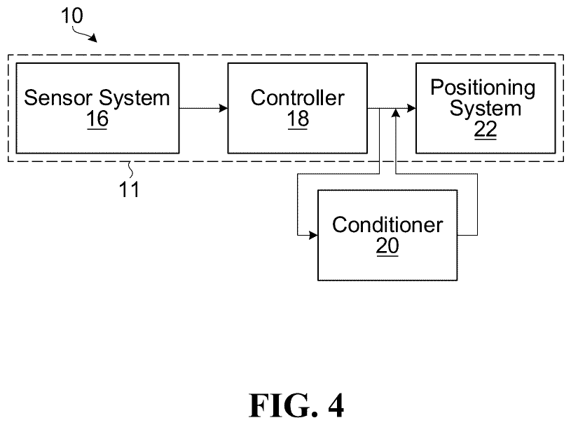

Referring to FIGS. 1 and 5, sensors 32, 36 may be configured to send left and right position signals 40 and 44 representing left and right sensed positions or heights of respective locations on header 12 (in particular on header main frame 100 relative to sub-frame 140) relative to the terrain to controller 18. In some embodiments, the sensors may each include a sensing arm or paddle attached to main frame 100 (shown at 33 and 37 in FIG. 1) and a Hall Effect sensor configured to sense a rotational angle of the sensing arm. Sensing arm/paddles 33 and 37 may detect when contact is made with the terrain surface, or when changes in height of the terrain surface relative to main frame 100 occur and may as a result of such contact with the terrain surface cause controller 18 to cause positioning system 22 to adjust the height of the header.

When operating in flex mode, instead of sensors 32, 36 being utilized to provide signals to controller 18, flex header height control (HHC) sensors of sensor system 16 may be employed and may be operable to provide signals/data to controller 18 indicative of the amount of angular pivoting of each of paddles 120/120′/120″ relative to the horizontal struts 116. A plurality of mechanical angle measuring HHC sensors may be mounted across the width of the header 12, with a single HHC sensor deployed proximate each transverse end of header 12, and further HHC sensors (e.g. 4 or more sensors) being transversely spaced between the end HHC sensors across the width of header 12. Each of the HHC sensors may be mounted on, for pivoting movement relative to, a common bar, that is circular in cross section and extends transversely. Each HHC sensor may have a lower arm portion interconnected to a paddle 120/120′ and an upper portion that is interconnected to the frame. The upper portion of each HHC sensor may comprise a connecting rod that extends upwards to a sensor arm. Pivoting of a paddle 120/120′/120″ causes the interconnected sensor arm to pivot-which provides a signal to controller 18 of the angle of the paddle relative to its support strut 116.

A mechanical arrangement for the HHC sensors may employ a mechanical “voting system” for each side of header 12. Such a voting system mechanism employed may be configured to only respond to the HHC sensor that has the closest to zero-inch amount of deflection. For example, if a few of the paddles 120/120′/120″ drop below two inches in their amount of downward deflection for the zero-deflection position, but the least amount of downward deflection of an HHC sensor on either a right or left side of header 12 is two inches, then only the HHC sensor on a side that is indicating the two inches of downward deflection will provide a signal/data to controller 18 which may cause positioning system 22 to respond. In other embodiments, instead of a mechanical arrangement for creating a voting system for the HHC sensors, the controller 18 may be programmed with a suitable algorithm to achieve the same function when receiving signals/data from each of the HHC sensors. By implementing such a voting system, localized drops in terrain across the transverse width of header on each side will be disregarded by controller 18 when controlling the header height in response to the HHC sensors.

The HHC sensors may be configured to provide a flex mode sense range of 0-9 inches which corresponds to the range of upward/downward movement of the paddles 120, 120′, 120″. The output from the HHC sensors may be ˜1.5-3.5 volts. As will be described further hereinafter, a set point for the header height control in flex mode of operation can be 2v @ 2 inches downwards from the upper range limit of movement (i.e. the zero downward deflection position). The controller 18 will then be operating the positioning system 22 to seek and hold the 2-volt set point with hydraulic adjustments to height and lateral tilt that achieve this for both left side and rights side signals. This may be referred to as “Auto Header Height” control.

In various embodiments the left and right position signals 40 and 44 may be electrical signals which have a voltage level representing a sensed position or height measured by their respective sensor. For example, the voltage level of the left and right position signals 40 and 44 may be between a low voltage level and a high voltage level, with a low voltage level representing 0% of a maximum sensed height and high voltage level representing 100% of the maximum sensed height. For example, in some embodiments, the low voltage level may be about 1 Volt and the high voltage level may be about 4 Volts. However, in various other embodiments, the high and low voltage levels of the left and right position signals 40 and 44 may be other voltage levels.

Referring still to FIG. 5, in various embodiments, controller 18 may be configured to receive or sample the left and right position signals 40 and 44 representing the left and right sensed heights of the main frame 100 or sub-frame 140 of header 12. In some embodiments, controller 18 may be configured to sample the position signals periodically, such as once every about 320 ms, for example. Controller 18 may be configured to compare each of the left and right sensed heights with desired left and right heights respectively to determine differences between the sensed heights and the desired heights. In some embodiments, the controller 18 may be configured to receive signals representing the desired left and right heights from memory and/or via an I/O interface of the controller 18, for example. The desired heights may be about 2″, for example.

Controller 18 may, based on the differences between the sensed heights and the desired heights, produce lift and drop control signals 46 and 48 for causing positioning system 22 to move the sub-frame 140/main frame 100 of header 12 towards the desired heights.

For example, in some embodiments, controller 18 may be configured to determine a left difference between the left sensed height and the left desired height and to determine a right difference between the right sensed height and the right desired height. When at least one of the left and right differences represents a sensed height that is less than a desired height and has an absolute value that is greater than a threshold difference, the controller 18 may produce the lift and drop control signals 46 and 48 such that, if the control signals were transmitted to positioning system 22, the control signals would cause positioning system 22 to cause main frame 100 and sub-frame 140 of header 12 (FIG. 1B) to be raised relative to propulsion unit 14 shown in FIG. 1.

If only one of the left and right differences represents a sensed height that is less than a desired height and has an absolute value that is greater than a threshold difference, the controller 18 may produce the lift and drop control signals 46 and 48 such that there will be both a suitable height adjustment of main frame 100 and sub-frame 140 relative to the terrain surface, and a lateral tilt adjustment, by positioning system 22 to achieve a desired main frame height on both the right and left sides.

If neither of the left and right differences represents a sensed height that is less than a desired height and has an absolute value that is greater than the threshold difference and at least one of the left and right differences represents a sensed height that is greater than a desired height and has an absolute value that is greater than a threshold difference, controller 18 may produce the lift and drop control signals 46 and 48 such that, if the control signals were transmitted to positioning system 22, the control signals would cause positioning system 22 to drop (i.e. lower) the main frame 100 and sub-frame 140 of header 12 relative to the propulsion unit 14 shown in FIG. 1. If the left and right differences are both within a threshold range, controller 18 may produce the lift and drop control signals 46 and 48 to cause the positioning system 22 to not change the height of the main frame 100 and sub-frame 140 of header 12 relative to the propulsion unit 14 shown in FIG. 1.

As discussed above, controller 18 may be configurable to transmit the lift and drop control signals 46 and 48 directly to positioning system 22 but, in the embodiment shown in FIG. 5, a conditioner 20 may optionally be provided which is configured to intercept the lift and drop control signals 46 and 48 produced by controller 18 and to produce and transmit conditioned lift and drop control or output signals 50 and 52 to positioning system 22 instead of the control signals. Conditioner may also receive signals from system sensors 47 (FIG. 5) which may include a hydraulic pressure sensor on a combine main pump output, for sensing pressure in a reservoir configured to control the height hydraulic cylinder 64 shown in FIG. 6. An example of the incorporation of a conditioner 20 into the control system is disclosed in U.S. Pat. No. 10,462,966 issued on Nov. 5, 2019, the entire contents of which is hereby incorporated by reference herein.

FIG. 6 shows a side view of the apparatus 30 without header 12 attached, showing elements of positioning system 22, in accordance with one embodiment. Referring to FIG. 4, positioning system 22 includes feeder house 60 which may be pivotally connected to propulsion unit 14 at pivot point 62. Positioning system 22 may also include a height controlling hydraulic system including a height-controlling hydraulic cylinder 64 connected at one end to the feeder house 60 and at the other end to propulsion unit 14. The height controlling hydraulic system may include a “lift” valve, such as, for example, a solenoid-controlled valve which may be controlled using the conditioned lift output signal 50 and a “drop” valve, such as, for example, a solenoid-controlled valve, which may be controlled using the conditioned drop output signal 52. When the lift valve is opened and the drop valve is closed, the height-controlling hydraulic cylinder 64 extends. Conversely, when the lift valve is closed and the drop valve is opened, the height-controlling hydraulic cylinder 64 retracts.

Header 12 shown in FIG. 1 is mounted to a front portion 66 of the feeder house 60 shown in FIG. 6. Extension of the height-controlling hydraulic cylinder 64 causes the front portion 66 (and thus main frame 100 and sub-frame 140 of header 12 shown in FIG. 1 when attached to the front portion 66) to move upward relative to propulsion unit 14 in the direction of arrow 67. Conversely, retraction of height-controlling hydraulic cylinder 64 may cause front portion 66 (and thus main frame 100 and sub-frame 140 of header 12 shown in FIG. 1 when attached to the front portion 66) to move downward relative to propulsion unit 14 in the direction of arrow 69.

In various embodiments, each time positioning system 22 is instructed to move, there may be a positioning response time before positioning system 22 finishes moving and reaches a generally non-transient or fixed position. In various embodiments, the positioning response time may be due to a variety of factors such as, for example, weight and momentum of feeder house 60 and/or the header 12, time required for valves of the height-controlling hydraulic cylinder 64 to open and/or close after being commanded to do so, and/or float in the height-controlling hydraulic cylinder.

Header 12 as shown in FIG. 1 is mounted to a front portion 66 of the feeder house 60 in a manner which allows for tilting together of header main frame 100, adapter plate 142, header sub-frame 140 and feeder house 60, relative to propulsion unit 14. Header 12 may thus be laterally tilted relative to propulsion unit 14 when there is a difference in the side-to-side slope of the terrain surface beneath the header, compared to the side to side slope of the terrain surface beneath the propulsion unit 14 and the corresponding slope of the propulsion unit 14 itself. Two or more transversely spaced hydraulic cylinders may be provided such that different amounts of extension/retraction of the height-controlling hydraulic cylinder 64 can cause header 12 to tilt transversely about a forwardly directed rotational axis.

Referring back to FIG. 6, header positioning system 22 may include one or more tilt hydraulic cylinders for controlling a lateral tilt of header 12. Extension of the tilt hydraulic cylinder(s) may cause the front portion 66 of the feeder house 60 shown in FIG. 6 to tilt laterally from left to right (i.e., to rotate the front portion 66 about a pivot point of the front portion by raising a left side of the front portion 66 and lowering a right side of the front portion).

In some embodiments, controller 18 may be configured to produce tilt control signals in addition to the signals already described, based on the received left and right position signals 40 and 44. The tilt control signals may be configured to control the tilt hydraulic cylinder and thus cause positioning system 22 to control a lateral tilt of main frame 100 and sub-frame 140 of header 12. In some embodiments, controller 18 may be configured to cause the tilt control signals to direct positioning system 22 to tilt sub-frame 140 and mainframe of header 12 together such that the heights of the left and right sensors 32 and 36 are equal. In some embodiments, controller 18 may be configured to transmit the tilt control signals directly to positioning system 22. In some embodiments, controller 18 may transmit the tilt control signals to conditioner 20, and conditioner 20 may relay the tilt control signals to the positioning system 22. In some embodiments, the conditioner 20 may condition the tilt control signals generally as described above having regard to the lift and drop control signals 46 and 48 shown in FIG. 5.

Agricultural apparatus 30 may also include a header suspension system to provide for shock/force absorption between header main frame 100 of header 12 and the front portion 66 of feeder house 60. The header suspension system may be an air suspension system that may include components that are also part of a pneumatic system. The pneumatic system may transmit pressurized air through hoses and valves, to and from a plurality of frame gas suspension air bags positioned operationally between header main frame 100 and header sub-frame 142. The pneumatic system may be operable to allow the air pressure in the frame gas suspension air bags to be selectively maintained at a specified air pressure, and also for the air pressure in the frame gas suspension air bags to be selectively increased and decreased. Such a header suspension system may support main frame 100 on sub-frame 140 and absorb forces transmitted between (a) the main frame 100 and cutter bar 122 of header 12, and (b) propulsion unit 14, such as when the cutter bar 122 impacts/encounters a rising portion of terrain surface while moving across terrain surface 74.

Header 12 may also be equipped with at least one stabilizer apparatus generally designated 500, (and possibly two or more) on each lateral side the header (FIG. 1C) and which are utilized to support the main frame 100, particularly when the header 12 is operating in rigid mode such that little weight of the header 12 is being carried by the cutter bar 122 or components such as skid shoes that are directly connected to, or are otherwise closely connected thereto. The stabilizer apparatuses 500—which may be wheel units having one of more wheels freely rotatable about generally transverse oriented wheels axles-on each side can assist in carrying some of the forces acting on header 12, during modes of operation such as when cutter bar 122 is in rigid mode as described above. A stabilizer apparatus 500 can also assist in “lifting” a side of main frame 100 when a stabilizer apparatus on a side, encounters a rise in the level of the terrain as header 12 moves over terrain surface 74, at least when the cutter bar 122 and header 12 are in rigid mode. Each stabilizer apparatus 500 may, at least in some modes of operation of header 12 (e.g. a rigid mode), carry at least part of the weight of header 12.

In the embodiment shown in FIG. 1C, each stabilizer apparatus 500 may comprise a gauge wheel assembly. In other embodiments, stabilizer apparatuses 500 may be a plough device, a ski device, or any other device on an agricultural implement capable of travelling in contact with terrain surface 74. As noted above, stabilizer apparatuses 500 are typically used when header is operating in a rigid mode of operation and are not used to any significant extent-if at all-when the header is operating in a flex mode.

In many crop cutting situations, it may be desirable to be able to utilize a flex mode of operation of header 12 as described above. This allows cutter bar 122 to move upwards and downwards within a limited range of movement, relative to header frame 100 and provide have enhanced capability to follow changes in the level of the terrain surface beneath the cutter bar. However, it may at the same time, in some situations also be desirable to harvest the crop material when cutter bar 122 of header 12 and the associated cutting blades, are kept at a constant height or vertical separation distance that is a few inches or several inches above the actual terrain surface beneath the cutter bar/cutting blades (such as for example in the range of zero inches to about 8-11 inches above the terrain surface) with cutter bar 122 not resting on the terrain surface. As noted above, it can be important to maintain the fixed separation height of cutter bar 122 relative to the terrain surface for one or more reasons in a particular operating situation. For example, the terrain surface may have inconsistencies or undulations which may cause portions of cutter 122 to strike the terrain. This may be more likely as the speed of agricultural apparatus 30 increases. Contact of cutter bar 122 with the terrain may result in excess wear, damage for failure of cutter bar 122 or associated components. It is beneficial if these negative consequences can be avoided or at least the frequency of the same reduced. Additionally, as referenced above, depending on the type and/or condition of crop to be cut, it may be desirable to cut the crop a particular distance above the terrain surface to maximize yields and/or to provide crop remains in the field after crop cutting of a particular height or height range.

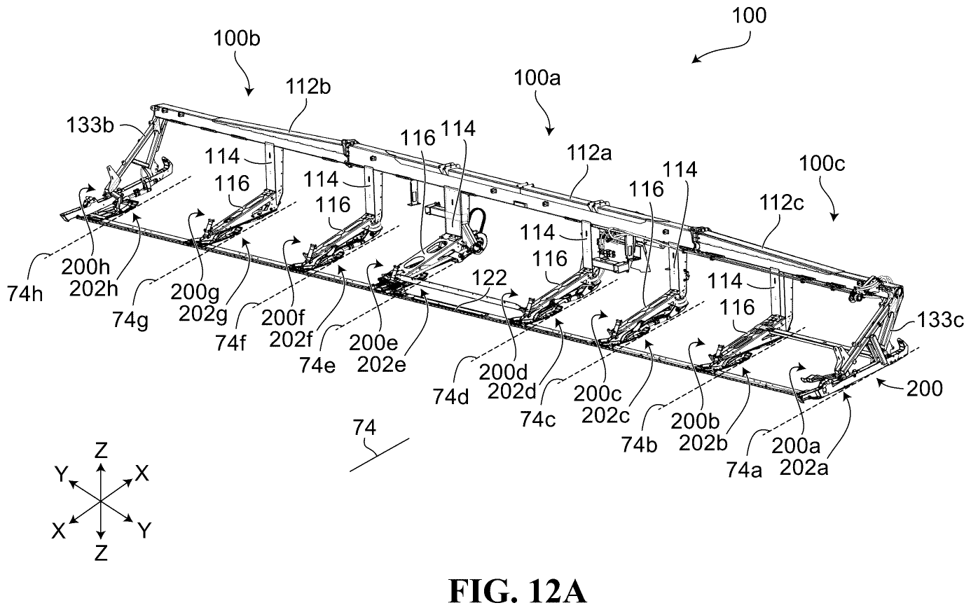

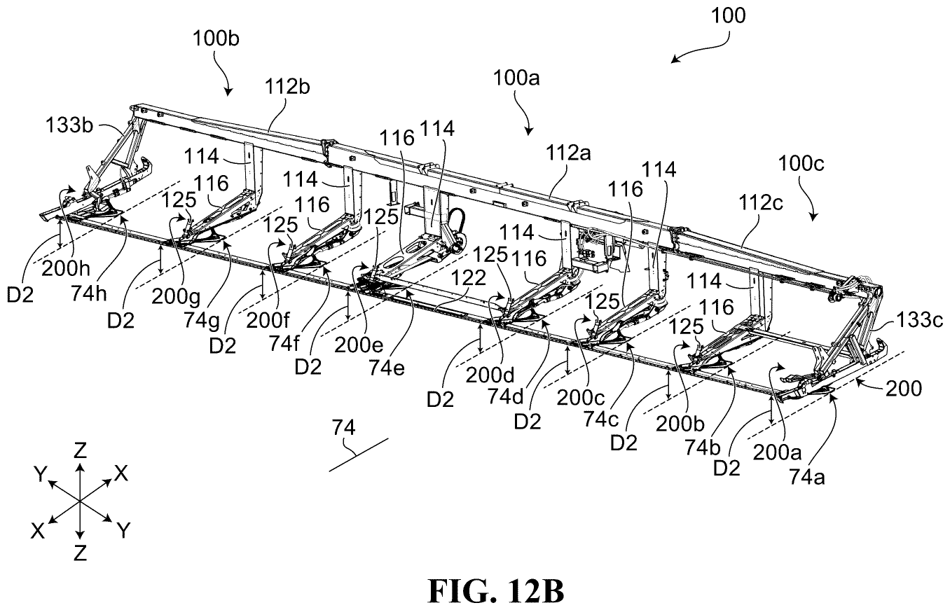

To be able to adjust and hold the position of cutter bar 122 (and paddles 120′/120′/120″) above the terrain surface when header 12 is operating in a flex mode, header 12 may therefore include a height adjustment apparatus, which may be a skid shoe cutter bar height adjustment apparatus 300 (generally referred to herein as a skid shoe adjustment system 300). Skid shoe adjustment system 300 may include one or more, and preferably at least two or more terrain contact assemblies such as for example skid shoe assemblies 200 (FIG. 12A). For example, skid shoe adjustment system 300 may include skid shoe assemblies 200a-h (FIG. 12A). If there is more than one skid shoe assembly 200, they may be transversely spaced apart (spaced apart in the Y direction in FIG. 1) across the transverse width of header 12. Each such skid shoe assembly 200 may be positioned with a lower surface area located at a lower vertical elevation on header 12 relative to cutter bar 122, thus providing a lower/bottom contact surface for making contact with terrain surface 74 and thus preventing cutter bar 122 and other components of header 12 such as cutting blades, from directly contacting terrain surface 74. The number of skid shoe assemblies 200 that are employed on a header (and the corresponding amount of skid shoe surface area on each skid shoe 200 that contacts the terrain surface) may be dependent upon a number of design factors including the overall weight and transverse width of the header and the configuration of the skid shoe assemblies 200 including the load capacity of their associated hydraulic cylinders (as described below).

As will be described further hereinafter, when each skid shoe assembly 200a-h and its corresponding terrain contact element (such as skid shoes 202a-h) are in a fully retracted position (e.g. FIG. 7C), then the terrain contact element that have a terrain contact element contact region that may be in contact with the terrain surface 74 (particularly on level terrain) and that contact region may be the underside surface of cutter bar 122 (which in some embodiments may be lower cutter bar skid plate 1123). This terrain contact element may make contact with the terrain surface at a longitudinal position X (Ret) and in some embodiments no portion of the underside surface of a component of the skid shoe assemblies 200a-h may be in contact with the terrain surface. In other embodiments, a portion of the underside surface of a component of the skid shoe assemblies may be in contact with the terrain surface when the skid shoes 202a-h are fully retracted. Each skid shoe assembly 200a-h may include at least one terrain contact element that has a terrain contact element contact region/location with the terrain surface 74 having a longitudinal position X (Ext) that is longitudinally proximate to/only a relatively short longitudinal separation distance X (Sep) (FIG. 8C) away from (in direction X in FIG. 1) cutter bar 122 and the cutting blades/devices (eg. a short distance behind the cutter bar 122) and from longitudinal position X (Ret). This relatively short longitudinal separation distance X (Sep) between the skid shoe contact region/location and the terrain contact location of cutter bar 122 may be 24 inches or less and may be in the range of 18 inches to 21 inches. Thus, even when the level of the terrain surface/slope changes quickly in a longitudinal direction, as the header 12 moves in a longitudinal direction through a crop field, the level of terrain surface 74 where the terrain contact element contact location is positioned at any time during operation, will be quite close to (or substantially the same as) the level of the terrain surface beneath where the actual cutting blades of the cutter bar 122 are engaging the crop material that is being cut. Thus, the level of the terrain surface at each skid shoe contact location X (Ext) will be maintained in close alignment with and be close to the level of the terrain surface that lies directly beneath the actual cutting blades on the cutter bar 122, even when the level of terrain surface changes quite steeply longitudinally over the terrain in which the cutter bar is operating.

Each of the slid shoe assemblies 200a-h of skid shoe adjustment system 300 may have one or more terrain contact elements (FIG. 12A)—such as a skid shoes 202a-h [which may be like skid shoe 202a (FIG. 7A)]. In embodiments (e.g. FIG. 8E), the terrain contact elements may additionally or alternatively include a wheel unit 510 having one or more freely rotatable wheels mounted on a wheel axle. In some embodiments, freely rotatable wheels may be mounted on the skid shoe itself, such as having a wheel with a diameter in the range of 3 to 6 inches and having a wheel width of about 4 to 8 inches wide being integrated into and extending beneath a lower surface of a cover plate 210 of skid shoe assemblies 200a-h (FIG. 7A). In other embodiments, the skid shoe assemblies 200a-h may not have a component which resembles a skid shoe like skid shoe 200a with a base plate 204, a front cover plate 208 and a rear cover plate 210 (FIG. 7A) as further discussed below). Instead, freely rotatable wheels may be mounted on the skid shoe itself, such as having a wheel with a diameter in the range of 3 to 6 inches such as for example wheels being about 5 inches in diameter and a width in the range of 2 to 4 inches that may be employed as part of the skid shoe assemblies 200a-h and may provide the only terrain contact elements.

Header 12 may be designed such that there will be a skid shoe adjustment system including skid shoe assemblies 200a-h corresponding to and mounted on each of the paddles 120, 120′, 120″ that support the cutter bar 122 and its cutting devices for upwards and downwards movement relative to the header main frame 100. The wider the header, then the more support paddles/units and the more corresponding skid shoe assemblies that will be provided. Each of paddles 120, 120′ and 120″ across the width of header 12 and their assemblies, may be designed and the pressures in the cutter bar float air bags 124/124′ may be set, so that the same downward force is applied to each of the terrain contact elements (e.g. skid plates) and be subject to equal and opposite forces applied by the terrain surface 74 to the terrain contact elements. This can be arranged at least in in part by adjusting the amount of the downward force applied by the cutter bar float air bags 124, 124′ to the paddles on the opposite side of the pivot axis for the paddles-so that the cutter bar air float bags support some portion of the weight of the paddles 120, 120′, 120″ as referenced above. Specifically, by adjusting the pressures in the air bags 124/124′ it is possible to adjust the weight of the paddles 120, 120′, 120″ and the cutter bar 122 supported thereon that is felt on the terrain surface. This can also result in or permit the setting of the weight that will be felt by each skid shoe 202a-h that is in contact with the terrain surface when the skid shoe adjustment system 300 described herein is activated to extend the skid shoes 202a-h.

The arrangement can be designed and selected such that the terrain contact elements/skid shoes 202a-h never carry a significant portion of the entire weight of the paddles 120, 120′ and 120″, the components supported thereon, and cutter bar 122. For example, the arrangement can be designed and selected such that terrain contact elements may only carry about 50 pounds of weight on a single skid shoe contact plate region (known as the cutter bar being “light”). Also, the arrangement can be designed and selected such that the terrain contact elements/skid shoes 202a-h each carry about the same amount of the entire weight of the paddles 120, 120′ and 120″ and cutter bar 122 (known as the cutter bar being “heavy”).

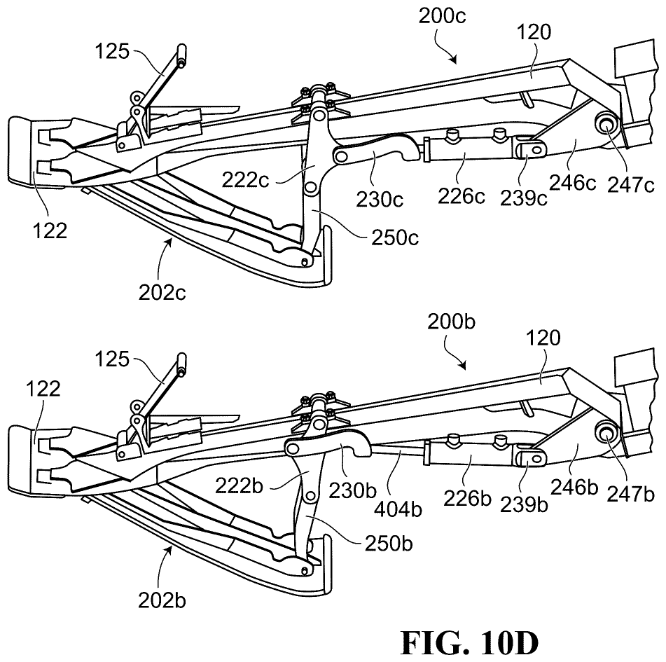

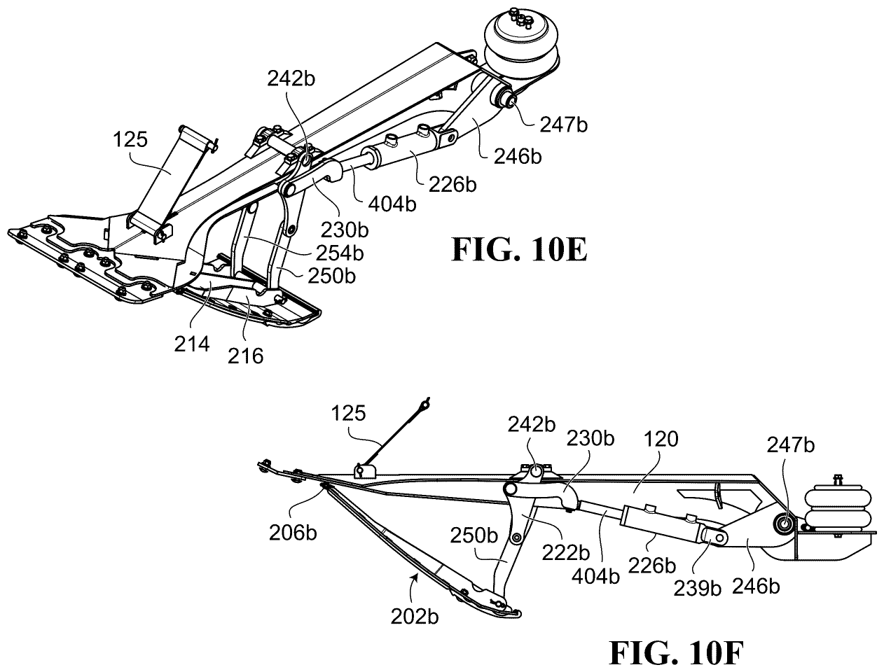

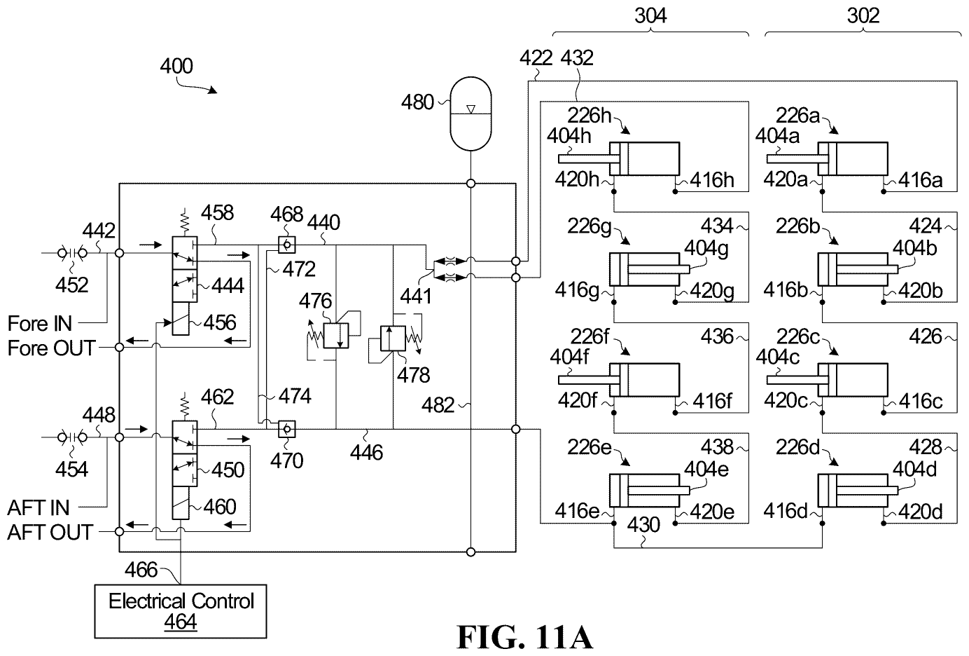

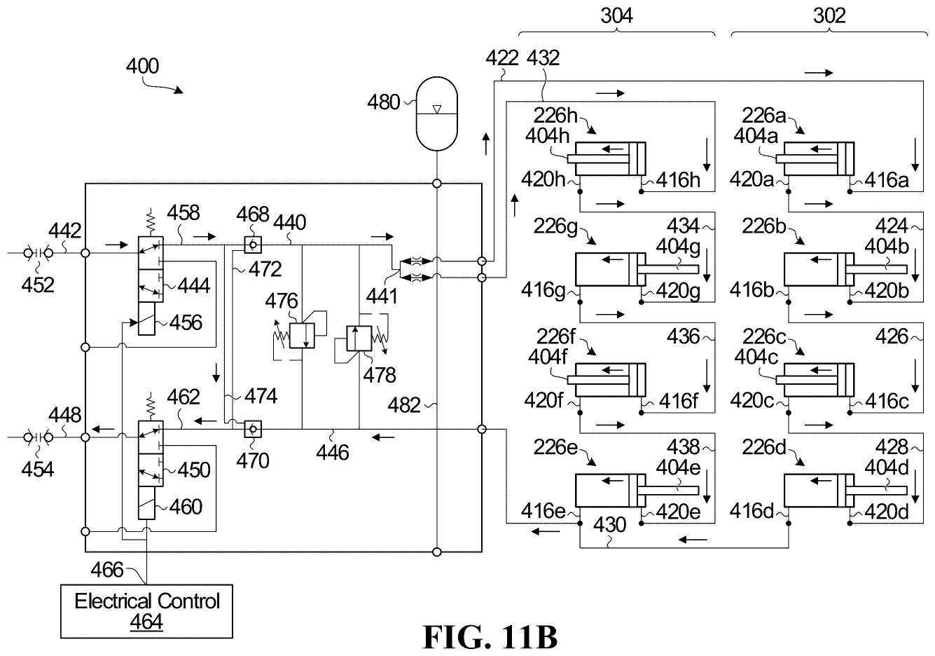

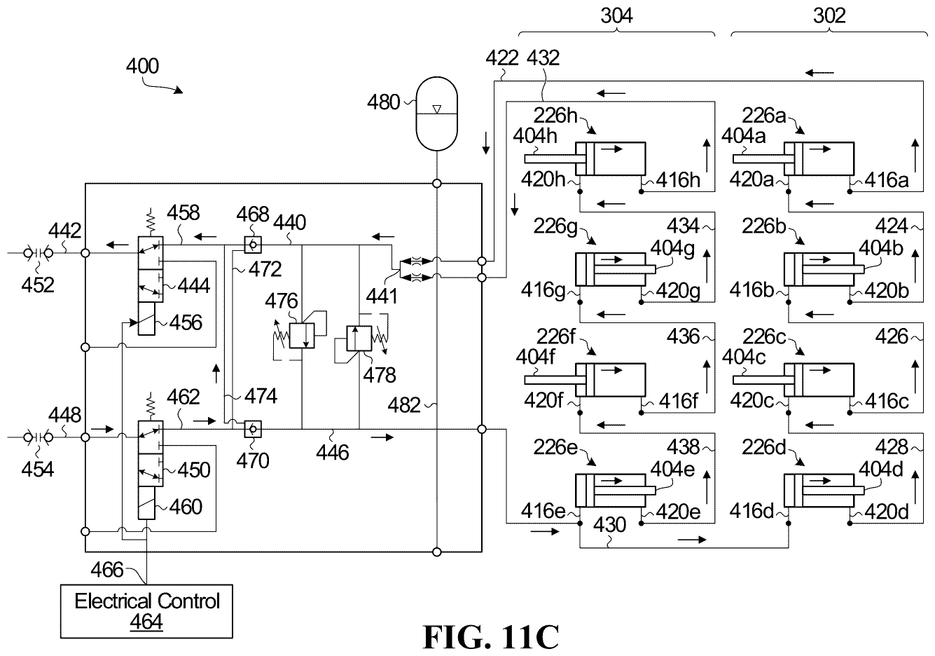

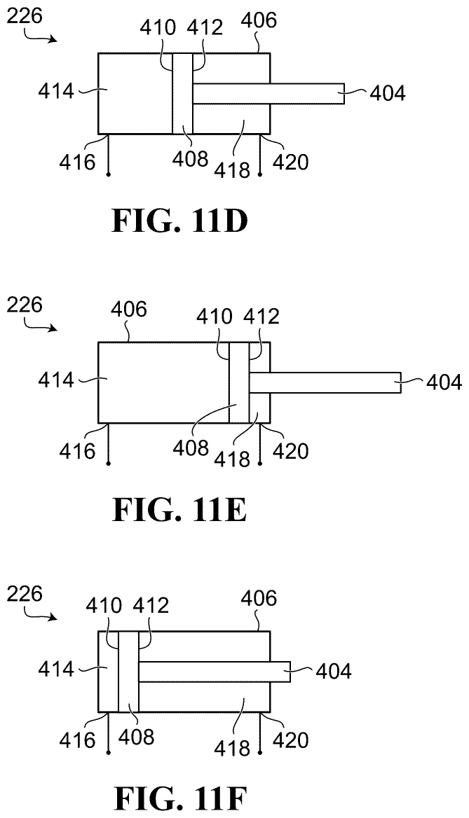

Each of terrain engagement elements (e.g. skid shoes 202) of the skid shoe assemblies 202a-h (such as skid shoe 202a of skid shoe assembly 200a) may be configured and operable (such as with linkages and actuators such as hydraulic cylinders 226a-h with moveable piston rods 404a-h—see FIG. 11A) so that during operation in flex mode of header 12, each skid shoe 202 may move upwards and downwards relative to header frame 100 to follow the level of the terrain surface which it contacts, and a portion of the weight of the paddles 120, 120′, 120″ will be carried by each of the terrain engagement elements (e.g. skid shoes 202) that are in contact with the terrain surface. During normal operation in flex mode of header 12, when travelling over level terrain surface, the terrain contact elements (e.g. skid shoes 202) may in combination support in the range of one percent to 100% of the weight of all the paddles 120, 120′, 120″.

Also, each of the skid shoe assemblies 200a-h, including terrain contact elements such as skid shoes 202, may be mounted/directly connected to the same pivoting/movement support system/components that support the cutter bar 122 on header frame 100 for upward and downward movement relative to header frame 100 (e.g. cutter bar float paddles 120, 120′) and also partly mounted/directly connected to cutter bar 122. Thus, the upwards and downwards movement of each of the terrain contact elements (e.g. skid shoes 202) may also be directly related to/correspond with the upwards and downwards movement of the cutter bar 122. In operation, as each of the terrain contact elements such as skid shoes 202 move upwards and downward relative to header frame 100, as they follow the level of the terrain surface, so do each of their corresponding paddles 120/120′/120″ to which they are fixedly attached, and thus so does the cutter bar 122 (or portions thereof) across its transverse the width of cutter bar 122, which is also fixedly attached for upwards and downwards movement on paddles 120/120′/120″. During operation in a crop field, the vertical separation distances of the cutter bar 122 and the terrain contact elements, relative to main frame 100 of header 12 will thus vary together in synchronized movement, if header 12 is operating in flex mode (such as for example as described above), such that the distance between the level of the terrain surface 74 and cutter bar 122 is also varied when each terrain contact element 200 is in contact with a respective portion of the terrain surface as header 12 moves across varying levels of terrain surface.

It may be appreciated that under the voting system mechanism described above, under certain conditions a small gap between the terrain surface 74 and one or more of the skid shoes 202 may exist. For example, if all except one of the skid shoes 202 were to encounter a depression in terrain surface 74 of 10 inches (exceeding the maximum 9 inch range of downward motion of the paddle regions 120a, 120a′ allowed by paddle travel limiting straps 125, 125′), then the header height control system 10 may not fully compensate for this, resulting in a one inch gap between all except one of the skid shoes 202 and the terrain surface 74.

Each of the skid shoes 202 of each skid shoe assembly 200a-h may be configured and operable to contact the terrain surface 74 as the cutter bar 122 moves forward in a crop field and maintain for each of the skid shoes 202, a fixed and the same set amount of skid shoe extension at a set position at or between the fully retracted position and the fully extended position. This may result in the maintenance-during operation—of a selected set skid shoe vertical separation distance for each skid shoe 200 of each skid shoe assembly 200a-h, which may extend between: (a) a specific location on the paddle 120/120′/120″ such as a location where a part of a skid shoe assembly is attached to a paddle 120/120′/120″ and (b) the terrain surface 74 vertically beneath that specific location on paddle 120/120′ at that transverse location of cutter bar 122. For example, height D1 in FIGS. 7C and 8C depicts the height of a specific location on paddle 120′ denoted by the location of a pivot housing 236 with a pivot pin 234 which is vertically separated from the terrain surface level 74 beneath by a vertical separate (ion distance (D1 (Ret) in FIG. 7C and D1 (Ext) FIG. 8C). The vertical separation distance may be D1 (Ext) when the skid shoe 202a is in the fully extended position (FIG. 8C) and may be D1 (Ret) when the skid shoe is in the fully retracted position (FIG. 7C). By adjustment of the skid shoe height adjustment mechanism described herein, the vertical separation distance D1 may be set at any distance between D1 (Ret) and D1 (Ext). By selecting and setting a specific separation distance D1 that may be associated with a skid shoe 202a, this results in a corresponding cutter bar vertical separation distance (for example D2 (Ret) in FIG. 7C and D2 (Ext) in FIG. 8C) at that transverse position on cutter bar 122. In FIG. 7C when fully retracted, the distance D2 (Ret) may be substantially close to zero inches. When header 12 is on level terrain (both longitudinally and transversely) the vertical separation distances may be set at the same distance D1 for each of skid shoes 202a-h for each of the skid shoe assemblies 200a-h across the entire width of header 12. In an example embodiment, the range of height adjustment available of the skid shoes 202a-h [D1 (Ext) minus D1 (Ret)] may be about 8 inches. For a terrain contact element that includes one or more freely rotatable wheels with a diameter of about 5 inches and a skid plate assembly, or just comprises one or more freely rotatable wheels without any terrain contact plates, the range of height adjustment may be about 11 inches. This will result in a corresponding equal maximum height adjustment available to the cutter bar 122 to adjust the separation distance D2 associated therewith.

It may be appreciated that the skid shoes 200a-h of each skid shoe assembly 200a-h may be each set at an extended position such that header remains level in a transverse direction across the transverse width of the cutter bar 22, and header 12 as a whole.

When the actual level of the terrain surface changes in a longitudinal direction as cutter bar 122 moves across a crop field during operation the set separation distance D1 does not change. Given the close longitudinal proximity of the one or more skid shoes on each skid shoe assembly 200a-h to the cutter bar 122, the corresponding separation distance D2 at that transverse location on header 12, will therefore also not change significantly under most longitudinal varying slope conditions encountered in a typical crop field.

As header 12 travels longitudinally across the terrain surface 74, each of the one or more skid shoes 202 associated with each individual skid shoe assembly 200a-h may follow the local terrain of terrain surface 74 adjacent to that particular skid shoe assembly. Skid shoe assemblies 200a-h may operate such that, regardless of any localized longitudinal variations in the level of the terrain surface 74 the distance D2 (FIG. 8C) between the cutter bar 122 and the terrain surface 74 is generally maintained at a substantially constant amount, such that the crop is cut at a substantially constant height and undesirable collisions of cutter bar 122 with terrain surface 74 may be reduced in frequency or degree, or substantially eliminated.

As noted above, each skid shoe assembly 200a-h (FIG. 2A) and its corresponding skid shoe 202, may be placed on header 12 in close longitudinal proximity to cutter bar 122. Therefore, when header 12 is in a flex mode of operation, the contact position of the skid shoe 202 on the terrain is in close longitudinal proximity to the cutter bar. By doing this, each skid shoe 202 will be following the terrain that is in close proximity to the terrain that is beneath the longitudinally adjacent section of cutter bar 122. Thus, even when encountering longitudinally changing slope conditions during operation as header 12 moves through a crop field, both the skid shoe and the longitudinally adjacent region of the cutter bar 122 will substantially follow the terrain level together. As depicted in the embodiment of FIG. 2A, skid shoe adjustment system 300 may include a series of transversely spaced skid shoe assemblies 200a-h, each secured to one of the cutter bar float paddles 120, 120′, including cutter bar drive paddle 120″. Skid shoe assemblies 200a-d may form part of the left side 302 of skid shoe adjustment system 300 and skid shoe assemblies 200e-h may form part of right side 304 of skid shoe adjustment system 300. Skid shoe assemblies 200a-h may be configured to move between and be operable to be set at any set position at or between a fully retracted position and a fully extended position. The set positions of skid shoe assemblies 200a-h may be infinitely adjustable at positions at and between the fully retracted position and the fully extended position. Thus, a specific amount of extension between the fully retracted position and the fully extended position can be selected-such as by the adjustment/operation of electrically operated control devices 464 (FIG. 11A) which controls the movement of hydraulic fluid in hydraulic fluid supply and control system 400 (as described hereinafter)—by the operator of skid shoe adjustment system 300.

Each of skid shoe assemblies 200a and 200h may have at least some components directly secured/attached to a respective one of the cutter bar float paddles 120′ at the respective right and left end regions of main frame 100. Each of skid shoe assemblies 200b-g may be directly secured to a respective one of the intermediate positioned intermediate cutter bar float paddles 120 or cutter bar drive paddle 120″. In the illustrated embodiment, each of the skid shoe assemblies 200a-200h has one or more components/parts directly secured to the cutter bar 122 and one more components/parts that are directly secured to a portion of a paddle 120, 120′, 120″. This permits the skid shoe assemblies 120a-h, including their terrain contact elements, such as the skid shoes 202, and their respective terrain contact areas, to be located longitudinally close/proximate to cutter bar 122 and its cutting devices. As will be explained hereinafter in greater detail, skid shoe assemblies 200a, 200c, 200f and 200h may be generally configured in a similar manner, while skid shoe assemblies 200b, 200d, 200e and 200g may be configured in the same manner but may be configured to have their height adjustment mechanisms act in an opposite direction in comparison to the height adjustment mechanisms of skid shoe assemblies 200a, 200c, 200f and 200h.

With reference to FIGS. 7A-C and 8A-C skid shoe assembly 200a (which may be constructed and operate substantially the same as skid shoe assembly 220h) is depicted which may include a skid shoe 202a which like the other skid shoes 202b-h, may be a generally rectangular plate shaped skid shoe—that may be longitudinally aligned with a longitudinal axis (x-axis in FIG. 1) of cutter bar float paddle 120′. Each skid shoe 202 such as skid shoe 202a may include a base plate 204 which may have a shallow upwardly curved end region towards rear end 205. Base plate 204 may be generally rectangular, but may also be any other suitable shape, such as square. In an embodiment, base plate 204 may be manufactured from a suitably strong and durable material such as 3/16 inches thick, A36 steel plate.

During operation at least in certain modes of operation of header 12, such as a flex mode of operation, skid shoe 202a may be in prolonged contact with terrain surface 74. In order to protect skid shoe 202a (and in particular base plate 204) from damage and/or excessive wear, secured/attached to the lower surface of base plate 204 may be a front cover plate 208 and attached to the rear end region 205 of base plate 204 may be a rear cover plate 210. Front and rear cover plates 208, 210 may be releasably attached/secured to base plate 204 by any suitable method, such as bolts. Rear cover plate 210 may have a rear portion 210a which may be curved to be received over the transversely extending rear edge of base plate 204. As front and rear cover plates 208, 210 are intended to be sacrificial pieces that may be replaced more frequently in comparison to other components of skid shoe assembly 200a, they may be secured such they are easily replaceable.

In various embodiments front and rear cover plates 208, 210 may be formed as a single unitary piece or from multiple pieces of the same or different materials.

Front and rear cover plates 208, 210 may provide one or more contact surface areas for skid shoe 202a with the terrain surface 74 to protect skid shoe 202a from damage and/or excessive wear. Front and rear cover plates 208, 210 may be made from a suitably strong and wear resistant material. The material may also be selected: so as to not have a tendency for crop material to adhere to it; to have impact absorbing properties; and not have a tendency to create sparks upon impact with rocks or other debris during operation in a crop field. Avoiding the build-up of crop material on the lower surfaces front and rear cover plates 208, 210 is desired to avoid crop material creating additional height between the cutter bar 122 and the other cutting components, and the level of the terrain surface 74.

Front and rear cover plates 208, 210 may be formed from a suitable plastic, metal, rubber, ceramic or ceramic composite material. In an embodiment, front and/or rear cover plates 208, 210 are formed from ultra-high-molecular-weight polyethylene (UHMW). In other embodiments, front and/or rear cover plates 208, 210 may be formed from hard steel wear plate.

The front-end region 207 of base plate 204 of skid shoe 202a may be pivotally connected beneath the lower front end of cutter bar float paddle. The front end 207 of base plate 204 of skid shoe 202a may be pivotally connected to a rearwardly extending plate portion 122′ of cutter bar 122 by any suitable mechanism, for example a hinge 206a, such that skid shoe 202a may pivot relative to and about cutter bar 122 about a generally transversely orientated pivot axis Xa (see FIG. 7A).

The upper surface of base plate 204 may be attached to a series of spaced apart longitudinally extending upstanding plate support members 212, 214 and 216 which may be made from any suitable material such as 3/16 inches thick A36 steel plate and which may be oriented generally perpendicular to base plate 204. For example, the bottom edges of the spaced apart longitudinally extending plate support members 212, 214 and 216 may be welded to the generally upwards facing surfaces of base plate 204. Central support member 214 may be generally straight (and aligned with the longitudinal axis of header 12) whilst outer plate support members 212 and 216 may diverge from the straight-forward longitudinal direction, towards the outer sides of base plate 204. Plate support members 212, 214, 216 may provide additional strength to plate base 204 and skid shoe 202a, and the inward ends thereof, may also provide a mounting point for a skid shoe pivot linkage 218a.

Skid shoe pivot linkage 218a may include a bell crank device 222a, and interconnected crank arm 230a, and a pair of pivotally interconnected lower arms 224 (FIG. 8A). Skid shoe pivot linkage 218a may be operated such that skid shoe assembly 200a is moveable from the first (fully retracted) position (as shown in FIGS. 7A-C) to the second (fully extended) position (as shown in FIGS. 8A-C) and from the second (fully extended position to the first (fully retracted) position, and may set at a set position at any position therebetween.

The movement and the positioning of skid shoe linage 218a may be actuated and established by any suitable actuator, such as a hydraulic cylinder 226a having a movable piston rod 440a. Hydraulic cylinder 226a may be a double (two-way) acting hydraulic cylinder with an actuating piston arm controlled by a hydraulic fluid supply system and may be moveable and be set at a set position between the first (fully extended) position as shown in FIGS. 7A-C and the second (fully retracted) position as shown in FIGS. 8A-C. By way of example only, each of the hydraulic cylinders may be 4-inch stroke two-way acting hydraulic cylinder with a 1.5 inch interior cylinder diameter and a 0.875 inch diameter piston rod, with a maximum load capacity of 3000 pounds, such as is commercially available.

With reference to FIG. 8A, the rear end (e.g., hydraulic cylinder portion end) of hydraulic cylinder 226a may be pivotally connected with a pivot mount lug 239a at pivot connection 229 (FIG. 8A) to side walls 109′ of cutter bar float paddle 120′ through a mounting bracket 228. The front end (e.g., hydraulic cylinder piston rod end) of piston rod 404a may be pivotally connected to the rearwardly projecting medial portion 227a of bell crank 222a through connected crank arm 230a and pivotal connection 232. The front end of hydraulic cylinder 226a (hydraulic cylinder piston rod end) may have the forward end of its piston rod 404a fixedly attached (such as with bolting) to a rearward end of crank arm 230a. Thus, crank arm 230a may function as a shaped extension of piston rod 404a. Crank arm 230a may have its forward end pivotally connected to the downwardly/rearwardly projecting portion 227a of bell crank 222a through crank arm 230a—at pivotal connection 232a—which are in turn pivotally is interconnected to paddle 120′ at pivot pin 234 (FIG. 8A, 8B).

Crank arm 230a may generally extend longitudinally and have a generally shallow arcuate profile with a hooked rearward end portion 231 (FIG. 8A) which may also engage the rear edge of rear cover plate 210 when skid shoe assembly 200a is in the first fully retracted position (FIG. 7A, 7B).

In some embodiments/applications/environments an alternate type of actuator such as for example a pneumatic cylinder or an electrically driven servo drive motor might possibly be employed to actuate the skid shoe height adjustment mechanism. The upper end portion 223a of bell crank 222a may be pivotally connected to side walls 109′ of cutter bar float paddle 120′ through pivot pin 234, which may be housed in a tubular housing 236 fixedly located between vertical side walls 109′ of cutter bar float paddle 120′. Pivot pin 234 provides an upper fixed pivot point for bell crank 222a for pivoting movement about transverse axis X2 (FIG. 8A). The lower end portion 225a of bell crank 222a is also pivotally connected to the upper ends of both lower arms 224 through pivotal connection 235a that permits relative pivoting motion of bell crank 222a relative to lower arms 224 about transverse axis X3. Lower arms 224 may diverge from one another from the lower end 225a of bell crank 222a in a downwards direction and each respectively pivotally connect to the end region of one of respective outer plate support members 212 and 216 through transversely extending pivot pin 238. Thus, lower arms 224 may also pivot about a transverse axis X4 relative to outer plate support members 212, 216 as well as central plate support member 214.

Pivot pin 238 extends in a transverse direction along axis X4 through axially aligned holes in lower arms 224 and plate support members 212, 214 and 216. Movement of pivot pin 238 may be secured by a retainer 240 at each end, such as a circlip or a split pin.

As depicted in FIGS. 7A-C, hydraulic cylinder 226a is shown in the fully extended position, which corresponds to skid shoe assembly 200a in the fully retracted position. With reference to FIG. 7C, when header 12 is positioned proximate to terrain surface 74 and skid shoe assembly 200a is in the fully retracted position, the lower surface of cutter bar skid plate 1123 and possibly also the lower surface of forward region of plate 208 may provide the first point(s)/areas of contact terrain surface 74 such that the upward acting forces of the terrain surface may be borne by the cutter bar skid plate 1123 and possibly also a forward region of cover plate 208. As will be explained in more detail below, in this position, during operation of header 12, cutter bar 122 may closely follow and be vertically positioned proximate to/on the level of terrain surface 74.

As shown in FIG. 8C, when cutter bar 122 is positioned proximate to/on terrain surface 74 and skid shoe assembly 200a is in the second (fully extended) position, a lower surface area of the rear cover plate 210 may provide the location of contact support with terrain surface 74.

The operation of skid shoe assembly 200a from the fully retracted position to the fully extended position will now be described.

As hydraulic cylinder 226a is retracted from the position shown in FIG. 7A, bell crank 222a (through crank arm 230a) rotates in a counter-clockwise direction (as viewed in FIG. 7A), pivoting about pivot pin 234. This will cause rotation of upper arms 224 in a clockwise direction (as viewed in FIG. 7A), which in turn pushes the rear end 205 of base plate 204 in a generally downwards direction as base plate 204 pivots about axis Xa as indicated by arrow 256 in FIG. 7A. Thus, skid shoe assembly 200a can move to the second (fully extended) position as hydraulic cylinder 226a moves to the fully retracted position shown in FIGS. 8A-C.

The operation of skid shoe assembly 200a from the fully extended position to the fully retracted position may be the reverse of the steps described above as hydraulic cylinder 226a moves from the fully extended position to the fully retracted position, which in turn pushes the rear end 205 of base plate 204 in a generally upwards direction as base plate 204 pivots about axis Xa as indicated by arrow 258 in FIG. 8A.

In an embodiment, skid shoe 202a may be pivotable about axis Xa through a range of pivot adjustment angles e (FIG. 8C) extending between a retracted pivot angle e (Ret) and a fully extended pivot angle e (Ext) in the range of a retracted pivot angle e (Ret) of about 6 degrees to a fully extended pivot angle e (Ext) of about thirty-four degrees, and which may be in the larger angular range of a retracted pivot angle e (Ret) of 3 degrees to a fully extended pivot angle e (Ext) about 40 degrees. The maximum permissible pivot adjustment angle e is determined by the stroke length of hydraulic cylinder 226a and the respective physical distances and arrangements of the relevant parts inter-connected thereto. As shown in FIG. 8C, the maximum height adjustment difference between the vertical distance D1 (Ext) when skid shoe assembly 200a is in the fully extended position, and the vertical distance D1 (Ret) when the skid shoe assembly in the fully retracted position can translate into a maximum height difference D2 (Ext) minus D2 (Ret) beneath cutter bar 122 which may be in the range of about zero (0) inches to nine (9) inches and preferably in the range of zero (0) inches to fourteen (14) inches.

Relative example dimensions for a paddle 120 and skid shoe assembly 200a are shown in FIG. 8D.

As referenced above, in an alternate embodiment such as depicted in FIG. 8E, the skid shoe assembly 200a may have a wheel unit 510 having one of more wheels freely rotatable about a generally transverse oriented wheels axle that is mounted at a rearward end region of skid shoe 202a, and can be configured such that the lower surface of the wheels will provide the contact regions with the terrain surface when the skid shoe assembly is in an extended position. A skid shoe assembly may employ one or more freely rotatable wheels as referenced above (either in combination with skid plates or in substitution of skid plates), and this may provide an additional one (1) inches to three (3) inches in additional height such that for example the maximum height adjustment difference between the vertical distance D1 (Ext) when skid shoe assembly 200a is in the second (fully extended) position, and the vertical distance D1 (Ret) when the skid shoe assembly in the first (fully retracted) position (which again can translate into a maximum height adjustment difference beneath cutter bar 122) may be in the range of zero (0) inches to twelve (12) inches.

Assuming terrain surface 74 in FIG. 8C is flat and level, an adjustment in the amount of height D1 beneath the skid shoe 200a by operation of the skid shoe height adjustment mechanism, will result in substantially close to or the same amount of height adjustment D2 beneath the cutter bar 122 in that transverse location of skid shoe 200a. It will be appreciated that since paddle 120′ is pivoting about the rearward transverse pivot axis X1 there will be difference as a result of the differing radial distances of D1 and D2 from the pivot axis X1. However, if the paddle 120′ is relatively long in length (e.g. about 6 feet long) and if D1 and D2 are measured radially close together (e.g. 8-12 inches), the difference associated with differing radial distances will typically be small.

Skid shoe assembly 200h (FIG. 12A) may be configured and operate in substantially the same manner as skid shoe assembly 200a including being directly connected/mounted to an end region cutter bar float paddle 120′. Also like skid shoe assembly 200a, skid shoe assembly 200h may be movable and positioned in a set position between a fully retracted position and a fully extended position by operation of a hydraulic cylinder 226h (which may be substantially the same as hydraulic cylinder 226a) and be able to achieve a corresponding maximum height adjustment difference between the vertical distance D1 (Ext) when skid shoe assembly 200h is in the fully extended position, and the vertical distance D1 (Ret) when the skid shoe assembly 200h is in the fully retracted position. This provides a corresponding same maximum height adjustment distance D2 (Ext) minus D2 (Ret) of the cutter bar 122 in the vicinity of skid shoe assembly 200h. Again, assuming terrain surface 74 is flat and level, this also provides that any adjustment in the vertical height D1 will result in in substantially close to or the same amount of height adjustment in the cutter bar vertical separation distance/height D2 beneath the cutter bar 122 in the vicinity of skid shoe of skid shoe assembly 200h. Similarly, it will be appreciated that since paddle 120′ is pivoting about the rearward transverse pivot axis X1 there will be difference as a result of the differing radial distances of D1 and D2 from the pivot axis X1. However, if the paddle 120′ is relatively long in length (e.g. about 6 feet long) and if D1 and D2 are measured radially close together (e.g. 8-12 inches), the difference associated with differing radial distances will typically be small.

Skid shoe assemblies 200a and 200h may have skid shoes 202a and 202h that are pivotable about the same range of pivot angles e as described above in order to achieve the same separation distances D1 and D2.

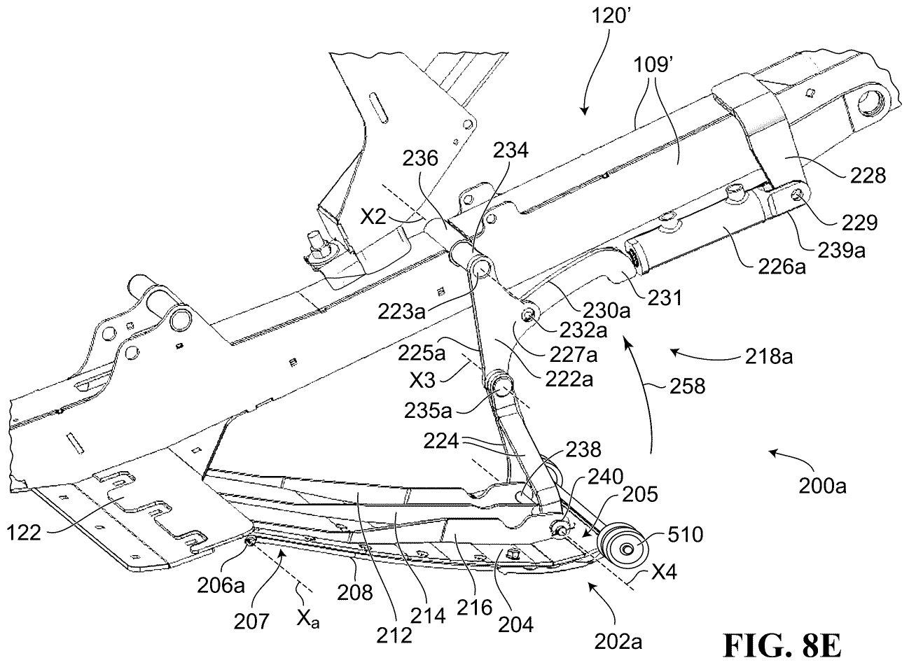

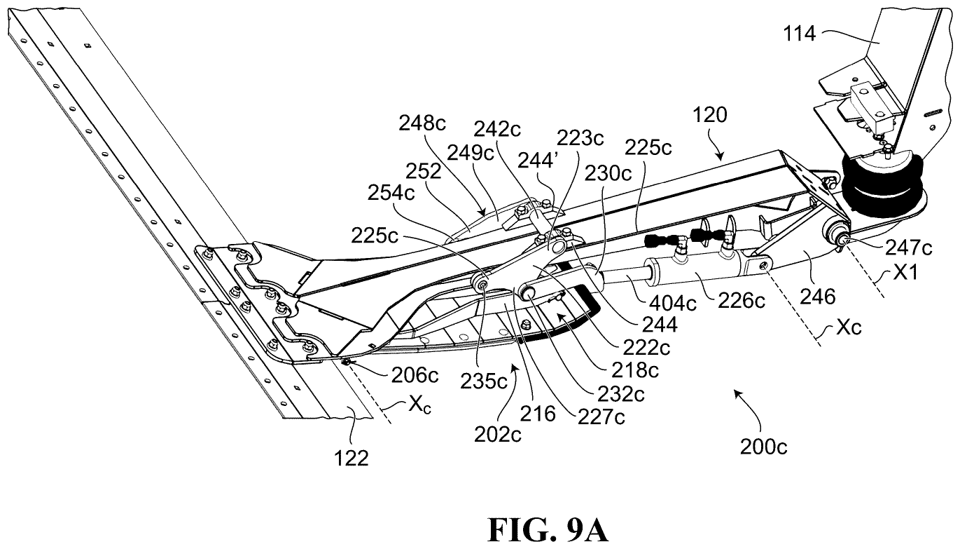

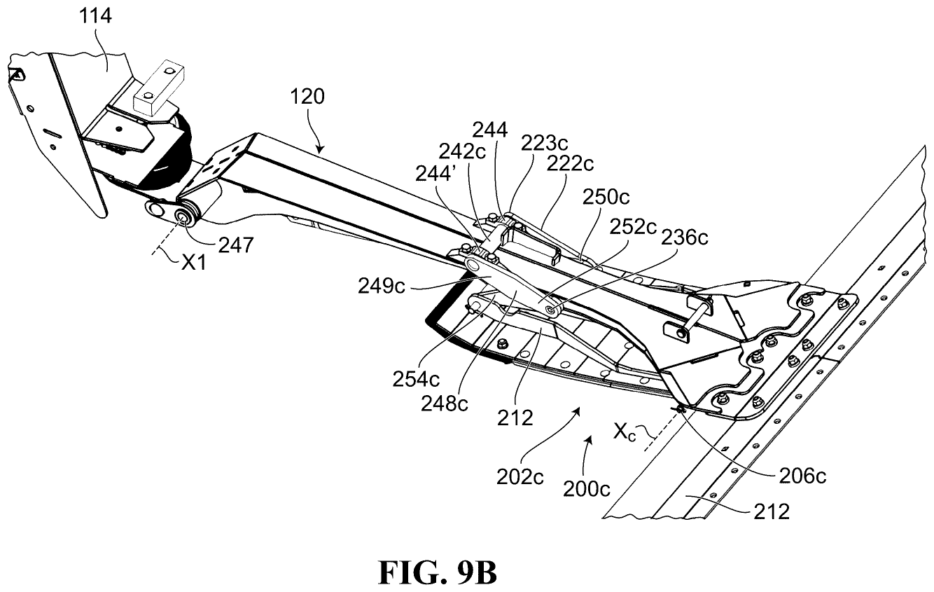

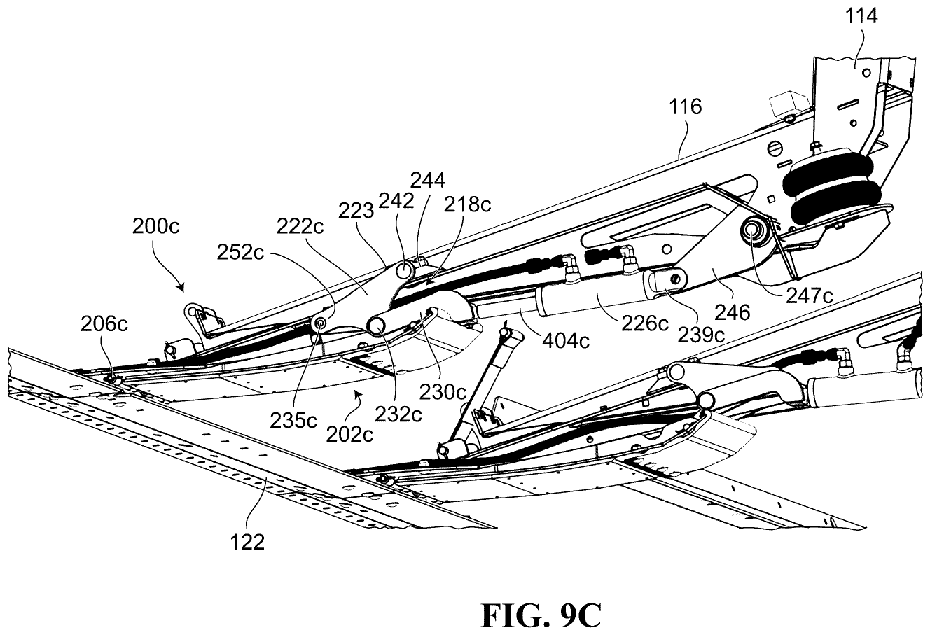

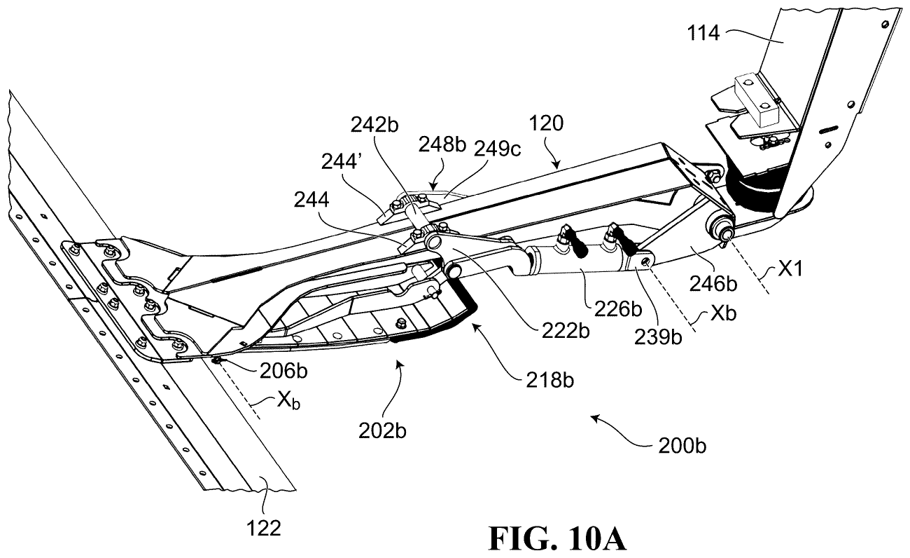

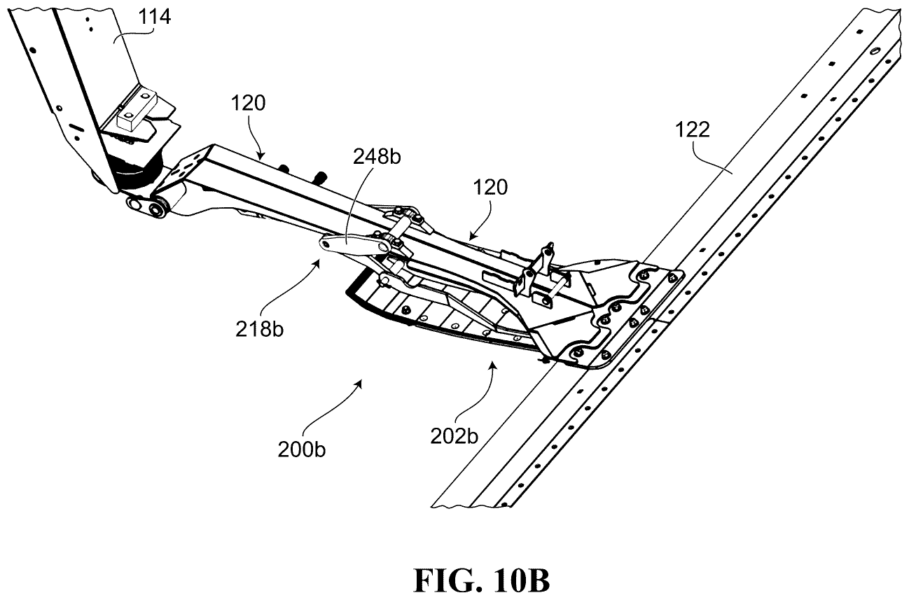

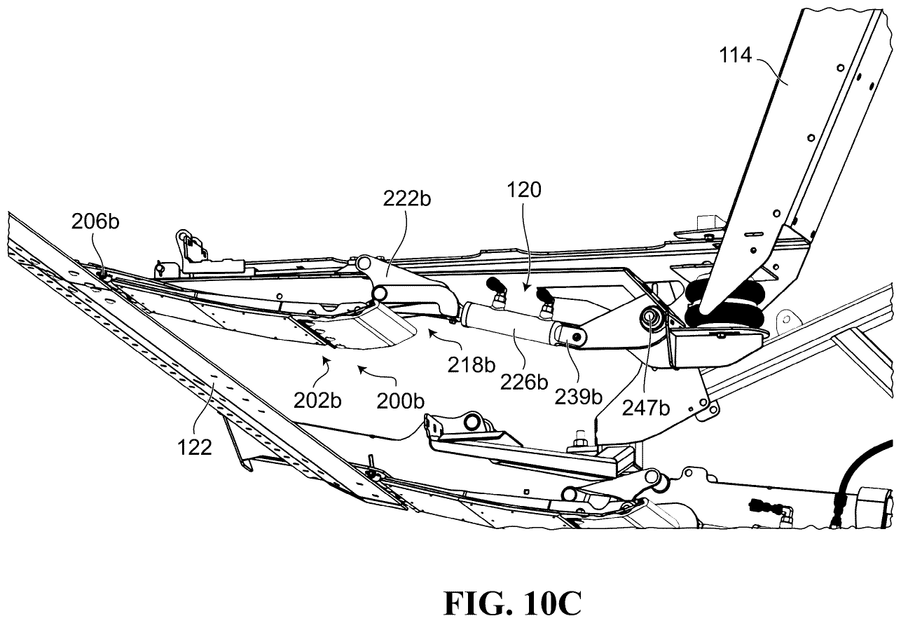

With reference now to FIGS. 9A to 9C and 10D, a skid shoe assembly 200c as installed on an intermediate cutter bar float paddle 120 is shown. Skid shoe assembly 200c may be configured in a substantially similar manner skid shoe assembly 200a and may operate substantially the same as skid shoe assembly 200a, as described above. Each skid shoe assembly 200c may include a skid shoe 202c (which may be like skid shoe 202a) that is pivotally directly attached-beneath the lower front end of a cutter bar float paddle 120—to a rearwardly extending portion of cutter bar 122 with a hinge 206c (FIGS. 9A, 9B, 9C, 10D) such that skid shoe 202c may pivot about a generally transversely orientated pivot axis Xc (FIG. 9A, 9B).

Skid shoe assembly 200c may also include a skid shoe linkage 218c—which may be substantially the same as skid shoe linkage 218a. Skid shoe pivot linkage 218c may include a bell crank device 222c, an interconnected crank arm 230c, and an interconnected lower arm 250c (FIGS. 8A and 10D). Skid shoe linkage 218c may be positioned generally on one transverse side of paddle 120. On the opposite transverse side of paddle 120 may be another linkage 248a which may include a linkage arm 249c interconnected at a one end to pivot pin 242c and at an opposite end to an interconnected lower arm 254c. Linkage 248a may be operationally interconnected to skid shoe linkage 218c. Skid shoe linkage 218c may include a bell crank 222c, the upper end 223c of which is pivotally connected to cutter bar float paddle 120 through pivot pin 242c. Pivot pin 242c may be retained for pivotal movement by a pair of brackets 244, 244′ secured to the upper surface of cutter bar float paddle 120. The opposite end of pivot pin 242c may extend through bracket 244′ and be received in an upper opening of a linkage arm 249c which is on the opposite transverse side of paddle 120 to bell crank 222c (FIG. 9A, 9B). Thus, linkage arm 249c and bell crank 222c may be fixedly connected to pivot pin 242c and may pivot together about the longitudinal axis (in a transverse direction Y) of pivot pin 242c.

The lower end 225c of bell crank 222c is also pivotally connected to the upper end of lower arm 250c [not completely visible] through pivotal connection 235c (which is like connection 235 in FIG. 8B). Lower arm 250c is in turn pivotally connected to shoe plate support member 216 (FIGS. 9A and 10D). Similarly, the lower end 252c of linkage arm 249c is also pivotally connected to the upper end of a lower arm 254c through pivotal connection 236c. Lower arm 254c is in turn pivotally connected to a shoe plate support member 212 (FIG. 9B).

Skid shoe linkage 218c including bell crank 222c and linkage 248 including interconnected linkage arm 249c may be actuated by hydraulic cylinder 226c and be moveable between a first (fully extended) position as shown in FIGS. 9A-C and a second (fully retracted) position as shown in FIG. 10D, and moveable between the second (fully retracted) position and the first (fully extended) position.

The rear end (hydraulic cylinder portion end) of hydraulic cylinder 226c may be pivotally connected to a mounting bracket 246 with a cylinder connecting lug 239c, which in turn at its rear portion may be fixedly mounted to paddle 120 such that hydraulic cylinder 226c can pivot at its rear end relative to mounting bracket 246 about the transverse axis Xd of its cylinder connecting lug 239c. Bracket 246 itself has a rear end region that occupies space required by the paddle pivot point 247c of paddle 120 that allows paddle 120 to pivot relative to horizontal strut 116 and vertical strut 114. However, bracket 246 only wraps around this pivot point 247c while being fixed/welded to the paddle 120 so that bracket 246 pivots with paddle 120 about the paddle pivot axis X1. Bracket 246 does not pivot about pivot point 247c independently of the paddle 120. The bracket 246 therefore pivots with paddle 120 but does not limit the twisting of paddle 120. The pivot point of paddle 120 is effectively the neutral axis of paddle flexibility or compliance.

The front end of hydraulic cylinder 226c (hydraulic cylinder piston rod end) may have the forward end of its piston rod 404c fixedly attached (such as by bolting) to a rearward end of crank arm 230c. Thus, crank arm 230c may function as a shaped extension of piston rod 404c. Crank arm 230c may have its forward end pivotally connected to the downwardly/rearwardly projecting portion 225c of bell crank 222 at pivotal connection 232c-which are in turn pivotally is interconnected to paddle 120 at pivot pin 242c (FIG. 9A, 9C). Piston rod 404c (and all piston rods 404a-h) is configured to rotate about a longitudinal axis of piston rod 404c whilst the forward end is still fixedly attached to rearward end of crank arm 230c. This will prevent any binding forces as other elements of skid shoe assembly 200c or paddle 120 deform or flex during operation.

In operation, similar to skid shoe assembly 200a, skid shoe assembly 200c is moveable from a fully retracted position to a fully extended position as hydraulic cylinder 226c is retracted from the fully extended position to the fully retracted position. Skid shoe assembly 200c may be configured and operate in substantially the same manner as skid shoe assembly 200h and like skid shoe assembly 200h may be movable and positioned in a set position at any point between the fully retracted position and the fully extended position by operation of a hydraulic cylinder 226c.

As hydraulic cylinder 226c is retracted from the fully extended position shown in FIG. 9A, 9B, 9C, bell crank 222c (and interconnected linkage arm 249c) rotate together in a counter-clockwise direction (as viewed in FIG. 9A), pivoting about pivot pin 242c. This will cause rotation of lower arms 250c, 254c in a clockwise direction (as viewed in FIG. 10D) which in turn pushes the rear end skid shoe 202c in a downwards direction. Thus, skid shoe assembly 200c can then move to the fully extended position.

Skid shoe assembly 200c (FIG. 12A) which is installed on an intermediate paddle 120 and cutter bar 122, may also be configured and operate in substantially the same manner as skid shoe assembly 200a including being mounted/directly connected to an end region cutter bar float paddle 120 and to cutter bar 122. Also like skid shoe assembly 200a, skid shoe assembly 200c may be movable and positioned in a set position between a fully retracted position and a fully extended position by operation of a hydraulic cylinder 226c (which may be substantially the same as hydraulic cylinder 226a) and may be able to achieve the same maximum height adjustment difference associated with the skid shoe 202c between the vertical distance D1 (Ext) when skid shoe assembly 200c is in the fully extended position, and the vertical distance D1 (Ret) when the skid shoe assembly 200c is in the fully retracted position. This provides a corresponding same maximum height adjustment distance D2 (Ext) minus D2 (Ret) of the cutter bar 122 in the vicinity of skid shoe assembly 200c. Again, assuming terrain surface 74 is flat and level, this also provides that any adjustment in the vertical height D1 will result in a similar amount of height adjustment in the cutter bar vertical separation distance/height D2 beneath the cutter bar 122 in the vicinity of skid shoe of skid shoe assembly 200c.

Skid shoe assembly 200f may be configured and operate in substantially the same manner as skid shoe assembly 200c and also be movable between a fully retracted position and a fully extended position by operation of a hydraulic cylinder 226f which may be substantially the same as hydraulic cylinder 226c. Skid shoe assembly 200f may similarly be movable and positioned in any set position between the fully retracted position and the fully extended position by operation of a hydraulic cylinder 226f.

Skid shoe assemblies 200c and 200f may have skid shoes 202c and 202f respectively that are pivotable about a similar range of pivot angles e to those pivot angles described above in relation to skid shoe assemblies 200a and 200h in order to achieve the same separation distances D1 and D2.

It will be appreciated, that like skid shoe assembly 200a, skid shoe assemblies 200c and 200f can be moved to a set position at any position between the fully retracted positions and the fully extended positions, as may be determined by an operator.

With reference now to FIGS. 10A to 10F, skid shoe assembly 200b (which is configured in substantially the same manner as skid shoe assemblies 200d, 200e and 200g) as installed on a cutter bar float paddle 120 is shown. Skid shoe assembly 200b may include a skid shoe 202b (which may be substantially the same as skid shoe 202a) that is pivotally connected beneath the lower front end of paddle 120 to a portion of cutter bar 122 by hinge 206b such that skid shoe 202b may pivot about a generally transversely orientated pivot axis 211b (FIG. 10A) from the first (fully retracted) position to the second (fully extended) position.

Skid shoe assembly 200b may include a skid shoe linkage 218b and interconnected linkage 248b which are actuated by hydraulic cylinder 226b. Skid shoe linkage 218b may be substantially similar to skid shoe linkage 218c and include a bell crank 222b and lower arms 250b, 254b. Linkage 248b may include a linkage arm 249b. A pivot pin 242b may interconnect linkage 248b and skid shoe linkage 218b. Bell crank 222b, linkage arm 249b and lower arms 250b, 254b, which may generally be the same as and function like bell crank 222c, pivot pin 242c, linkage arm 249c and lower arms 250c, 254c described above.

However, as shown clearly in FIG. 10D, in comparison to skid shoe linkage 218c, in skid shoe linkage 218b the orientation of bell crank 222b and linkage arm 249b are flipped/reversed rotationally with respect to the orientation of bell crank 222c and linkage 249c shown in FIG. 9A, and there is a corresponding angular difference in the orientation of movement by 180 degrees of the piston rod 404b of hydraulic cylinder 226b compared to the movement of the piston rod 404c of hydraulic cylinder 225c. As a result of the orientation of skid shoe linkage 218b, and orientation of movement of piston rod 404b, when skid shoe assembly 200b is in the fully retracted position (as shown in FIG. 10A), hydraulic cylinder 226b is in the fully retracted position; and when skid shoe assembly 200b is in the fully extended position, hydraulic cylinder 226b is in the fully extended position (FIGS. 10D, 10E and 10F). By providing that hydraulic cylinders 226a-h are arranged so that they alternately work in opposite directions (ie. cylinders 226a, 226c, 226f and 226h retract to extend respective skid shoes 202a, 202c, 202f and 202h—whereas cylinders 226b, 226d, 226e and 226g extend to extend respective skid shoes 202b, 202d, 202e and 202g) this permits hydraulic cylinder fluid volumes to be matched. This configuration may also allow a common hydraulic cylinder to be used for cylinders 226a-h.

In operation, skid shoe assembly 200b is moveable from the fully retracted position (FIGS. 10A-10C) to the fully extended position (FIGS. 10D-10F) as hydraulic cylinder 226b is extended from its fully retracted position to the fully extended position. Skid shoe assembly 200b may be movable and positioned in a set position between a fully retracted position and a fully extended position by operation of a hydraulic cylinder 226b.

Skid shoe assemblies 200d, 200e, 200g may be configured and operate in substantially the same manner to skid shoe assembly 200b and be movable between a fully retracted position and a fully extended position by operation of respective hydraulic cylinders 226d, 226e, 226g which may be substantially the same as hydraulic cylinder 226b.

It will be appreciated, that like skid shoe assembly 200b, skid shoe assemblies 200d, 200e and 200g can also be moved to a set position at any position between the fully retracted positions and the fully extended positions, as may be determined by an operator.

Skid shoes 202a-h of skid shoe assemblies 200a-h may be pivotable about hinges located a common position vertical and longitudinal position on cutter bar 122 and thus may be pivotable about the same range of pivot angles e as described above in relation to skid shoe assembly 200a in order to achieve the same vertical separation distances D1 and D2.

Referring back to FIG. 2A and also with reference to FIGS. 11A and 11B, skid shoe assemblies 200a-h may be arranged on main frame 100 in an alternating-acting functional arrangement with respect to the operation of their respective skid shoe linkages 218a-h. The effect of this is that skid shoe assemblies 200a, 220c, 200f and 200h are in their fully retracted position when their respective hydraulic cylinders 226a, 226c, 226f and 226h are in their fully extended positions and skid shoe assemblies 200b, 200d, 200e and 200g are in their fully retracted positions when their respective hydraulic cylinders 226b, 226d, 226g and 226g are in their fully retracted positions.

Conversely, skid shoe assemblies 200a, 220c, 200f and 200h are in their fully extended positions when their respective hydraulic cylinders 226a, 226c, 226f and 226h are in their fully retracted positions and skid shoe assemblies 200b, 200d, 200e and 200g are in their second fully extended positions when their respective hydraulic cylinders 226b, 226d, 226e and 226g are in their fully extended positions (e.g. FIGS. 10D, 10E and 10F).

In other embodiments, the skid shoe assemblies 200a-h of skid shoe adjustment system 300 could be arranged in another suitable arrangement. For example, all of the skid shoe assemblies of skid shoe adjustment system 300 may be identically set up such that they are in their fully retracted position when their respective hydraulic cylinders are in their fully extended positions and in their fully extended position when their respective hydraulic cylinders are in their fully retracted positions—or vice versa.

An operator in propulsion unit 14 may be able to operate one or more electric control devices 464 (FIG. 11A) of a hydraulic fluid supply and control system 400 to effect desired changes related to the positions of skid shoes 202a-h or respective skid shoe assemblies 200a-h.

Hydraulic fluid supply and control system 400 may be fluidly interconnected to a bidirectional hydraulic fluid circuit that is utilized by propulsion unit 14 and header 12 for other functionalities. For example, hydraulic fluid supply and control system 400 may utilize pressurized hydraulic fluid that may be selectively diverted from a hydraulic fluid circuit that operates the forward and aft movement of reel sections 132a, 132b (FIG. 1A). That hydraulic fluid circuit may include common components including a hydraulic fluid pump. Hydraulic fluid supply and control system 400 may be actuated by the same operator controls associated with the movement of reel sections forward and aft. In other embodiments, hydraulic fluid supply and control system 400 may be self-contained hydraulic fluid system with its own associated components including a hydraulic fluid pump.

With reference to FIGS. 11A, 11B and 11C, an embodiment of part of a hydraulic fluid supply and control system 400 for skid shoe adjustment system 300 is shown. Hydraulic fluid supply and control system 400 may include operator activated electric control devices 464, and hydraulic cylinders 226a-h having associated extendible piston rods 404a-h (FIG. 11A) associated with respective skid shoe assemblies 200a-h. As described above, by operation electric control devices 464 by an operator (who may be located on propulsion unit 14), hydraulic cylinders 226a-h are configured and operable to extend and retract the respective skid shoe assemblies between the first (fully retracted) and the second (fully extended) positions. The operator may select a switch position for the electronic control devices 464 for control of hydraulic fluid valves in hydraulic fluid supply and control system 400. Hydraulic fluid supply and control system 400 for operation of the hydraulic cylinders 226a-h may be part of the overall hydraulic fluid supply and control system for the entirety of header 12 and propulsion unit 14, and may utilize/divert hydraulic fluid that is part of hydraulic fluid circuits that control the FORE and AFT movement of the reel sections 132a, 132b (FIG. 1A). The reel FORE/AFT hydraulic fluid is diverted by diverter valves 444, 450 as described further below, which are actuated at the same time. When diverter valves 444, 450 are actuated, the hydraulic fluid-when flowing in the reel FORE/AFT circuits-will be diverted to operate the hydraulic cylinders 226a-h as described below in order to move the skid shoes 202a-h upwards and downwards, in order to adjust the vertical separation distances D1 and D2 as referenced above. Valves 444 and 450 are only functioning as diverter valves. The hydraulic fluid flowing to these diverter valves 444, 450 is normally flowing to the FORE and AFT reel positioning hydraulic fluid circuits (FIG. 11A). When the valves 444, 450 are activated [always being activated both together], the fluid flow is diverted away from the FORE/AFT reel control circuits and instead is available for use by the hydraulic cylinders 226a-h of skid shoes assemblies 200a-h (FIGS. 11B, 11C). The actual control of the delivery of the supply flow of hydraulic fluid is achieved in the cab of propulsion unit, by and operator in real time activating the same controls in the cab of propulsion unit 14 for movement of the reel sections FORE and AFT. These propulsion unit controls, supply the hydraulic fluid in the direction desired by the operator to raise or lower the skid shoes. Both diverter valves 444 and 450 are only “opening the door” to this flow of hydraulic fluid. Nothing moves if only one door is open/valve is activated.

An operator may during operation of propulsion unit 14 and header 12, be able to adjust the set position “on the fly” while the propulsion unit 14 and header 12 are moving forward through a crop field so that the vertical separation distance D2 of cutter bar 122 above the terrain surface can be changed to suit the terrain and crop conditions as they are encountered. Thus, header height control system 10 may be operating contemporaneously while skid shoe system 300 is being activated by hydraulic fluid supply and control system 400. In such a situation the operator may be able to rely upon the header height control system 10 providing the main lifting and lowering of the header main frame 100 relative to the terrain surface. But the operator may for example wish to make such an adjustment to height of the skid shoe extensions when the operator sees an area in the crop field that has fallen down crop and he will be able to cut that crop by only making the necessary adjustment to reduce the vertical separation distance D2. This can be done by utilizing skid shoe adjustment system 300 by activating the hydraulic fluid supply and control system 400, while the agricultural implement (e.g. header 12) and propulsion unit 14 are moving through a crop field cutting crop.

A representative hydraulic cylinder 226 is shown in FIGS. 11D to 11F, which may be similar to any or all of the hydraulic cylinders 226a-h associated with a respective skid shoe assemblies 200a-h. Hydraulic cylinders 226 may each include a hydraulic fluid chamber 406 having a reciprocally moveable piston 408 therewithin connected to piston rod 404.

Piston 408 may have upper and lower faces 410, 412 and divides hydraulic chamber 406 into cap end chamber 414 having cap end hydraulic fluid port 416 and rod end chamber 418 having rod end hydraulic port 420. As shown in FIG. 11D, hydraulic piston 408 is at the approximate mid-point of hydraulic fluid chamber 406 such that cap end chamber 414 and rod end chamber 418 are about the same size/volume.

In order to move hydraulic cylinder 226 to the first (fully extended) position shown in FIG. 11E, pressurized hydraulic fluid is supplied cap end chamber 414 through cap end hydraulic port 416 which will act upon upper face 410 of piston 408. At the same time, hydraulic fluid is permitted to flow back from rod end chamber 418 through rod end port 420.

In order to move hydraulic cylinder 226 to the second (fully retracted) position shown in FIG. 11F, pressurized hydraulic fluid is supplied rod end chamber 418 through rod end hydraulic port 420 which will act upon lower face 412 of piston 408. At the same time, fluid is permitted to flow back from cap end chamber 414 through cap end port 418.

In some embodiments hydraulic cylinder 226 may include a bleed port (not shown in FIGS.). The bleed port may function to allow any air in the hydraulic fluid to escape when a hydraulic cylinder 226 is in the fully extended or fully retracted position. By removing air from the hydraulic system, all of the hydraulic cylinders 226a-h may better stay in properly phased movement and positioning with each other. If air is present in any one or more the hydraulic cylinders and/or hoses of any fluid circuit this can negatively impact the operation of skid shoe adjustment system 300. A quantity of air, unlike hydraulic fluid, is prone to having its volume reduced when pressurized. Accordingly, air trapped in the system may mean that the skid shoes 202a-h will not deploy properly and together in phased movement with each other. In order to reduce or eliminate the prospect that air is trapped in the hydraulic fluid supply and control system 400 bleeding may be performed on the hydraulic cylinders 226a-h to purge air from the system by pushing air out of the fluid circuits though bleed ports. This should ensure that all hydraulic cylinders 226a-h and their operationally connected skid shoe assemblies 200a-h will move equally together, reliably and solidly, thorough their entire range of movement.

Hydraulic fluid supply and control system 400 may be configured to supply and receive hydraulic fluid to left side 302 and right side 304 of skid shoe adjustment system 300 to control the extension/retraction of hydraulic cylinders 226a-h and therefore the extension/retraction of each of skid shoe assemblies 200a-h in synchronized movement and positioning.

As shown in FIG. 11A, hydraulic cylinders 226a-d of left side 302 of skid shoe adjustment system 300 are connected in series and may be interconnected as follows: the cap end port 416a of hydraulic cylinder 226a is in communication hydraulic fluid line 422, the rod end port 420a of hydraulic cylinder 226a may be hydraulically connected to the rod port end 420b of hydraulic cylinder 226b by hydraulic fluid line 424, the cap end port 416b of hydraulic cylinder 226b may be connected to the cap end port 416c of hydraulic cylinder 226c by hydraulic fluid line 426, the rod end port 420c of hydraulic cylinder 226c may be hydraulically connected to the rod port end 420d of hydraulic cylinder 226d by hydraulic fluid line 428 and the cap end port 416d of hydraulic cylinder 226d may be connected a hydraulic fluid line 430.

Similarly, hydraulic cylinders 226e-h in left side 304 of skid shoe adjustment system 300 are connected in series and may be interconnected as follows: the cap end port 416h of hydraulic cylinder 226h is in communication hydraulic fluid line 432, the rod end port 420h of hydraulic cylinder 226h may be hydraulically connected to the rod port end 420g of hydraulic cylinder 226g by hydraulic fluid line 434, the cap end port 416g of hydraulic cylinder 226g may be connected to the cap end port 416f of hydraulic cylinder 226f by hydraulic fluid line 436, the rod end port 420f of hydraulic cylinder 226f may be hydraulically connected to the rod port end 420e of hydraulic cylinder 226e by hydraulic fluid line 438 and the cap end port 416e of hydraulic cylinder 226e may be connected a hydraulic fluid line 430.

Hydraulic fluid lines 422 and 432 are connected to a hydraulic fluid line 440, through a 50/50 flow divider 441 which is in turn selectively connected to a pressurized hydraulic fluid supply line 442 through a directional diverter control valve 444 (shown schematically in FIG. 11A) by hydraulic fluid lines 458, 440. Hydraulic fluid line 430 is connected to a hydraulic fluid lines 446 462, which are in turn selectively connected to a pressurized hydraulic fluid supply line 448 through a directional diverter control valve 450 (shown schematically in FIG. 11A).

As referenced above, diverter valves 444, 450 which may be located on header 12, may be coupled to a pressurized hydraulic fluid supply-such as the hydraulic fluid circuit the operates the FORE/AFT reel movement-on propulsion unit 14, through lines 442 and 448 such as by quick connection fittings 452, 454 respectively. Control of directional diverter valve 444 may be achieved through an internal control spool that may be actuated via solenoid 456 to move diverter valve 444 between an open position, where fluid can flow between lines 442 and 458 and a closed position, where fluid flow is not permitted across the valve and will flow through the valve to the FORE OUT port (FIG. 11A). Similarly, control of directional diverter valve 450 may be achieved through an internal control spool that may be actuated via solenoid 460 to move diverter valve 450 between an open position, where fluid can flow between lines 448 and 462 and a closed position, where fluid flow is not permitted across the valve and will flow through the valve to the AFT OUT port (FIG. 11A). Diverter valves 444, 450 may be “bang-bang” controlled valves. For example diverter valves 444, 450 may be configured and operable such that: (a) if zero volts are applied to solenoids 456, 460 then be solenoid is not activated and valve springs ensure that the valves are positioned in their closed positions (FIG. 11A) and fluid moves through the FORE/AFT reel circuits when activated by an operator; (b) when 12 volts is applied producing a current of about 3 amps, then the solenoids 456, 460 are activated and the valves are moved to the open positions (FIGS. 11B and 11C) and fluid moves through the skid shoe hydraulic system when activated by an operator.

A pair of pilot operated cross check valves 468, 470 may positioned between lines 458 and 440 and between lines 462 and 446 respectively. Cross check valve 468 may be interconnected to line 462 by fluid line 472 and cross check valve 470 may be interconnected to line 458 by fluid line 474. This arrangement ensures that both of the cross-check valves 468, 470 will be in an open position/state at the same time when pressurized fluid is applied to either of lines 458, 468, for example when either of control valves 444, 450 are in the open position, and hydraulic fluid flow is delivered from the reel FORE/AFT hydraulic fluid circuits

When diverter valves 444, 450 are in the closed position fluid is not permitted to flow from line 440 to line 458 or from line 446 to line 462 and thus both of cross check valves 468, 470 will be in a closed position/state. Cross check valves 468, 470 can thus ensure that during normal operation of skid shoe adjustment system 300, i.e., when pressurized hydraulic fluid is not being supplied from either of lines 458 or 462 to the hydraulic cylinders 226a-f to adjust the position of skid shoes 200a-f, fluid will not flow back through cross check valves 468, 470 to hydraulic fluid lines 458, 460. This may be beneficial in circumstances, for example, when one or more of the skid shoes 200a-f impacts an object or raised portion of the terrain surface. This impact may cause one or more of the skid shoes to retract and create a large spike in the pressure of the hydraulic fluid. As cross check valves 468, 470 isolate the skid shoe adjustment system 300, damage to other components of the hydraulic system on the opposite side of check valves 468, 470, such as control valves 444, 450 may be prevented. It should be noted that many of the hydraulic circuit components associated with a hydraulic fluid supply and control system associated with a combine harvester, may not be designed to handle relatively high hydraulic pressures, such as those that could be generated by impacts of one more skid shoes 200a-f impacting a hard surface such as the terrain surface.

Through control of valves 444, 450 by electric control devices 464 of hydraulic fluid supply and control system 400, pressurized hydraulic fluid may be selectively supplied to lines 422, 432 to cause cylinders 226a, 226c, 226f, 226h to expand whilst cylinders 226b, 226d, 226e, 226g contract. Alternatively, pressurized hydraulic fluid may be supplied to line 430 to cause cylinders 226a, 226c, 226f, 226h to contract whilst cylinders 226b, 226d, 226e, 226g expand.

As shown in FIG. 11A, cylinders 226a, 226c, 226f, 226h are in their fully extended positions, which corresponds to the fully retracted positions for their respective skid shoe assemblies 200a, 220c, 220f, 220h. Also as shown in FIG. 11A, cylinders 226b, 226d, 226e, 226g are in their fully retracted positions, which corresponds to the fully retracted positions for their respective skid shoe assemblies 200b, 200d, 200e, 200g. This corresponds to the position for skid shoe assemblies 200a-h that is shown in FIG. 12A. In this unpowered state of hydraulic fluid supply and control system 400, diverter valves 444, 450 are in closed positions with respect to providing hydraulic fluid to the hydraulic cylinders 226a-h. Instead, hydraulic fluid supplied on line 442 from the FORE reel circuit will enter the hydraulic valve block at the FORE IN port and pass through diverter valve 444 and then follow a hydraulic line to the FORE OUT port where it is returned to the FORE/AFT reel circuits. Similarly, in this unpowered state of hydraulic fluid supply and control system 400, with diverter valves 444, 450 in these closed positions, hydraulic fluid supplied on line 448 from the AFT reel circuit will enter the hydraulic valve block at the AFT IN port and pass through diverter valve 450 and then follow a hydraulic line to the AFT OUT port where it is returned to the FORE/AFT reel circuits.

If an operator wishes to cause the hydraulic cylinders to move from the hydraulic cylinder positions shown in FIG. 11A to the positions shown in FIG. 11B (or some position therebetween), then if an operator switches the electric control devices 464 to transition valves 444, and 450 to the open positions, and the operator activates the appropriate lever in the operator cab, such that (as depicted in FIG. 11C) pressurized hydraulic fluid is supplied from line 448 through the AFT IN port, and it will then pass through diverter valve 450, into line 462, through one way valve 470, through line 446 and into line 430. If the pressurized hydraulic fluid continues to be applied in this manner, it will cause cylinders 226a, 226c, 226f, 226h to move (i.e. retract) from their fully extended positions (shown in FIG. 11C) to their fully retracted positions shown in FIG. 11B. At the same time cylinders 226b, 226d, 226e, 226g will also move from their fully retracted positions to their fully extended positions shown in FIG. 11B. Through movement of cylinders 226a-h in this manner skid shoe assemblies 200a-h and their respective skid shoes 202a-h will move together from their fully retracted positions to their fully extended positions. This corresponds to the position for skid shoe assemblies 200a-h that is shown in FIG. 12B. Hydraulic fluid being forced out of hydraulic cylinders 226a and 226h, will move through lines 422 and 432 respectively to flow divider 441 where the flow is combined into line 440, then passing through one way valve 468 and into line 458, through diverter valve 444 to exit into line 442.

As shown in FIG. 11B, cylinders 226a, 226c, 226f, 226h are in their fully retracted positions, which corresponds to the fully extended positions for their respective skid shoe assemblies 200a, 220c, 220f, 220h. Also as shown in FIG. 11B, cylinders 226b, 226d, 226e, 226g are in their fully extended positions, which also corresponds to the fully extended positions for their respective skid shoe assemblies 200b, 200d, 200e, 200g.

By way of further explanation, with the hydraulic cylinders positioned as shown in FIG. 11C (i.e., skid shoe assemblies 200a-h all in the fully retracted position), when diverter valves 444,450 are both the open position hydraulic fluid may flow from line 448 and into line 462, across check valve 470, into line 446 and into line 430. From line 430, fluid is permitted to flow through line 430 to cap end port 416d of cylinder 226d, causing cylinder 226d to expand in length. As this happens, fluid is forced through rod end port 420d of cylinder 226d, through line 428 and to rod end port 420c of cylinder 226c, causing cylinder 226c to retract in length.

As this happens, fluid is forced through cap end port 416c of cylinder 226c, through line 426 and to cap end port 416b of cylinder 226b, causing cylinder 226b to expand in length. As this happens, fluid is forced through rod end port 420b of cylinder 226b, through line 424 and to rod end port 420a of cylinder 226a, causing cylinder 226a to retract in length. The direction of fluid flow is indicated in FIG. 11C.

At the same time fluid also is permitted to flow through line 430 to cap end port 416e of cylinder 226e, causing cylinder 226e to expand in length. As this happens, fluid is forced through rod end port 420e of cylinder 226e, through line 438 and to rod end port 420f of cylinder 226f, causing cylinder 226f to retract in length. As this happens, fluid is forced through cap end port 416f of cylinder 226f, through line 436 and to cap end port 416g of cylinder 226g, causing cylinder 226g to expand in length. As this happens, fluid is forced through rod end port 420g of cylinder 226g, through line 434 and to rod end port 420h of cylinder 226h, causing cylinder 226h to retract in length. The direction of fluid flow is indicated in FIG. 11A.

Fluid is forced from cap end ports 416a, 416h of cylinders 226a, 226h through lines 422, 432 respectively and into line 440 via flow divider 441. As described above, cross check valve 468 will be in the open position (due to a supply of pressurized fluid though line 472) such that fluid can flow through cross check valve 468 as indicated in FIG. 11C, into line 458 and into line 442 via diverter valve 444, (which is also in the open position).

With cylinders 226a-h positioned as shown in FIG. 11B, if an operator wishes to cause the hydraulic cylinders to move from the positions in FIG. 11B towards or to the positions shown FIG. 11C, then the operator activates the appropriate lever in the operator cab, and pressurized hydraulic fluid is supplied from line 442 through the FORE IN port, and as depicted in FIG. 11B, then it will then pass through diverter valve 444, through line 458 and one way check valve 468, and into line 440. so that pressurized hydraulic fluid may be supplied to lines 422 and 432, which will cause cylinders 226a, 226c, 226f, 226h to move from their fully retracted positions to their fully extended positions shown in FIG. 11C. At the same time cylinders 226b, 226d, 226e, 226g will also move from their fully extended positions to their fully retracted positions shown in FIG. 11C. Through movement of cylinders 226a-h in this manner skid shoe assemblies 200a-h will move from their fully extended positions to their fully retracted positions. Hydraulic fluid being forced out of hydraulic cylinders 226d and 226e, will be fed through lines 430 where the flow flows into line 446, then passing into line 462 through diverter valve 450 to exit into line 448.

By way of further explanation, with the hydraulic cylinders positioned as shown in FIG. 11B (i.e., skid shoe assemblies 200a-h all in the fully extended position, when both diverter valves 444/450 are in the open position, hydraulic fluid may flow from line 442 and into line 458, across check valve 468 and to line 440. From line 440, a portion of hydraulic fluid is permitted to flow to line 422 via flow divider 441 to cap end port 416a of cylinder 226a, causing cylinder 226a to expand in length. As this happens, fluid is forced through rod end port 420a of cylinder 226a, through line 424 and to rod end port 420b of cylinder 226b, causing cylinder 226b to retract in length. As this happens, fluid is forced through cap end port 416b of cylinder 226b, through line 426 and to cap end port 416c of cylinder 226c, causing cylinder 226c to expand in length. As this happens, fluid is forced through rod end port 420c of cylinder 226c, through line 428 and to rod end port 420d of cylinder 226b, causing cylinder 226d to retract in length. The direction of fluid flow is indicated in FIG. 11B.

At the same time a portion of hydraulic fluid is permitted to flow to line 432 via flow divider 441 to cap end port 416h of cylinder 226h, causing cylinder 226h to expand in length. As this happens, fluid is forced through rod end port 420h of cylinder 226h, through line 434 and to rod end port 420g of cylinder 226g, causing cylinder 226g to retract in length. As this happens, fluid is forced through cap end port 416g of cylinder 226g, through line 436 and to cap end port 416f of cylinder 226f, causing cylinder 226f to expand in length. As this happens, fluid is forced through rod end port 420f of cylinder 226f, through line 438 and to rod end port 420e of cylinder 226e, causing cylinder 226e to retract in length. The direction of fluid flow is indicated in FIG. 11B.

Fluid is forced from cap end ports 416d, 416e of cylinders 226d, 226d through line 430 and into line 446. As described above, cross check valve 470 will be in the open position (due to a supply of pressurized fluid though line 474) such that fluid can flow from line 446, through cross check valve 470 as indicated in FIG. 11B, into line 462 and into line 448 via diverter valve 450, (which is also in the open position).

Hydraulic fluid supply and control system 400 may also include a pair of cross relief valves 476, 478, configured to allow fluid flow once a predetermined pressure across the respective valve is reached. Cross relief valve 476 is configured to allow fluid flow between 440 and line 446 and cross relief valve 478 is configured to allow fluid flow between 446 and line 440 once the predetermined pressure is reached. This may be beneficial in circumstances where the hydraulic pressure in either of lines 440 or 446 increases above a desired level, for example when one or more of the skid shoes 200a-h impacts an object or raised portion of the terrain surface. For example, an impact of one or more skid shoes 200a-h may cause a spike in the hydraulic pressure in line 440. The pressure increase may be sufficient to open cross relief valve 476, such that fluid may flow from line 440 to line 446, relieving some of the pressure within line 440. Similarly, an impact of one or more skid shoes 200a-h in left side 302 may cause a spike in the hydraulic pressure in line 446. The pressure increase may be sufficient to open cross relief valve 478, such that fluid may flow from line 446 to line 440, relieving some of the pressure within line 446. The pressure relief as described above may be sufficient to prevent damage to components, such as hydraulic fluid lines and seals of control system 400.

As cross relief valves 476, 478 are opened, which decreases pressure of the hydraulic fluid, skid shoes 200a-h may retract as each of the hydraulic cylinders 226a-h may move towards their center positions (i.e., the position shown in FIG. 11D for cylinder 226). The result may then be that the weight formerly carried on the skid shoes 202a-h may then be transferred and carried by cutter bar 122 and its cutter bar skid plate 1123 which may extent substantially the entire transverse width of cutter bar 122.

Hydraulic fluid supply and control system 400 may also include an accumulator 480, which may be in fluid communication with line 446 via a line 482. Accumulator 480 may be any suitable pressure vessel configured to store a volume of hydraulic fluid. Accumulator 480 may also contain a quantity of a gas (such as nitrogen). When the pressure of the hydraulic fluid within control system 400 increases above a desired level (for example when one or more of the skid shoes 200a-f impacts an object or raised portion of the terrain surface as described above), causing a large upward force on one or more the skid shoes 202a-h, the resulting increase in pressure of pressurized hydraulic fluid flowing from line 430 into line 446, may then be diverted from line 446 and flow into the accumulator 480, resulting in compression of the gas within accumulator 480. This may relive some of the pressure of the hydraulic fluid, which may prevent damage to components within hydraulic fluid supply and control system 400 on the downstream sides of cross check valve 468, 470.

Control system 400 is also configured to control hydraulic cylinders 226a-h such that skid shoe assemblies 200a-h may be positioned at any position between their first (fully retracted position) and their second (fully extended position). Once the skid shoe assemblies 200a-h are in the desired position, diverter valves 444, 450 may be closed by an operator manually adjusting/setting the appropriate control devices 464. However, this is not necessary in order for the valves to revert to the unpowered state of FIG. 11A. If no voltage is applied to the solenoids 456, 460 then the valves will be held in the closed positions by the spring mechanism associated therewith and hydraulic fluid will still be available to the reel FORE/AFT circuits.

As noted above, the operation of hydraulic cylinders 226a-h may be enabled by an operator (such as an operator of propulsion unit 14, who may actuate control devices 464 (FIG. 11A) (such as switches in the cab) to actuate both diverter valves 444, 450 to control the flow of pressurized fluid to and from left side 302 and right side 304 of skid shoe adjustment system 300. Control devices 464 may produce an appropriate valve control signal through output 466 for driving solenoids 456 and 460 to control valves 444, 450 to open both diverter valves 444, 450. When that has been done, the operator can use the same levers controls that are otherwise used for controlling the rearward (AFT) and forward (FORE) movement of the reel to activate the hydraulic cylinders as described above, and therefore the extension/retraction of skid shoe assemblies 200a-h.

In some embodiments, header height control system 10 may include one or more sensors to detect the position of some or all of skid shoe assemblies 200a-h, i.e., if some or all of skid shoe assemblies 200a-h are in the first (fully retracted) position, second (fully extended) position) and/or any position therebetween. The sensors may be positional sensors configured to detect a position of a component of the skid shoe assembly to which they are attached, such as the skid shoe, hydraulic cylinder rod of a component of the skid shoe linkage. In some embodiments, the sensor may be used to confirm a set position of the skid shoe assemblies has been achieved, or to allow a user to save an achieved position of skid shoe assemblies 200a-h that can be returned to a later date. In other embodiments, the position of the skid shoes 202a-h may be indicated by a mechanical linkage indicator such as a pointer on a ruler that is readily visible to an operator in the cab of propulsion unit 14.

As shown in FIGS. 11A and 11B, hydraulic cylinders 226a-d of left side 302 of skid shoe adjustment system 300 and hydraulic cylinders 226e-h of right side 304 of skid shoe adjustment system 300 are grouped into separated sections of the hydraulic circuit such that each section receives a separate hydraulic fluid supply (i.e., sides 302 and 304 are connected in parallel). In comparison to having all of hydraulic cylinders 226a-h connected in series, this position may reduce any delay in the movement of each of the respective skid shoe assemblies 200a-h. By dividing skid shoe adjustment system 300 into two sections 302, 304, a leak in the hydraulic system in either section may be isolated and may be easier to locate and/or contain.

In other embodiments, hydraulic cylinders 226a-h may be connected in any suitable arrangement other than shown in FIG. 11A such as all in series or all in parallel.

In an embodiment, a computer controller that may facilitate obtaining various information about the operation of skid shoe adjustment system 300 and may display such information such as for example the position of skid shoe assemblies 200a-h (i.e., whether skid shoe assemblies 200a-h are in their fully retracted position, their second fully extended position or at a position in-between. An operator may then manually adjust the degree of extension of shoe assemblies 200a-h through opening of diverter valves 444, 450 and manipulation of reel FORE/AFT circuit levers to adjust the position of skid shoe assemblies 200a-h.

Referring to FIG. 12A, main frame 100 is depicted relative to terrain surface 74, with main frame 100 in a first position where skid shoe assemblies 200a-h are in their first (fully retracted) positions. In this example, header 12 may be configured to operate in “flex mode” as described above, whereby cutter bar 122 is in contact with (or very close to) terrain surface 74 as header 12 moves across 74. As described above, When cutter bar 122—or a portion of cutter bar 122 encounters a portion of rising terrain surface, if the height control system for header main frame 100 does not raise the entire header 12 relative to the propulsion unit 14, the cutter bar 122 (or a portion of cutter bar 122) may rise relative to the header main frame 100, as the forward regions of one or more cutter bar float paddles 120/120′ pivot upwards relative to and about the pivot connection with its respective horizontal strut 116.

As referenced above, the height adjustment system (e.g. skid shoe adjustment system 300) may function and behave as an adjustable terrain reference system, that has the effect of artificially adjusting the terrain height up or down to create a physical terrain offset relative to a height sensed nominal terrain level. Accordingly, the terrain surface following apparatus (e.g. paddles 120/120′/120″ and connected cutter bar 122), and their associated HHC sensors act to provide controller 18 (FIG. 5) of a header height control system 10 with signals/data indicative of the terrain surface level. The adjustable terrain following/engaging elements (e.g. skid shoes 200a-h) are able to physically/mechanically adjust the height of the terrain following paddles 120/120′/120″ and cutter bar 122 relative to the actual terrain surface while maintaining the sensor(s) terrain height calibration of the header height control system 10. The system operates in a manner such that the HHC sensor(s) provide signals to controller 18 of an implement height positioning system 10 that indicate a level of the terrain surface that is vertically offset from the actual level of the terrain surface. Implement height positioning system 10 can be set/calibrated at a baseline position/set point with a terrain following/engaging element such as a cutter bar or other ground engaging element in contact with the terrain surface and the HHC sensors providing a particular sensor signal/data to the height positioning controller 18. The implement height positioning system 10 can then be activated and the height of the terrain following element can be raised with a height adjustment mechanism/system (such as skid shoe adjustment system 300) relative to the terrain surface. The height adjustment system may have a height adjustable device may be directly connected to the terrain following element. The implement height control system of the agricultural implement will then respond and raise the implement to target the set point again. The result is that a vertical height offset of the terrain surface level is created such that the implement height positioning system will be controlling the height of the implement relative to an artificial terrain surface level that is vertically offset from actual terrain surface level. A benefit of this approach is that it is easy for an operator to vary the actual target height of the agricultural implement without having to recalibrate the implement height positioning system.

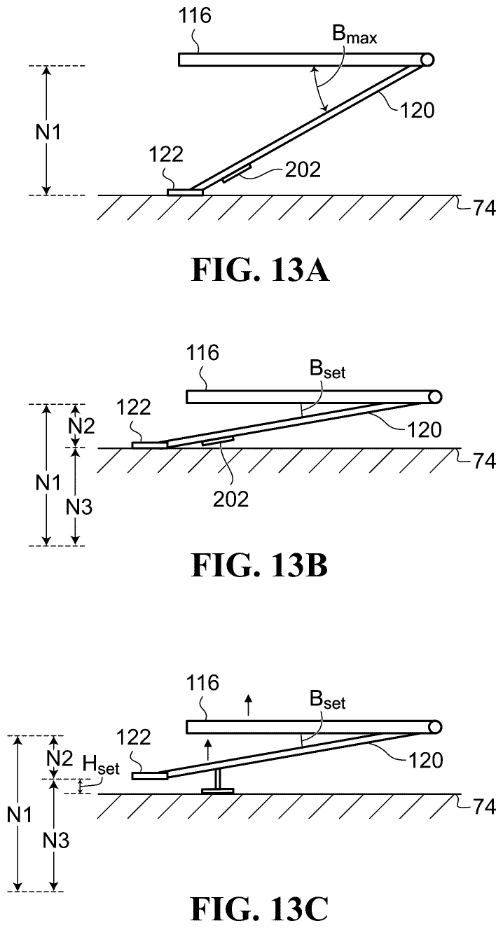

With reference to FIGS. 13A, 13B and 13C, in operation, as indicated above, it may be desired to operate header 12 in a flex mode of operation and yet have cutter bar 122 positioned at a fixed height or not move below a minimum height, above the terrain surface 74. This will enable the skid shoes assemblies 200a-h to follow the terrain of the terrain surface 74 such that cutter bar 122 maintains a constant distance above terrain surface 74. In such an example, an operator may set the header height control system 10 to flex mode and while positioning header 12 on a level terrain surface 74 (level laterally and also longitudinally) and set the height control system 10 to position the cutter bar 122 with a total range of upwards/downwards movement of a distance N1 (e.g. 9 inches) to provide a set point of the main frame that corresponds with the cutter bar 122 being at a specified distance N2 (e.g. 2 inches) down from the uppermost position-which results in it being a distance N3 (e.g. 7 inches) upwards from the lowermost position.

In FIG. 13A, a total maximum distance N1 is the vertical distance between the uppermost position of cutter bar 122 and the lowermost position of cutter bar 122, and cutter bar is also shown just in contact with the terrain surface 74 at its lowermost position and paddle 120 at its maximum pivot angle Beta_{Max}. With the header 12 set to flex mode, to establish a set point for the header height control system the header height control system 10 can cause header frame 100, including horizontal strut member 116, to be lowered towards the terrain surface 74, until such time as a sensor associated with header height control system 10 determines for the header height control system that the appropriate pivot angle Beta_{Set} and corresponding position of cutter bar 122 have been reached which corresponds to the cutter bar 122 being at a set point specified distance N2 (e.g. 2 inches) down from the uppermost position in its upwards/downwards range, and a corresponding set point distance N3 (e.g. 7 inches) up from the lowermost position in its upwards/downwards range, which is shown in FIG. 13B. It will be appreciated that the sum of distances N2 and N3=N1.

The next step is to set the desired cutting height H_{Set} of the cutter bar and its cutting blades (e.g. H_{Set}=3 inches). This is done by an operator activating skid shoe adjustment system 300 to extend the skid shoes 202a-h from the fully retracted positions, so that they engage the terrain surface 74 and start to push upwards paddles 120/120′ and the cutter bar 122 attached thereto relative the terrain surface 74. The header height control system 10 will then respond to what appears to system 10 to be equivalent to the cutter bar 122 passing over rising terrain surface 74 and the system 10 will then raise the header frame 100, including the horizontal strut members 116, to re-establish and maintain the set point angle Beta_{Set} and the corresponding set point distances N2 and N3. This extension of skid shoes 202a-h (identified 202 in FIGS. 13A-C) by an operator will continue until the desired cutting height Hₛₑₜ of the cutter bar 122 is reached across its transverse width. There will be, during the extension of skid shoes 202, a corresponding operation of header height control system 10 to raise the header frame 100, including the horizontal strut members 116, to re-establish and maintain the set point angle Beta_{Set} and the corresponding set point distances N2 and N3.

Once the skid shoes 202 have been extended sufficiently so that the cutting height of the cutter blade Hₛₑₜ has been reached, header 12 is then ready to be operated to cut crop in a crop field. With the header 12 operating in flex mode, and in combination with the header height control system 10, the skid shoes 202a-h will follow the level of the terrain surface 74 generally maintaining the desired cutting height of the cutter bar above the terrain surface.

It is possible that the operator may wish to adjust the desired cutting height Hₛₑₜ on the fly during operation of the agricultural implement and propulsion unit 14, as referenced elsewhere herein. By virtue of the co-operation of the header height control system 10 with the skid shoe adjustment system 300, this may be accomplished—with changes in the cutting height being realized by the operation of both systems.

Turning now to FIG. 12B, main frame 100 is depicted in isolation relative to terrain surface 74, with main frame 100 in a second position and where skid shoe assemblies 200a-h have been at least partially extended positions, as operated by hydraulic control system 400 described above and skid shoe adjustment system 300. With header 12 still configured to operate in “flex mode” the lower surfaces of each of the respective skid shoes 202a-h of skid shoe assemblies 200a-h are in contact with the terrain surface, such that cutter bar 122 is raised relative to and positioned above the terrain surface 74 (as controlled by header height control system 10 and skid shoe adjustment system 300). As shown in FIG. 12B, each of the skid shoes 202a-h are in contact with a proximal region of terrain surface 74, designated 74a-h respectively. As a result, each region of cutter bar 122 longitudinally adjacent to each region of terrain surface 74a-h, will be separated from the terrain by a distance D2 (FIG. 12B). Assuming that terrain surface 74 is level the distance D2 will be generally equal across cutter bar 122.

In operation, with header 12 configured as shown in FIG. 12B, as header 12 moves across terrain surface 74 the lower surfaces of skid shoes 202a-h will continue to rest on and “follow” the terrain that they are in contact with, such that a significant proportion of the weight of the cutter bar 122 and the weight of the paddles 120, 120′, 120″ and the skid shoe assemblies 200a-h is supported on the terrain surface 74 by the lower surfaces of skid shoes 202a-h. As the skid shoe assemblies 200a-h are interconnected to cutter bar float paddles 120/120′, then any rises/drops in the level of the terrain surface 74 beneath the lower contact surface of the skid shoes 202a-h will be transmitted though the respective skid shoe assemblies 200a-h, causing the forward regions of one or more cutter bar float paddles 120/120′ to respectively pivot upwards/downwards relative to and about the pivot connection with its respective horizontal strut 116. This will cause the adjacent section of cutter bar 122 to respectively rise/drop relative to main frame 100.

For example, as any or all of skid shoes 202a-h encounter a region of rising terrain surface 74 (i.e., some of all of regions 74a-h are raised relative to other regions) then the adjacent skid shoe, which is following the respective region of terrain surface, may rise relative to the main frame 100, causing the forward regions of one or more cutter bar float paddles 120/120′ to pivot upwards relative to and about the pivot connection with its respective horizontal strut 116. This will cause the adjacent section of cutter bar 122 to rise relative to main frame 100. The effect of this is that as one or more of skid shoes 202a-h encounter rising terrain surface, the adjacent portion of the cutter bar 122 will rise an equivalent distance, such that the distance D1 between the cutter bar 122 and the adjacent region of terrain surface 74 is maintained.

Further, with cutter bar 122 configured in “flex mode” each paddle 120 may be set to a set position, such that it is able to independently move upwards 2 inches and downwards 7 inches relative to the header main frame 100. As such, as any or all of skid shoes 202a-h encounter a region of lower terrain surface 74 (i.e., some of all of regions 74a-h are lower relative to other regions), then the adjacent skid shoe, which is following the respective region of terrain surface 74 may fall relative to the main frame 100, causing the forward regions of one or more cutter bar float paddles 120/120′ to pivot downwards relative to and about the pivot connection with its respective horizontal strut 116. This can cause the adjacent section of cutter bar 122 to fall relative to main frame 100. The effect of this is that as one or more of skid shoes 202a-h encounter lower terrain surface, the adjacent portion of the cutter bar 122 will fall an equivalent distance, such that the distance D1 between the cutter bar 122 and the longitudinally adjacent region of 74 is maintained.

As a result of maintaining a generally constant distance D2 of cutter bar 122 from the across the width of cutter bar 122, the cutter bar 122 is protected from undesirable impacts with terrain surface 74 that could lead to premature wear or damage to the cutter bar. Further, by maintaining a generally consistent distance D2 as header 12 moves across terrain surface 74, the crop may be cut at a consistent height as desired.

As described above, skid shoe assemblies 200a-h may be adjusted to be at any position between the fully retracted and fully extended positions by an operator such the position of cutter bar 122 relative to 74 (i.e., distance D2) may be finely controlled.

Due the close longitudinal proximity of each terrain contact areas of the skid shoes 202a-h of the skid shoe assemblies 200a-h to cutter bar 122, and as it is the contact of each of the skid shoes 202a-h with the adjacent region of terrain surface 74 that raises/lowers the height of cutter bar 122 relative to the terrain surface 74, this ensures that the terrain contact areas of the skid shoes 202a-h are following the same terrain as is longitudinally proximal to cutter bar 122. This means that there is minimal delay in movement of the cutter bar 122, when the cutter bar and then the skid shoes 202a-h pass over changing terrain slope conditions. By comparison, if the terrain contact areas of skid shoes 202a-h were located further back from the cutter bar 122, then each skid shoe 202a-h would encounter the changing terrain slope conditions much later than cutter bar 122, and any response in the height of cutter bar 122 would be delayed, such that then the distance D2 may vary to a greater extent as header 12 moves across terrain surface 74.

As referenced above, the desired adjustment of the height of cutter bar 122 by activating the skid shoe assemblies 200a-h may be performed if the cutter bar 122 is initially in contact with the terrain surface, but the extension of the skid shoe assemblies 200a-h and their skid shoes 202a-h is performed in conjunction with the operation of the header height control system 10. Accordingly, during the extension of the skid shoe assemblies 200a-h, the header height control system 10 is supporting a large proportion of the weight of the header 12. However, it should be noted in some embodiments, the desired adjustment of the height of cutter bar 122 by activating the skid shoe assemblies 200a-h may be performed if the cutter bar is initially appropriately spaced above the terrain surface to allow the skid shoes to be extended unimpeded by not making contact with the terrain surface during the extension of the skid shoe assemblies 200a-h. However, is not desirable or intended that the desired adjustment of the height of cutter bar 122 by activating the skid shoe assemblies 200a-h may be performed if the cutter bar 122 is initially in contact with the terrain surface and is carrying a large portion of the weight of the header 12—such that the skid shoe assemblies 200a-h would be required to lift a large portion of the weight of header 12. The skid shoes assemblies 200a-h may not be appropriately configured to be capable of lifting that amount of weight, and the weight of the header can/should only be lifted by employing the header height control system 10 to lift a large proportion of the weight of the entire header 12.

As described above, when the header 12 is operating in flex mode, the skid shoe adjustment system 300 can be used to adjust and hold the position of the cutter bar (and front region of the paddles 120/120′120″ to which the cutter bar is attached), above the terrain surface, regardless of the upwards/downwards movement of the horizontal struts 116 of the main header frame 100 to which the paddles 120/120′/120″ are attached (FIG. 2A).

When the position of the pistons on each of the hydraulic cylinders has been set, each skid shoe assembly 200a-h is generally a rigid arrangement of components, with very little if any, elastic deformation possible when one or more components (such as the skid shoes 202a-h) are subject to dynamic forces/loads. When one or more of the skid shoes 202a-h of skid shoe assemblies 200a-h, impact an object or raised portion of the terrain surface, this impact/collisions force may cause one or more of the skid shoes 202a-h to retract least to some extent, may create a large upward spike in the pressure of the hydraulic fluid within one or more of the two-way acting hydraulic cylinders 226a-h. That spike in hydraulic pressure, may, at least in some embodiments be passed along to other components of the hydraulic system. An impact force on one or more skid shoes 200a-h where the resultant force acting on each hydraulic piston tends to be directed to push the piston inwards or pull outwards the piston, may cause a large increase in in hydraulic pressure within one or more of the hydraulic cylinders 226a-h. Valves such as check valves may prevent, at least to some extent, the negative effects of the large increase in hydraulic pressure within a hydraulic cylinder 226a-h. However, it is desirable to reduce the negative impact of such a large fluid pressure spike/impact force on the components of one or more of the hydraulic cylinders 226a-h, including on the piston rod, the cylinder, piston and the associated hydraulic fluid seals.

Additionally, impacts on the skid shoes 202a-h can cause negative effects on other components of the skid shoe assemblies 200a-h (beyond the hydraulic cylinders) and associated connections to the cutter bar float paddles 120/120′/120″. The impact/collision forces may, at least in some situations, cause such components to vibrate excessively potentially causing damage and/or excessive wear on, or breakage of, one of more of the components.

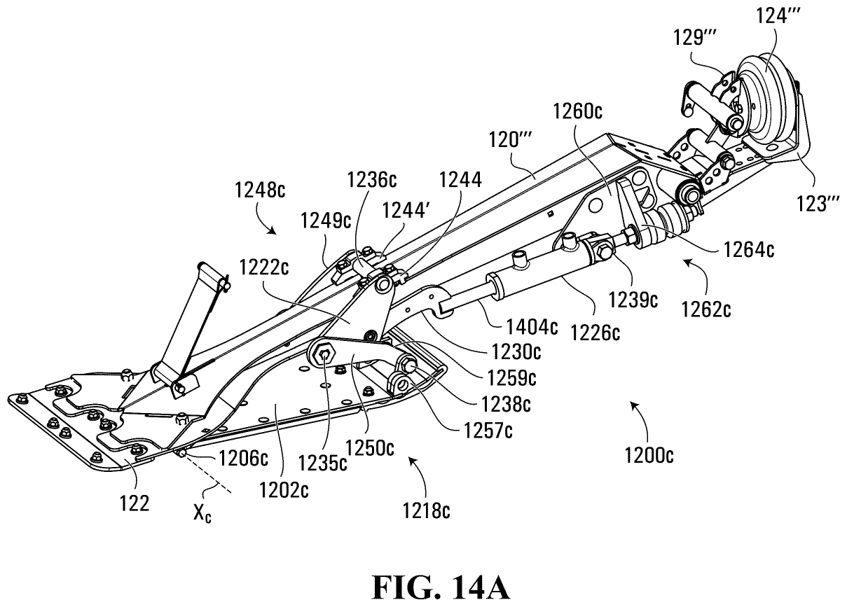

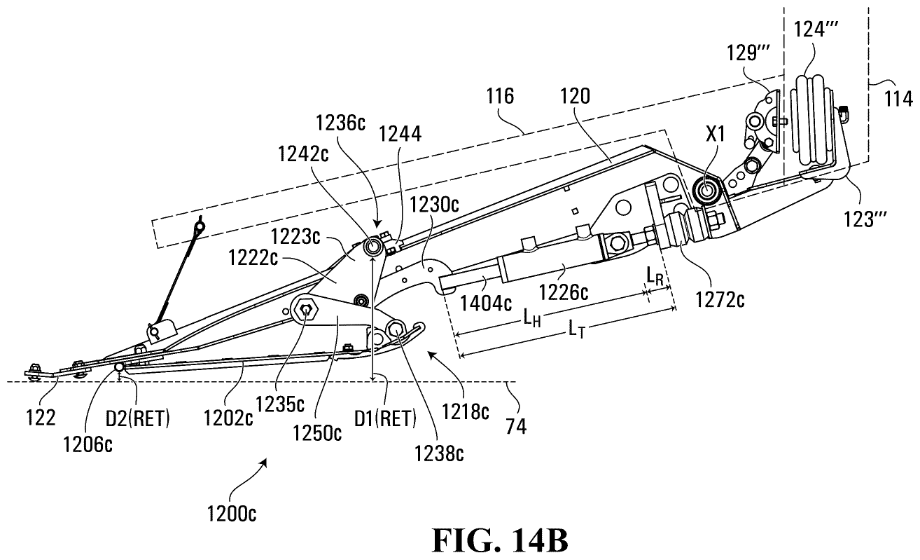

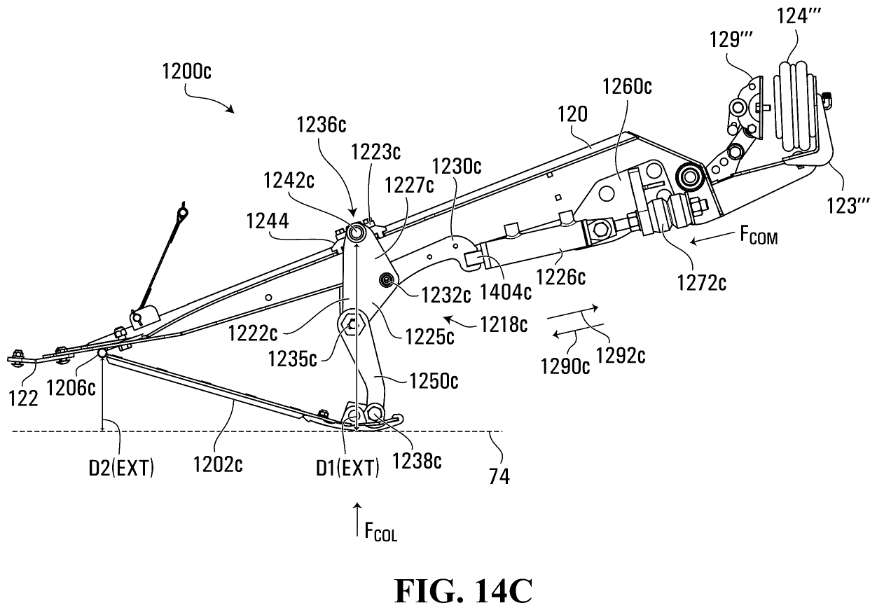

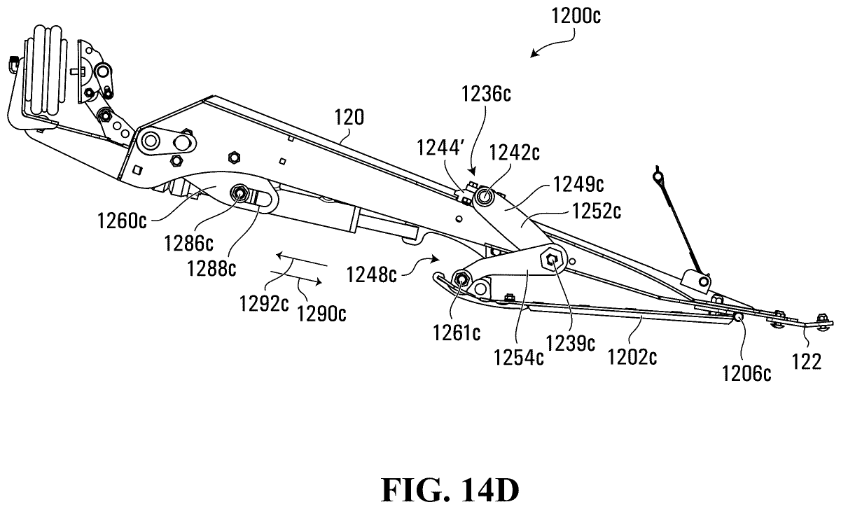

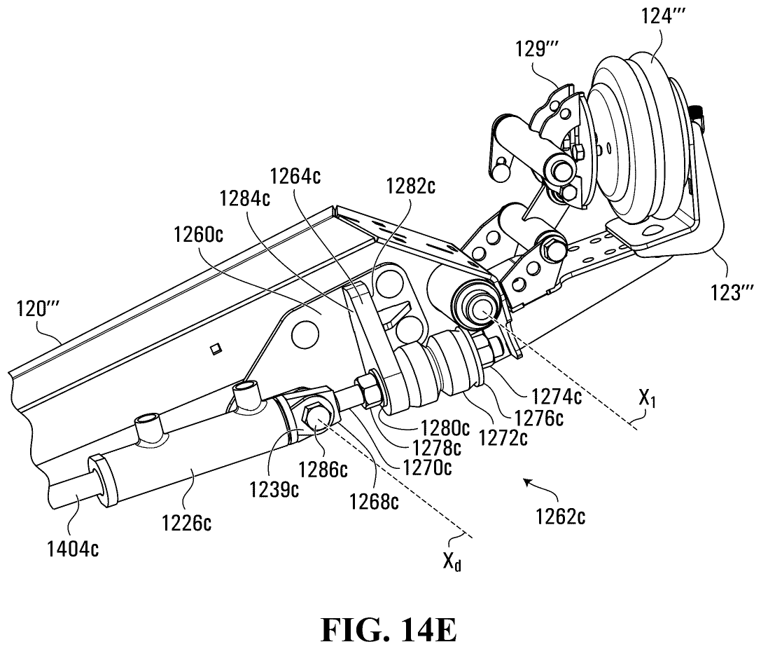

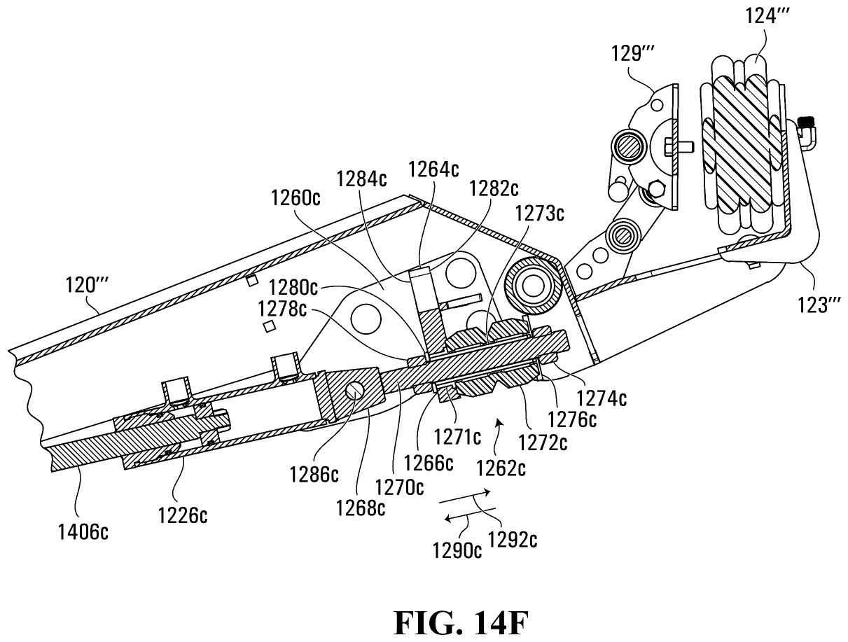

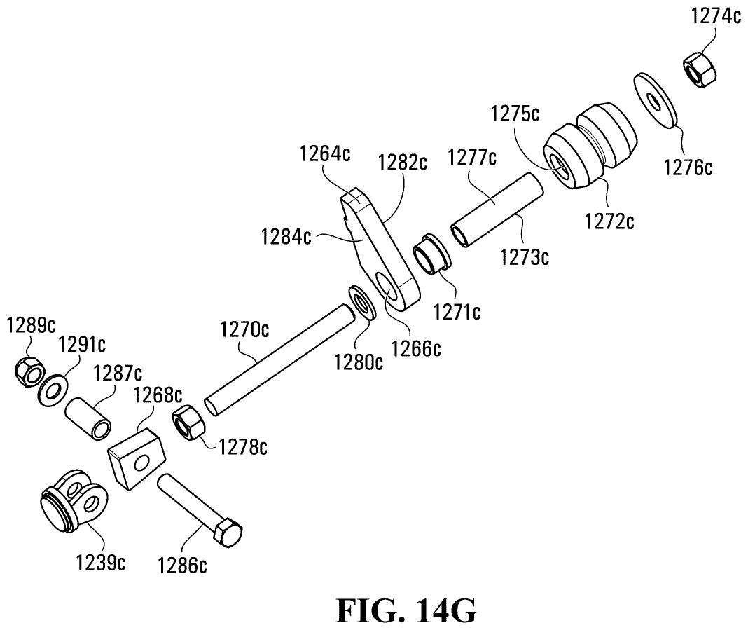

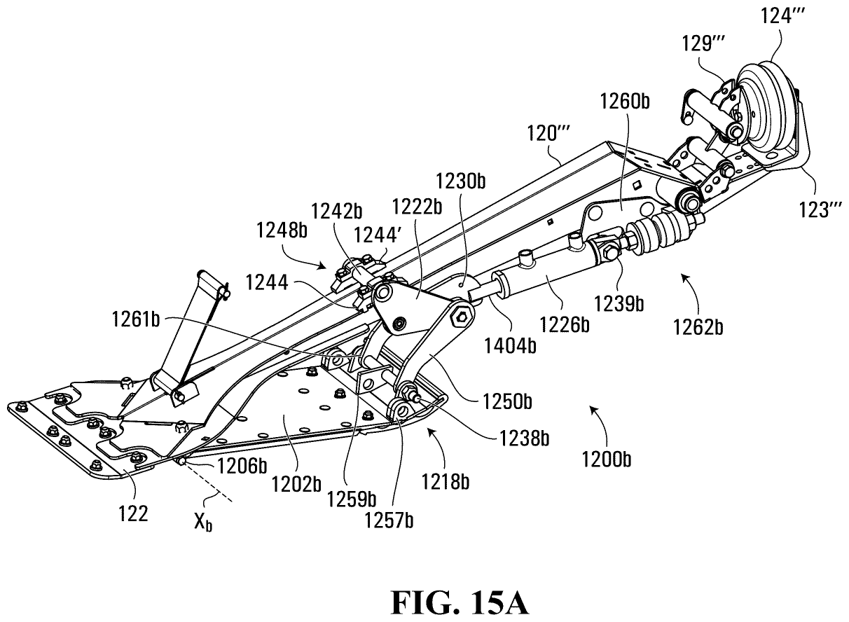

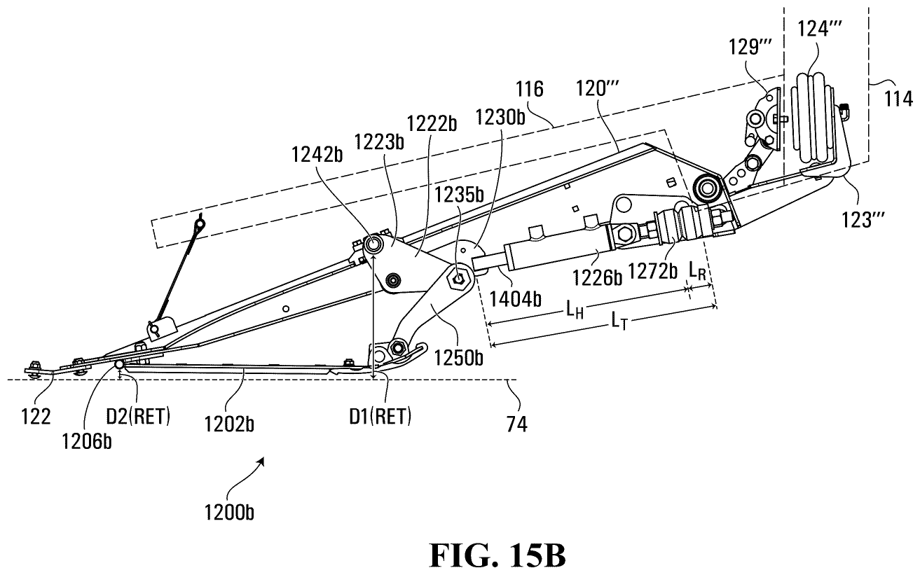

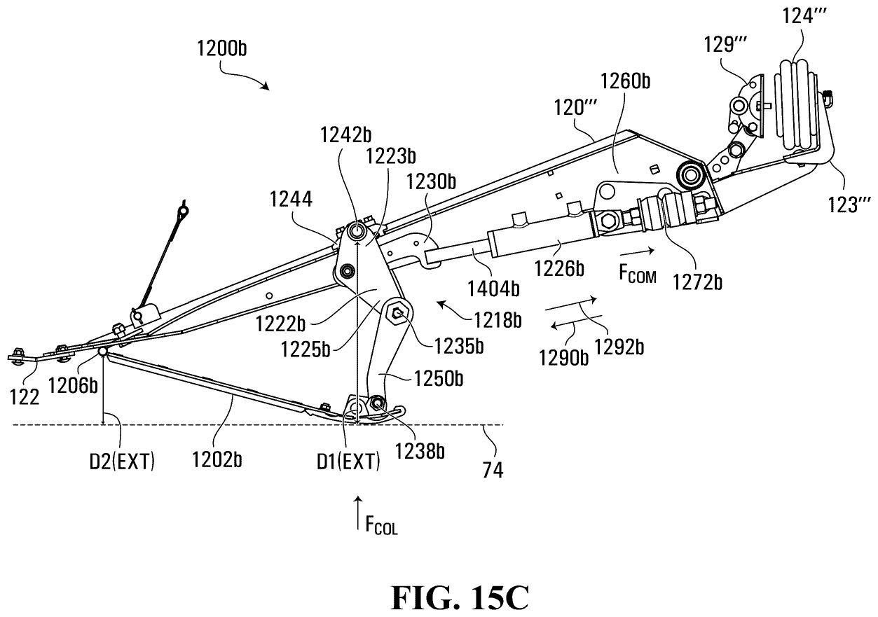

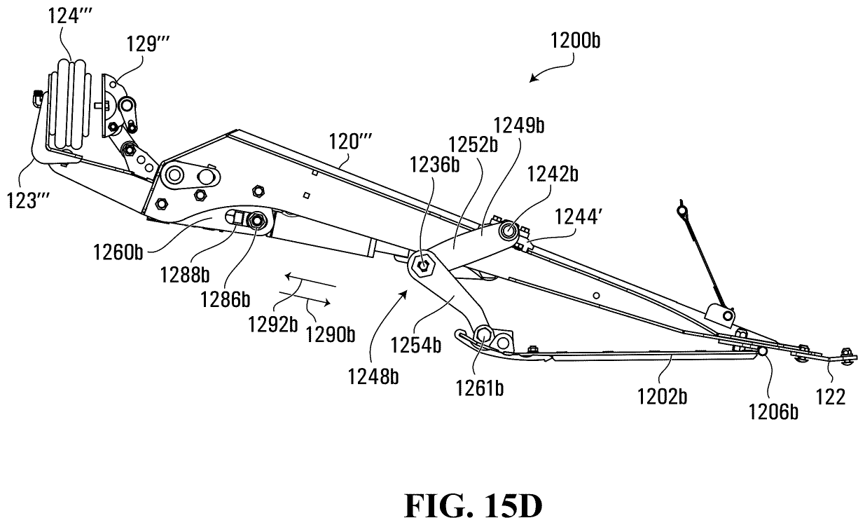

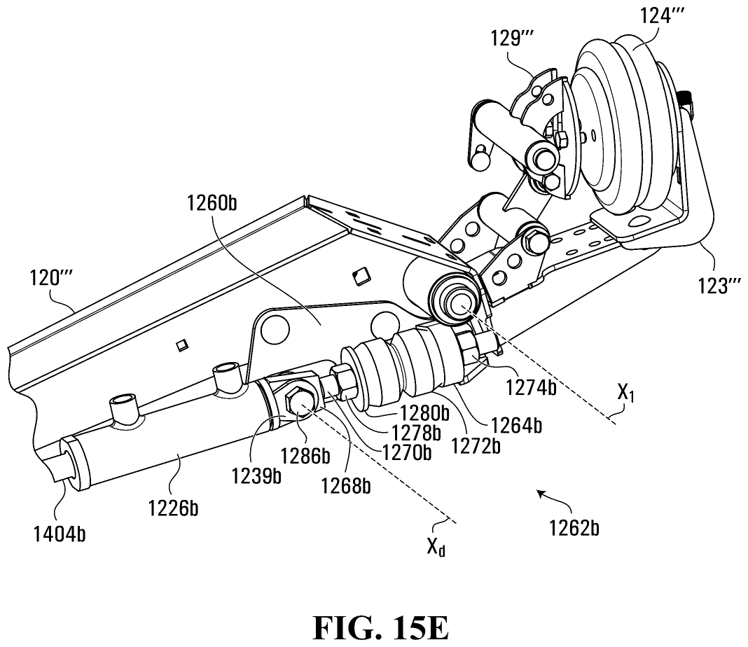

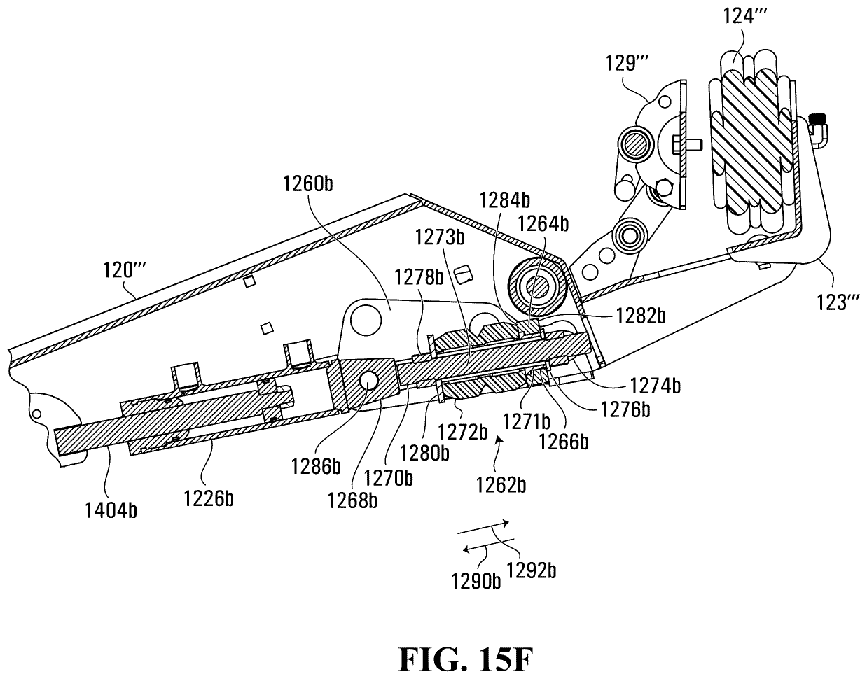

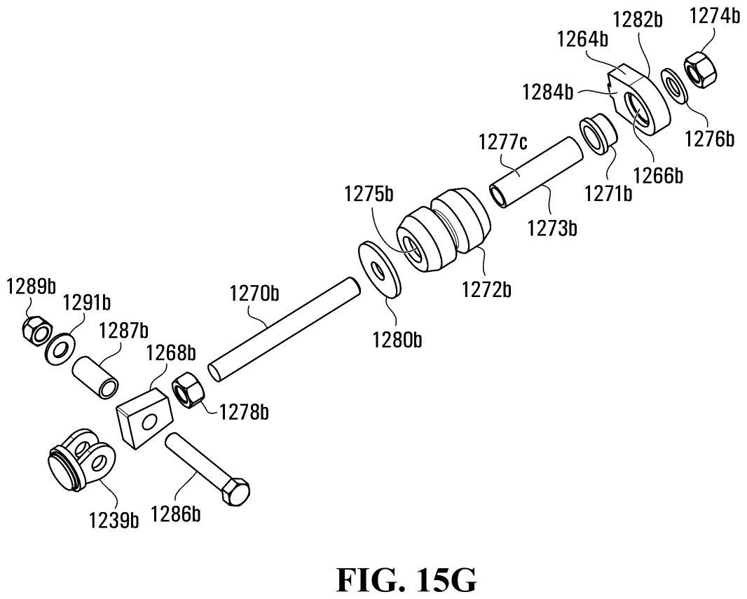

With reference generally to FIGS. 14A to 14F and 15A to 15G, modified skid shoe assemblies 1200c/1200b which have a significant and increased level of compliance (ie. they have a significantly reduced stiffness) are disclosed. As illustrated, this may be done by introducing an elastically and/or resiliently deformable component/assembly which may be part of or comprise a shock/force absorbing assembly 1262c/1262b, as described hereinafter. A rubber spring component is particularly well-suited including being very durable, for such an elastically and resiliently deformable component, given the various design constraints in skid shoe assemblies as described herein.

With reference now specifically to FIGS. 14A to 14F, a representative cutter bar float paddle 120′″ is illustrated, several of which may support a cutter bar, in a manner like that described above. Each cutter bar float paddle 120″ may be mounted/pivotally connected to a portion of header frame 100 such as a vertical strut 114, and/or a horizontal strut 116, in a manner as generally described above. Each cutter bar float paddle 120′″ may also be configured and operate in substantially the same way as cutter bar float paddles 120, 120;′ as described above and may be substituted for each of cutter bar float paddles 120, 120;′, 120″. Also illustrated is an example of one alternate skid shoe assembly 1200c that may be installed on each respective cutter bar float paddle 120″ and which introduces enhanced compliance of the assembly, particularly in association with the hydraulic cylinders. Another, functionally similar, skid shoe assembly 1200b is described below and may be deployed on some other cutter bar float paddles 120″. Like with cutter bar float paddle 120′ as described above (and generally similar to cutter bar float paddles 120 and 120″), at least one cutter bar float gas bag, which may be a cutter bar float air bag 124″ may be supplied with pressurized gas/air, and mounted between a rearwardly generally vertically extending plate member 123′″ of each cutter bar float paddle 120″ and a front side, generally vertically extending mounting plate 129′″ of cutter bar float paddles 120″ Mounting plate 129′″ is part of a pivoting mounting bracket assembly, like bracket assembly 128′ described above. Depending upon the pressure in the air bags 124″ of the plurality of such cutter bar float paddles 120″ supporting a cutter bar, the cutter can be operated in both a flex mode or rigid mode, as described above.

Except as described hereinafter, each skid shoe assembly 1200c may be configured in substantially the same manner as skid shoe assemblies 200c and 200f and may operate in substantially the same manner as skid shoe assemblies 200c and 200f as described above, and in particular, as when cutter bar 122 is being operated in flex mode as described above. Skid shoe assembly 1200c may be substituted for each of skid shoe assemblies 200a, 200c, 200f and 200h described above on each of their cutter bar float paddles. It will be noted that each of skid shoe assemblies 200a, 200c, 200f and 200h incorporates an actuator such as a hydraulic cylinder 226, such that when the pistons extend, the skid shoes retract; and when the pistons retract, then the skid shoes extend. Skid shoe assembly 1200c operates generally in the same manner.

A representative skid shoe assembly 1200c may include a skid shoe 1202c (which may be like skid shoe 202c) that may be pivotally directly attached/connected beneath the lower front end of a cutter bar float paddle 120 to a rearwardly extending portion of cutter bar 122 with a hinge 1206c (FIGS. 14A-C) such that skid shoe 1202c may pivot about a generally transversely orientated pivot axis Xc (FIG. 14A) so that the vertical spacing of the cutter bar 122 above the terrain may be set, as described above.

Skid shoe assembly 1200c may also include a skid shoe pivot linkage 1218c-which may be configured substantially the same as skid shoe linkage 218c described above—and may like all the skid shoe linkages described herein, have components made from suitably strong materials such as for example a hardened steel. Skid shoe pivot linkage 1218c may include a bell crank device 1222c, an interconnected crank arm 1230c, and an interconnected lower arm 1250c (FIGS. 14A and 14C). Skid shoe linkage 1218c may be positioned generally on one transverse side of paddle 120. On the opposite transverse side of paddle 120 may be another linkage 1248c (FIG. 14D) which may include a linkage arm 1249c interconnected at one end to pivot pin 1242c and at an opposite end to an interconnected lower arm 1254c (FIG. 14D). The components of linkage 1248c may also be made from suitably strong materials such as for example a hardened steel. Linkage 1248c may be operationally interconnected to skid shoe linkage 1218c.

The upper end 1223c of bell crank 1222c is pivotally connected at a pivotal connection 1236c (FIG. 14A-C) to cutter bar float paddle 120″ through pivot pin 1242c (FIG. 14C). Pivot pin 2142c may be retained for pivotal movement by a pair of brackets 1244, 1244′ (FIG. 14A) which may be made from suitably strong materials such as hardened steel, and the brackets may be secured/fixedly attached to the upper surface of cutter bar float paddle 120″. The opposite end of pivot pin 1242c may extend through bracket 1244′ and be received in an upper opening of linkage arm 1249c (FIG. 14D) which is on the opposite transverse side of paddle 120″ to bell crank 1222c. Thus, linkage arm 1249c and bell crank 1222c may be fixedly connected to pivot pin 1242c and may all pivot together at pivotal connection 1236c about the longitudinal axis (oriented in a transverse direction) of pivot pin 1242c.

With particular reference to FIG. 14C, the lower end 1225c of bell crank 1222c is also pivotally connected to the upper end of lower arm 1250c through pivotal connection 1235c. Similarly, the lower end 1252c of linkage arm 1249c is also pivotally connected to the upper end of lower arm 1254c through pivotal connection 1236c (FIG. 14D)

The lower ends of lower arms 1250c and 1254c are each pivotally connected to skid shoe 1202c through a transversely extending pivot pin 1238c, which is received in brackets 1257c, 1259c, 1261c (FIGS. 14A and 14D). Brackets 1257c, 1259c, 1261c are in turn secured to base plate 1204c of skid shoe 1202c, such as by welding. Compared to plate support members 212, 214, 216, utilized in embodiments of skid shoe assemblies 200a as described above, brackets 1257c, 1259c, 1261c are structurally simpler, typically have less crop material building up in their vicinity, and tend to be more self-cleaning functionally with respect to crop buildup.

Skid shoe linkage 1218c, including bell crank 1222c and linkage 1248c, including interconnected linkage arm 1249c, may be actuated by a double (two-way) acting hydraulic cylinder 1226c and be moveable from a first (fully extended) position as shown in FIG. 14C to a second (fully retracted) position as shown in FIGS. 14A, 14B and 14D, and also moveable from the second (fully retracted) position to the first (fully extended) position. Hydraulic cylinder 226a may be a double (two-way) acting hydraulic cylinder with an actuating piston arm controlled by a hydraulic fluid supply system. Hydraulic cylinder 1226c (like hydraulic cylinder 1226b described below) may be controlled by a hydraulic fluid supply and control system like system 400 as referenced above (FIGS. 11A-C).

The front end of hydraulic cylinder 1226c (hydraulic cylinder piston rod end) may have the forward end of its piston rod 1404c fixedly attached (such as by bolting) to a rearward end of crank arm 1230c. Thus, crank arm 1230c may function as a shaped extension of piston rod 1404c. Crank arm 1230c may have its forward end pivotally connected to the rearwardly projecting medial portion 1227b of bell crank 1222c at pivotal connection 1232c. Piston rod 1404c may be configured to retract inwards and extend outwards in the direction of its central longitudinal axis and it may also be configured to rotate/pivot to some extent about its central longitudinal axis whilst the forward end is still fixedly attached to rearward end of crank arm 1230c. This latter feature will prevent any binding forces as other elements of skid shoe assembly 1200c or paddle 120 deform or flex during operation.

The rear end (hydraulic cylinder portion end) of hydraulic cylinder 1226c may be pivotally connected to a mounting bracket 1260c via a mechanism that may provide for an increased amount of mechanical compliance in the connections of the hydraulic cylinder to other components off the skid shoe assembly 1200c. This mechanism may be a force mitigation/energy dissipation mechanism such as a shock absorbing assembly 1262c, which is illustrated in FIGS. 14E-14G. Mounting bracket 1260 is fixedly attached to a surface of paddle 120″. Shock absorbing assembly 1262c may be operationally and physically positioned between the main frame 100 and the terrain contact unit of said height adjustment apparatus. The shock absorbing assembly 1262c may be operationally positioned between at least part of the operational unit (such as paddle 120″) and the terrain contact unit of said height adjustment apparatus. Shock absorbing assembly 1262c may be specifically operably and physically located between the hydraulic cylinder 1226c and the paddle 120″ such that impact forces on skid shoes 1202c are cushioned upon transmission to hydraulic cylinder 1226c.

Shock absorbing assembly 1262c may include a shock absorbing device 1272c, and a mounting bracket 1260c fixedly mounted such as with bolts and/or welding to a generally vertical and longitudinally extending side surface of paddle 120, with a generally transversely and vertically projecting tab/flange 1264c having an opening 1266c extending therethrough which is longitudinally aligned with hydraulic cylinder 1226c (FIG. 14F). Bracket 1260c may thus pivot with paddle 120 about the paddle pivot axis X1 (FIG. 14E).

At the rear end of hydraulic cylinder 1226c is a cylinder connecting lug 1239c (FIG. 14E) which is pivotally connected to a connector block 1268c at a forward end of a rod 1270c via a pivot pin 1286c (which is configured to pivot within a sleeve 1287c shown in FIG. 14G) such that hydraulic cylinder 1226c can pivot at its rear end relative to rod 1270c about the transverse axis Xd of pivot pin 1286c (FIG. 14E).

With reference to FIGS. 14D and 14G, pivot pin 1286c, which extends through connecting lug 1239c, connector block 1268c and sleeve 1287c, also extends through a longitudinally extending slot 1288c in mounting bracket 1260c and is secured by nut 1289c and washer 1291c. As will be explained in more detail below, slot 1288c may function to guide longitudinal movement of hydraulic cylinder 1226c and rod 1270c.

With reference to FIGS. 14F and 14G, a bushing 1271c may be received within opening 1266c in tab 1264c and a sleeve 1273c may be partially received within bushing 1271c and extend in a rearward direction from bushing 1271c. Rod 1270c also extends in rearwards direction through sleeve 1273c. As noted above, the force mitigation/energy dissipation device operating within skid shoe assembly 1200c may be provided by shock absorber assembly 1262c, which may include shock absorber device 1272c which may be or include an elastically and resiliently deformable component that may provide for elastic/spring-like deformation. The force mitigation/energy dissipation device may be operable to one or more of, isolate, absorb, cushion, and dampen at least some of the static and dynamic forces that are being transferred/transmitted from the skid shoes 1202c to the other components of the skid shoe assemblies 1200c, including hydraulic cylinders 1226c.

As illustrated, shock absorber device 1272c may be configured with a generally longitudinally extending body made from a suitable elastically and/or resiliently deformable material, and may have a generally circular cylindrical longitudinally oriented and extending central opening 1275c such that shock absorber device 1272c may be friction fit with the outer circular cylindrical surface 1277c of sleeve 1273c, as it may be received on and positioned generally over sleeve 1273c at the rearward surface 1282c of tab 1264c (FIGS. 14F and 14G).

Rod 1270c and sleeve 1273c may each have complimentary generally circular cylindrical cross sections. Rod 1270c may have a circular cylindrical outer surface that may be threaded in each opposite end region. Rod 1270c and connector block 1268c may be made from any suitably strong and configured material(s) such a hard chrome for a cylinder rod and may be formed as separate but fixedly connected parts, or a single piece, or two pieces that are welded together to form a single assembly/weldment. Bushing 1271c made be made from any suitable material such as bronze.

Sleeve 1273c and shock absorber device 1272c may be retained in place on rod 1270c by nut 1274c (which engages a threaded portion at a rearward end of rod 1270c) and a washer 1276c, which engages/presses upon the rear end of shock absorber device 1272c. Received on rod 1270c at the forward face 1284c of tab 1246c may be nut 1278c (which engages a threaded portion of the forward end of rod 1270c) and washer 1280c, which engages forwards face 1284c of tab 1264c. Thus, sleeve 1273c is sandwiched between washers 1276c and 1280c. Shock absorber device 1272c is sandwiched between the rearward facing surface 1282c of tab 1264c and washer 1276c. Washers 1276c and 1280c are retained in position on rod 1270c by nuts 1274c and 1278c, respectively. Thus, rod 1270c, sleeve 1273c, washers 1276c, 1280c and nuts 1276c, 1278c may form a single unit or unified sub-assembly that is slidably moveable in a longitudinal direction within/through/in relation to bushing 1271c and tab 1264c.

Shock absorber device 1272c may be elastically resilient so as to recover to its original size/length after the application of additional compressive forces. Thus, longitudinal movement of rod 1270c in the direction indicated by arrow 1290c in FIG. 14F, which is accompanied by longitudinal movement of sleeve 1273c, washers 1276c, 1280c and nuts 1276c, 1278c in the same direction causes compression and elastic and/or resilient deformation of shock absorber device 1272c between the rear face 1282c of tab 1264c and washer 1276c—thus providing enhanced mechanical compliance of the skid shoe assembly 1200c, especially in association with hydraulic cylinder 1226c. This elastic/resilient deformation can absorb/cushion the forces being transmitted to the hydraulic cylinder 1226c. It should be noted that there may be a significant amount of frictional resistance within the linkage components of skid shoe assembly 1200c, such that once the dynamic forces applied to the skid shoe 1202c terminate, the elastic deformation of the shock absorber device 1272c may not oscillate to any significant extent as energy is dissipated through the frictional engagement of those linkage components. The mass of the all the components that are in motion will tend to provide a suitable degree of dampening of the spring action of shock absorber device 1272c. Thus, the ability of the shock absorber device to provide significant dampening may not be of importance. However, in some embodiments, shock absorber device 1272c may itself be configured to also dampen the applied impact compressive forces.

In some embodiments the shock absorber device may be a rubber spring, such as an AEON rubber spring model A00525-7500H produced by Timbren Industries Inc. of Whitby, Ontario, Canada. This rubber spring has an unloaded internal diameter of 1⅛ inches, an unloaded external diameter of 2⅜ inches and an unloaded length of about 3 inches and with a maximum rated load capacity of about 6800 lbs or more. Such a rubber spring has a relatively high load capacity in a relatively small package and has a suitable load/deflection profile. It may deflect in the range of about 2.3 inches when subjected to a compressive load of about 6800 lbs but it may deflect about 2 inches when only subjected to a compressive load of about 3000 lbs. The use of a rubber spring may also be beneficial due to the high resistance to wear (e.g. cracking) and immunity to rust.

During operation of agricultural apparatus 30 in flex mode of header 12, as header 12 moves across terrain surface 74, the lower surface of the skid shoes 1202c of header 12 will rest on and “follow” the terrain that they are in contact with. However, this may result in dynamic collision forces being applied to the skid shoes, such as from collisions/impacts of the skid shoes 1202c with for example uneven portions of terrain surface 74, or objects, such as for example rigid or semi-rigid objects such as rocks. The location of the impact force on a skid shoe 1202c may vary and the direction of the impact force may also vary. However, the impact force may generally have a component that is acting in a vertically upwards direction and/or a horizontally rearwards direction relative to the skid shoe 1202c. In relation to skid shoe assembly 1200c, such collisions/impacts may for example result in a generally upwardly directed impact/collision force F_{col} (see FIG. 14C), that is imparted over a short interval of time to skid shoe 1202c in a generally vertically upwards direction and generally in a location at the rearward region of the skid shoe 1202c where it typically contacts the terrain surface 74. In some situations, the direction of collision/impact force F_{col} may be at an oblique angle to the vertical direction. The impact/collision force Fool may in part be transferred through hinge 1206c to cutter bar 122. The collision/impact force F_{col} may at least in part also be transferred through skid shoe linkage 1218c, linkage 1248c and pivotal connection 1236c to cutter bar float paddle 120″. Also, the impact/collision force Fc may at least in part also be transferred through skid shoe linkage 1218c to hydraulic cylinder 1226c, resulting in a force F_{com} acting for a short interval of time urging hydraulic cylinder 1226c in direction 1290c (FIG. 14F) as crank arm 1230c is pulled to the left and downwards by bell crank device 1222c, which in turn pulls on piston rod 1404c generally in the same direction. However, the force F_{com} will be transmitted to shock absorber device 1272c which absorbs at least some of that force and associated energy, thus reducing the force effect on hydraulic cylinder 1226c.

The magnitude of the collision force F_{col} imparted to skid shoe assembly 1200c may increase as the speed agricultural apparatus 30 is traveling increases. Depending on the magnitude and frequency of occurrence of collision forces Fc, such collisions may possibly result in premature wear, damage or failure of components of skid shoe assembly 1200c and cutter bar float paddle 120″. The presence of shock absorbing assembly 1262c, including shock absorber device 1272c, may dissipate at least some of the energy being transferred to some or all of these components and reduce some of the negative effects of the collision force F_{col} on these components, including in particular negative effects on hydraulic cylinder 1226c.

As explained above, when header 12 is operating in flex mode, the header height control system 10 may in some instances detect changes in the height of the terrain surface 74 and may then respond and raise the frame/implement to a target set point again. The header height control system 10 may provide a significant level of height control for header 12, but due to the system relying upon and utilizing sensors which are processed by a controller which then operates devices (typically hydraulic cylinders) to adjust the height/tilt of the header, the response to changes in the height of the terrain may be somewhat delayed. Further, the header height control system 10 may not detect isolated objects, such as rocks or isolated areas of uneven ground in the path of agricultural apparatus 30 that may collide with skid shoe assembly 1200c and therefore may not adjust the height of header 12 to prevent or reduce the force of such collisions.

In the embodiment shown in FIGS. 14A-E, a rearward region/surface area of skid shoe 1202c may be in contact with the terrain surface 74 and at least in flex mode of operation, a portion of the weight of the header may be supported on the terrain surface 74 during normal use of the header on level ground. In this normal operational state, shock absorber device 1272c will be in a normal state of compression, as it is held in a substantially balanced amount of extension and compression between tab 1264c and washer 1276c. However, an upward change in the level of the terrain surface, or contact with an upstanding object, or another change in the contact position/height of the skid shoe 1202c, may result in an additional upward dynamic collision/impact force F_{col} (FIG. 14C) of limited time duration being imparted to skid shoe 1202. As described above, this collision/impact force Fc may cause additional resultant forces to be transferred though skid shoe linkage 1218c, due to the configuration of skid shoe linkage 1218c, to hydraulic cylinder 1226c which is urged (i.e., “pulled”) by an additional compression force F_{com} acting along the longitudinal axis hydraulic cylinder 1226c in the direction indicated by arrow 1290c in FIG. 14C. As a result of this additional compression force F_{com}, rod 1270c, sleeve 1273c, washers 1276c, 1280c and nuts 1276c, 1278c are also pulled in the same direction by the compression force F_{com}, causing compression and shortening of shock absorber device 1272c between tab 1264c and washer 1276c (i.e. additional compressive forces F_{com} are applied to opposite ends of shock absorber device 1272c by tab 1264c and washer 1276c to further compress shock absorber device 1272c).

As described above, shock absorber device 1272c may be configured to absorb/cushion at least a portion of the collision force Fool and absorbs/cushions the corresponding compression force F_{com} transmitted to shock absorber device 1272c with a reactive spring force that will increase during further compression to oppose the compression force F_{com}. Shock absorber device 1272c may at least in some embodiments also be configured to dampen the impact response resulting from the collision/impact force F_{col} and the resultant compression force F_{com} that is transmitted to shock absorber device 1272c, that acts over a limited interval of time, such that oscillations of the hydraulic cylinder 1226c may be avoided, lessened and/or dissipated.

By providing shock absorber device 1272c between tab 1264c and washer 1276c, shock absorber device 1272c may also serve to reduce the level of force transmission from tab 1264c to the main body of paddle 120″ and may serve at least to some extent as an isolator with respect to the forces resulting from collision forces F_{col}.

Once the collision/impact force Fc has terminated, then due to the resilient nature of shock absorber device 1272c, hydraulic cylinder 1226c, skid shoe linkage 1218c and skid shoe 1202c may return (or rebound) in the direction indicated by arrow 1292c to their original normal state positions and this rebound motion may be dampened by shock absorber device 1272c and/or by the inherent friction of the skid shoe linkage mechanism.

During longitudinal movement of hydraulic cylinder 1226c (and rod 1270c and sleeve 1272c) in directions 1290c, 1292c, interconnected pivot pin 1286c may slide within longitudinally oriented slot 1288c in mounting bracket 1260c (see FIG. 14D), which acts to guide and support hydraulic cylinder 1226c during longitudinal movement.

As a result of hydraulic cylinder 1226c being able to move in directions 1290c/1292c, an enhanced amount of mechanical compliance is provided to skid shoe linkage 1218c, that may reduce the effect of forces/stresses/vibrations within the skid shoe assembly 1200c, and may avoid premature wear or failure of components of skid shoe assembly 1200c, that might otherwise occur if the skid shoe linkage were substantially rigid.

In some embodiments, hydraulic cylinder 1226c may be moveable about/along its longitudinal axis in direction 1290c (and back in direction 1292c) over a distance of between about 1 inches and about 5 inches. It should be noted that due to the configuration/geometry of skid shoe linkage 1218c, a movement of 1 inch in direction 1290c of hydraulic cylinder 1226c may correspond to a vertical height movement of the terrain contact point of skid shoe 1202c of greater than one inch and may for example be in the range of about 0 inches (when fully retracted and shock absorber device 1226c is not active) to about 14 inches. Thus, shock absorbing assembly 1262c may accommodate a wide range of movement of skid shoe 1202c.

In other embodiments, shock absorber device 1272c may be a conventional (i.e. coiled metal) spring, a gas strut or a coil over shock absorber. Shock absorber device 1272c may be selected to give a desired spring rate, for example by selection of a particular durometer of a rubber spring or spring rate of a metal spring. It may not be necessary to “tune” the shock absorber device 1272c to a specific desired preload configuration-rather the component that is utilized for shock absorber device 1272c may be just specifically selected for its natural, unloaded state that is suitable for the application.

The shock absorbing assembly 1262c as described herein may also allow for convenient adjustment of the effective length of hydraulic cylinder 1226c without extending or retracting hydraulic cylinder 1226c. This assists in providing that all of the skid shoes assemblies of header 12 have the same retracted and extended height positions relative to the terrain surface (i.e. synchronized such that the distances D1 (Ret)/D2 (Ret) and D1 (Ext)/D2 (Ext) will be generally similar for all skid shoe assemblies of header 12 at the same time (see FIGS. 14B and 14C).

With reference to FIG. 14B, skid shoe assembly 1200c is shown in the second (fully retracted) position, whereby hydraulic cylinder 1226c is in the fully (or close to fully) extended position.

In this configuration, the hydraulic cylinder 1226c with piston rod 1404c fully extended has a length L_{H} and the portion of rod 1270c between the upper end of hydraulic cylinder 1226c and the forward face 1284c of tab 1246c has a length L_{R}, where a total length L_{T}=L_{H}+L_{T}.

The total length L_{T} may be adjusted by increasing or decreasing length L_{R}, i.e., the portion/length of rod 1270c between the upper end of hydraulic cylinder 1226c and the forward face 1284c of tab 1246c. This may be achieved through adjustment of nuts 1278c and 1274c (FIG. 14F).

It may be noted that mechanical and build imperfections in the components of the skid shoe assembly 1200c (and skid shoe assembly 1200b as referenced below) can be compensated for by making appropriate adjustments in the rod/bolt positions so that all skid shoes 1202 vertically deploy evenly.

As will be apparent, from a given starting position, changes to the total length L_{T} affected by changes to length L_{R} will affect (through skid shoe linage 1218c) the relative position of skid shoe 1202c. For example, with skid shoe 1202c in the fully retracted position shown in FIG. 14B, a decrease in total length L_{T} will cause extension of skid shoe 1202c thereby adjusting both distances D1 (RET) and D2 (RET). In another example, with skid shoe 1202c in the fully extended position shown in FIG. 14C, an increase in total length L_{T} will cause a degree of retraction of skid shoe 1202c thereby adjusting both of the distances D1 (EXT) and D2 (EXT). Therefore, it is possible to adjust the position of skid shoe 1202c when cylinder 1226c is fully retracted, fully extended or in any position therebetween without extending or retracting the piston rod 1404c of cylinder 1226c itself.

Whilst all of the skid shoe assemblies of header 12 may be manufactured using the same components (as described above), there may be slight variations between them, for example due to manufacturing tolerances or a degree of play in any of the linkages/connections. As a consequence, even though the hydraulic cylinders of all of the skid shoe assemblies that are configured in this manner may be retracted/extended to similar lengths, their position of their respective skid shoe (for example relative to cutter bar 122 or terrain surface 74) may vary across all of the skid shoes of header 12.

Through adjustment of total length L_{T} as described above, some or all of the skid shoe assemblies on header 12 may be “phased”, that is the position of their respective skid shoes may be adjusted such that they are in the same orientation relative to one another. This may be beneficial to ensure when the respective skid shoes of each skid shoe assembly are in contact with the terrain surface 74, spacing between the cutter bar 122 and terrain surface 74 will be generally even (i.e., the skid shoes will achieve the same or very similar vertical separation distances D1 and D2 described above).

In some embodiments, the total length L_{T} may be adjusted prior to operation of header 12, such that all of the skid shoes are “phased” in the same fully retracted position.

In operation, similar to skid shoe assembly 200c, skid shoe assembly 1200c is moveable from a fully retracted position (FIGS. 14A, 14B and 14D) to a fully extended position (FIG. 14C) as hydraulic cylinder 1226c is retracted from the fully extended position to the fully retracted position in a similar manner to as described above with respect to skid shoe assemblies 200c and 200f. Skid shoe assembly 1200c may be movable and positioned in a set position at any point between the fully retracted position and the fully extended position by operation of a hydraulic cylinder 1226c.

Skid shoe assembly 1200c may, in some embodiments be installed on any paddle 120 and cutter bar 122 (i.e., in place of any of skid shoe assemblies 200a, 200c, 200f, 200h in FIG. 12A), whereby each hydraulic cylinder 1226c is a part of the hydraulic fluid supply and control system 400 of FIGS. 11A to 11C as described above.

Skid shoe assembly 1200c may thus be configured and operate in substantially the same manner as skid shoe assemblies 200a and 200h including being mounted/directly connected to an end region cutter bar float paddle 120′ and to cutter bar 122.

With reference now to FIGS. 15A to 15F, a skid shoe assembly 1200b as installed on an intermediate cutter bar float paddle 120′″ is shown. Except as described herein, skid shoe assembly 1200b may be configured in a substantially similar manner as skid shoe assembly 200b or (skid shoe assemblies 200d, 200e and 200g) and may operate substantially the same as skid shoe assemblies 200b, 200d, 200e and 200g as described above, and in particular when cutter bar 122 is being operated in flex mode as described above. Skid shoe assembly 1200b may effectively be substituted for each of skid shoe assemblies 200b, 200d, 200e and 200g described above. It will be noted that each of skid shoe assemblies 200b, 200d, 200e and 200g incorporates an actuator such a two-way acting hydraulic cylinder 226, which when the pistons extend, the skid shoes extend; and when the pistons retract, the skid shoes retract. Skid shoe assembly 1200b operates in the same manner.

The rear end (hydraulic cylinder portion end) of hydraulic cylinder 1226b may be pivotally connected to a mounting bracket 1260b via a mechanism that may provide for an increased amount of mechanical compliance in the connections of the hydraulic cylinder 1226b to other components of the skid shoe assembly 1200b and paddle 120″. This mechanism may be a force mitigation/energy dissipation mechanism such as a shock absorbing assembly 1262b. Mounting bracket 1260b may be fixedly attached to a surface of paddle 120′″. Shock absorbing assembly 1262b may be operationally positioned between the main frame 100 and the terrain contact unit of said height adjustment apparatus. The shock absorbing assembly 1262b may be operationally positioned between at least part of the operational unit (such as paddle 120″) and the terrain contact unit of said height adjustment apparatus. Shock absorbing assembly 1262b may be operably disposed/located between the skid shoe 1202c and paddle 120″, and in particular shock absorbing assembly 1262b may be operationally and physically located between the hydraulic cylinder 1226b and the paddle 120′″ such that impact forces on skid shoes 1202b are cushioned upon transmission to hydraulic cylinder 1226b.

Skid shoe assembly 1200b may include a skid shoe 1202b (which may be like skid shoe 202b) that is pivotally directly attached beneath the lower front end of a cutter bar float paddle 120 to a rearwardly extending portion of cutter bar 122 with a hinge 1206b (FIGS. 15A-C) such that skid shoe 1202b may pivot about a generally transversely orientated pivot axis Xb (FIG. 15A) from the first (fully retracted) position to the second (fully extended) position (FIG. 15C).

Again, a representative cutter bar float paddle 120″ is illustrated which may together with other such cutter bar float paddles 120″, support a cutter bar and may be mounted to a vertical strut and/or a horizontal strut 116, in a manner as generally described above. Cutter bar float paddle 120″ may also be configured and operate in substantially the same way as cutter bar float paddles 120, 120;′ 120″ as described above. Skid shoe assembly 1200b may be installed on some or all respective cutter bar float paddle 120″, and may in some embodiments, be utilized in conjunction with alternate skid shoe assemblies 1200c as referenced above. Again, at least one cutter bar float gas bag, which may be a cutter bar float air bag 124″ may be supplied with pressurized gas/air, and mounted between a rearwardly generally vertically extending plate member 123″″ of each cutter bar float paddle 120′ and a front side, generally vertically extending mounting plate 129′″ of cutter bar float paddles 120″ Mounting plate 129′″ is part of a pivoting mounting bracket assembly, like bracket assembly 128′ described above.

Skid shoe assembly 1200b may include a skid shoe linkage 1218b—which may be substantially the same as skid shoe linkage 218b described above and actuated by a two-way acting hydraulic cylinder 1226b. Skid shoe linkage 1218b may include a bell crank 1222b and lower arms 1250b, 1254b and a linkage 1248b. Linkage 1248b may also include a linkage arm 1249b (FIG. 15D). A pivot pin 1242b may interconnect linkage 1248b and skid shoe linkage 1218b. Bell crank 1222b, linkage arm 1249b and lower arms 1250b, 1254b may generally be the same as and function like bell crank 222b, pivot pin 242b, linkage arm 249b and lower arms 250b, 254b described above.

The upper end 1223b of bell crank 1222b is pivotally connected to cutter bar float paddle 120 through pivot pin 1242b (FIG. 15C). Pivot pin 2142b may be retained for pivotal movement by a pair of brackets 1244, 1244′ secured to the upper surface of cutter bar float paddle 120. The opposite end of pivot pin 1242b may extend through bracket 1244′ and be received in an upper opening of linkage arm 1249b (FIG. 15D) which is on the opposite transverse side of paddle 120 to bell crank 1222b. Thus, linkage arm 1249b and bell crank 1222b may be fixedly connected to pivot pin 1242b and may pivot together about the longitudinal axis (in a transverse direction) of pivot pin 1242b.

With reference to FIG. 15C, the lower end 1225b of bell crank 1222b is also pivotally connected to the upper end of lower arm 1250b through pivotal connection 1235b. Similarly, the lower end 1252b of linkage arm 1249b is also pivotally connected to the upper end of lower arm 1254b through pivotal connection 1236b (FIG. 15D)

The lower ends of lower arms 1250b and 1254b are each pivotally connected to skid shoe 1202b through a transversely extending pivot pin 1238b, which is received in brackets 1257b, 1259b, 1261b (FIGS. 15A and 15D). Brackets 1257b, 1259b, 1261b are in turn secured to base plate 1204b of skid shoe 1202b, such as by welding.

As a result of the orientation of skid shoe linkage 1218b, and orientation of movement of piston rod 1404b of hydraulic cylinder 1226b, when skid shoe assembly 1200b is in the fully retracted position (as shown in FIG. 15A), hydraulic cylinder 1226b is in the fully retracted position; and when skid shoe assembly 1200b is in the fully extended position, hydraulic cylinder 1226b is in the fully extended position (FIG. 15C).

The rear end (hydraulic cylinder portion end) of hydraulic cylinder 1226b may be pivotally connected to a mounting bracket 1260b via a shock absorbing assembly 1262b, which is illustrated in more detail in FIGS. 15E-G. Mounting bracket 1260b is fixedly attached to a surface of paddle 120″. Shock absorbing assembly 1262b is operably disposed/located between the skid shoe 1202b and the paddle 120″, and in particular is operably disposed/located between the hydraulic cylinder 1226b and the paddle 120″.

Shock absorbing assembly 1262b may operate in a functional manner like shock absorbing assembly 1262c but be configured to operate in an opposite direction-given that skid shoe assembly 1200b is arranged to function in a manner that is opposite to skid shoe assembly 1200c in relation to the extension/retraction arrangement of the hydraulic cylinder 1226b and skid shoe 1202b. Shock absorbing assembly 1262b may include a force mitigation/energy dissipation device, which may be a shock absorber device 1272b (like shock absorber device 1272c described above). This force mitigation/energy dissipation device may likewise be operable to one or more of, isolate, absorb, cushion, and dampen at least some of the static and particularly dynamic forces that are being transferred/transmitted from corresponding skid shoes 1202b to the components of the skid shoe assemblies 1200b, including their respective hydraulic cylinders 1226b.

Shock absorbing assembly 1262b may also include a mounting bracket 1260b fixedly mounted to paddle 120″ (which in interconnected to horizontal strut 116 of main frame 100 of header 12) with a transversely projecting tab/flange 1264c having an opening 1266b (FIG. 15G) extending therethrough which is generally longitudinally aligned with hydraulic cylinder 1226b (FIG. 15F). Bracket 1260b pivots with paddle 120″ about the paddle pivot axis X1 (FIG. 15E).

Similar to hydraulic cylinder 1226c described above, at the rear end of hydraulic cylinder 1226b is a cylinder connecting lug 1239b (FIG. 15E) which is pivotally connected to a connector block 1268b at a forward end of a rod 1270b via a pivot pin 1286b (which is configured to pivot within a sleeve 1287b shown in FIG. 15G) such that hydraulic cylinder 1226b can pivot at its rear end relative to rod 1270b about the transverse axis Xd of pivot pin 1286b (FIG. 15E).

With reference to FIGS. 15D and 15G, pivot pin 1286b, which extends through connecting lug 1239b, connector block 1268b and sleeve 1287b, also extends through a longitudinally extending slot 1288b in mounting bracket 1260b and is secured by nut 1289b and washer 1291b. As will be explained in more detail below, slot 1288b may function to guide longitudinal movement of hydraulic cylinder 1226b and rod 1270b.

Still with reference to FIGS. 15F and 15G, a bushing 1271b is received within opening 1266b in tab/flange 1264b and a sleeve 1273b is partially received within bushing 1271b and extends in a rearwardly direction from bushing 1271b. Rod 1270b also extends in a rearwardly direction through sleeve 1273b. Shock absorber device 1272b (which may be like or the same as shock absorber device 1272c) may be received on and over sleeve 1273b at the front face 1284b of tab 1264b (FIG. 15F).

Rod 1270b, sleeve 1273b and bushing 1271c may have similar sizes and dimensions and be made from similar materials to rod 1270c, sleeve 1273c and bushing 1271c described above with respect to skid shoe assembly 1200c.

Sleeve 1273b and shock absorber device 1272b may be retained in place on rod 1270b by nut 1278b (which engages on a threaded portion of rod 1270b) and a washer 1280b, which engages the front-end surface area of shock absorber device 1272b. Received on rod 1270b at the rear face 1282b of tab 1264b are nut 1274b (which engages a threaded portion of rod 1270b) and washer 1276b, which engages face 1286b of tab 1264b. Thus, sleeve 1273b is sandwiched between washers 1276b and 1280b and shock absorber device 1272b is sandwiched between the forward face 1284b of tab 1264b and washer 1280b. Washers 1276b and 1280b are retained in position on rod 1270b by nuts 1274b and 1278b. Thus, rod 1270b, sleeve 1273b, washers 1276b, 1280b and nuts 1276b, 1278b form a single unit/unified assembly that is slidably moveable in a longitudinal direction within bushing 1271b.

Longitudinal movement of rod 1270b in the direction indicated by arrow 1292b in FIG. 15F, which is accompanied by longitudinal movement of sleeve 1273b, washers 1276b, 1280b and nuts 1276b, 1278b in the same direction causes compression of shock absorber device 1272b between the forward face 1284b of tab 1264b and washer 1280b. Shock absorber device 1272b may operate in a manner that is the same or similar to shock absorber device 1272c described above. This elastic/resilient deformation of shock absorber device 1272b can absorb/cushion the forces being transmitted to the hydraulic cylinder 1226b. Shock absorber device 1272b may be configured to elastically and or resiliently deform to absorb compressive forces resulting from collisions with skid shoes 1202b and may also dampen the applied dynamic compressive forces during operation of header 12.

As described above, during operation of agricultural apparatus 30, in flex mode, as header 12 moves across terrain surface 74, of the skid shoes of agricultural apparatus 30 with uneven portions of terrain surface 74, may result in a generally upwardly directed collision force F_{col} (FIG. 15C), that is imparted to skid shoe 1202b. The collision force F_{col} is transferred through skid shoe linkage 1218b to hydraulic cylinder 1226b, urging hydraulic cylinder 1226b in direction 1292b (FIG. 15F).

In the embodiment shown in FIGS. 15A-E, as a result of the orientation of skid shoe linkage 1218b as a dynamic collision force F_{col} (FIG. 15C) is imparted to skid shoe 1202b and is transferred though skid shoe linkage 1218c, hydraulic cylinder 1226b is urged (i.e., “pushed”) along its longitudinal axis in the direction indicated by arrow 1292b in FIG. 15C. As a result of this, rod 1270b, sleeve 1273b, washers 1276b, 1280b and nuts 1276b, 1278b are also pushed in the same direction, causing compression of shock absorber device 1272b between rearward tab 1264b and forward washer 1280b (i.e., a dynamic compressive force is applied to shock absorber device 1272b). Shock absorber device 1272b is able to absorb and also dampen at least a portion of the collision force F_{col} transmitted to shock absorber device 1272b. Once the collision force Fool decreases and then terminates, due to the resilient nature of shock absorber device 1272b, hydraulic cylinder 1226b, skid shoe linkage 1218b and skid shoe 1202b may return (or rebound) in the direction indicated by arrow 1290b to their original positions.

Similar to skid shoe assembly 1200c described above, during longitudinal movement of hydraulic cylinder 1226b (and rod 1270b and sleeve 1272b) in directions 1290b, 1292b, interconnected pivot pin 1286b may slide within slot 1288b in mounting bracket 1260b, which acts to guide and support hydraulic cylinder 1226b during longitudinal movement.

Also, like that described above with respect to skid shoe assembly 1200c, skid shoe assembly 1200b may have a shock absorbing assembly 1262b that may also allow for convenient adjustment of the effective length of hydraulic cylinder 1226b without extending or retracting hydraulic cylinder 1226b, through adjustment of total length L_{T} as described above.

In operation, similar to skid shoe assembly 200b, skid shoe assembly 1200b is moveable from the fully retracted position (FIGS. 15A, 15B and 15D) to the fully extended position (FIG. 15C) as hydraulic cylinder 1226b is extended from its fully retracted position to the fully extended position. Skid shoe assembly 1200b may be movable and positioned in a set position between a fully retracted position and a fully extended position by operation of a hydraulic cylinder 1226b.

Skid shoe assembly 1200c may be installed on an intermediate paddle 120 and cutter bar 122 (i.e., in place of any of skid shoe assemblies 200b to 200g in FIG. 12A), whereby hydraulic cylinder 1226c is a part of the control system of FIGS. 11A to 11C as described above.

Similar to skid shoe assemblies 200a-h described above, skid shoe assemblies 1200b and 1200c may be movable and positioned in a set position between a fully retracted position and a fully extended position by operation of the respective hydraulic cylinders 1226b, 1226c) and may be able to achieve the same maximum height adjustment difference between the vertical distance D1 (Ext) when skid shoe assemblies 1200b and 1200c are in the fully extended position, and the vertical distance D1 (Ret) when skid shoe assemblies 1200b and 1200c are in the fully retracted position. This provides a corresponding same maximum height adjustment distance D2 (Ext) minus D2 (Ret) of the cutter bar 122 in the vicinity of skid shoe skid shoe assemblies 1200b and 1200c. Again, assuming terrain surface 74 is flat and level, this also provides that any adjustment in the vertical height D1 will result in a similar amount of height adjustment in the cutter bar vertical separation distance/height D2 beneath the cutter bar 122 in the vicinity of skid shoe of skid shoe assemblies 1200b and 1200c.

Skid shoe assemblies 1200b and 1200c may have respective skid shoes 1202b, 1202c that are pivotable about a similar range of pivot angles e to those pivot angles described above in relation to skid shoe assemblies 200a to 200h in order to achieve the same separation distances D1 and D2.

It will be appreciated, that like skid shoe assemblies 200a to 200h, skid shoe assemblies 1200b and 1200c can be moved to a set position at any position between the fully retracted positions and the fully extended positions, as may be determined by an operator.

Skid shoe assemblies 200a-h, 1200b and 1200c may be arranged on main frame 100 in any suitable arrangement.

It may also be noted that skid shoe assembles 200a-h, 1200b and 1200c may be used to extend the height adjustment apparatuses to extend the vertical position of the skid shoes as described above, when in a flex mode of operation. In a rigid mode of operation, skid shoe assembles 200a-h, 1200b and 1200c do not typically use height adjustment apparatuses to extend the height adjustment apparatuses and instead the skid shoes are in fully retracted positions. In the fully retracted positions, the skid shoes may be mechanically “bottomed out” and incapable of any further compressive movement. Thus, with respect to skid shoe assembles 1200b and 1200c, the shock absorber devices 1272b, 1272c of shock absorbing assemblies 1262b, 1262c may not be able to be activated/utilized since the shock absorber devices 1272b, 1272c cannot be further compressed.

While specific embodiments of the invention have been described and illustrated, such embodiments should be considered illustrative of the invention only and not as limiting the invention as construed in accordance with the accompanying claims. The above-described embodiments are intended to be illustrative only and in no way limiting. The described embodiments of carrying out the invention are susceptible to many modifications of form, arrangement of parts, details and order of operation. Other variations are possible.

When introducing elements of the present invention or the embodiments thereof, the articles “a,” “an,” “the,” and “the” are intended to mean that there are one or more of the elements. The terms “comprising,” “including,” and “having” are intended to be inclusive and mean that there may be additional elements other than the listed elements.

1. An agricultural apparatus comprising an agricultural implement, said agricultural implement comprising:
(i) a main frame;
(ii) an operational unit interconnected to said main frame;
(iii) a height adjustment apparatus interconnected to said main frame and said operational unit, said height adjustment apparatus comprising at least one terrain contact element, said at least one terrain contact element operable to be positioned to contact a terrain surface level at a terrain contact element contact region such that said at least one terrain contact element supports said operational unit at a vertical separation distance of the operational unit above the terrain surface, said height adjustment apparatus being operable to adjust the vertical separation distance of said operational unit above the terrain surface;
(iv) a shock absorbing assembly operationally positioned between said main frame and said at least one terrain contact element, said shock absorbing assembly operable to provide for resilient deformation in response to forces transmitted during operation to said at least one terrain contact element, from contact of said at least one terrain contact element with the terrain surface.

2. The agricultural apparatus as claimed in claim 1, wherein the shock absorbing assembly is capable of absorbing and/or cushioning dynamic forces imparted to at least one component of said height adjustment apparatus that result from forces transmitted during operation to said at least one terrain contact element.

3. The agricultural apparatus as claimed in claim 1 or 2, further comprising a unit support apparatus configured to interconnect said operational unit to said main frame, wherein said shock absorbing assembly is operationally positioned between said unit support apparatus and said at least one terrain contact element.

4. The apparatus as claimed in claim 3, wherein said unit support apparatus comprises at least one, longitudinally extending, paddle, which is pivotally interconnected to said main frame, and wherein said at least one terrain contact element is at least partially mounted on said at least one paddle; and wherein said shock absorbing assembly is operationally located between said at least one paddle and said at least one terrain contact element.

5. The apparatus as claimed in claim 4, wherein said height adjustment apparatus further comprises a linkage connected to said at least terrain contact element, said linkage being operable to facilitate upwards and downwards movement of the terrain engaging element relative to said at least one paddle, wherein said shock absorbing assembly is operationally positioned between said linkage and said at least one paddle.

6. The apparatus as claimed in claim 5, wherein said height adjustment apparatus further comprises an actuator operably positioned between said linkage and said at least one paddle, said actuator operable to actuate the linkage to adjust the vertical position of said terrain engaging element, and thereby in operation adjust the vertical separation distance between said operational unit and the terrain surface beneath operational unit; and wherein said shock absorbing assembly is operationally located between said actuator and at least one paddle.

7. The apparatus as claimed in claim 6, wherein the actuator is directly connected to the shock absorbing assembly.

8. The apparatus as claimed in claim 6, wherein said actuator comprises a two-way acting hydraulic fluid cylinder having an extendible and retractable piston rod, which in operation the extension and retraction of which is controlled by a hydraulic fluid control and supply system.

9. The apparatus as claimed in claim 8, wherein the piston rod is connected to the linkage.

10. The apparatus as claimed in claim 9, wherein the hydraulic cylinder has a connecting lug at an opposite end to said piston rod, and wherein the connecting lug is connected to the shock absorbing assembly, and wherein the shock absorbing assembly is connected to the at least one paddle.

11. The apparatus as claimed in any one of claims 5 to 10, wherein said at least one component of said height adjustment apparatus comprises said actuator.

12. The apparatus as claimed in claim 11, wherein the shock absorbing assembly comprises a shock absorber device, operationally located between the hydraulic cylinder and the at least one paddle.

13. The apparatus as claimed in claim 12, wherein the shock absorbing assembly further comprises a shock absorbing rod interconnected to said connecting lug of said hydraulic cylinder, and wherein said rod extends generally longitudinally generally in alignment with a longitudinal axis of said hydraulic cylinder.

14. The apparatus as claimed in claim 13, wherein the at least one paddle comprises a flange with an opening, and wherein the shock absorbing rod extends through said opening, and wherein the shock absorber device is mounted on said rod and held between (i) said flange and (ii) a retention member, wherein in operation when wherein said forces transmitted to said height adjustment apparatus from contact of said at least one terrain contact element with the terrain surface, said linkage causes movement of said hydraulic cylinder and said shock absorbing rod, to cause said rubber spring to be compressed between said flange and said retention member, to thereby to at least one of cushion, absorb and dampen forces transmitted to said hydraulic cylinder via said linkage.

15. The apparatus as claimed in claim 14, wherein the shock absorber device comprises a rubber spring device.

16. The apparatus as claimed in claim 15, wherein the rubber spring device has a central longitudinally extending opening receiving said shock absorbing rod therethrough.

17. The apparatus as claimed in any one of claims 1 to 16, wherein said shock absorbing assembly is operable to at least one of cushion, absorb and dampen generally upwardly directed dynamic forces transmitted, in operation, to said at least one component of said height adjustment apparatus resulting from contact of said at least one terrain contact element with the terrain surface.

18. The apparatus as claimed in any one of claims 1 to 17, wherein in operation, said shock absorbing assembly behaves like a spring in response to dynamic forces transmitted to said at least one terrain contact element from contact of said at least one terrain contact element with the terrain surface.

19. The apparatus as claimed in any one of claims 1 to 18, wherein during operation, the operational unit is configured in a flexible mode relative to said main frame and said terrain surface, such that said terrain contact unit moves relative to said main frame to follow the terrain surface.

20. The apparatus as claimed in claim 1, wherein the shock absorbing assembly comprises a shock absorber device, located between the at least one terrain contact element and the main frame.

21. The apparatus as claimed in any one of claims 1 to 20, wherein the main frame is generally transversely extending, and the operational unit is generally transversely extending.

22. The apparatus as claimed in claim 2, wherein the unit support apparatus has a weight and the operational unit has a weight, and wherein during operation in a flex mode of operation, the terrain surface supports a portion of the weight of the operational unit and a portion of the weight of the unit support apparatus.

23. The apparatus as claimed in claim 2, during operation in a flex mode of operation, the unit support apparatus supports a portion of the weight of the operational unit.

24. The apparatus as claimed in claim 22 or 23, wherein in said flex mode of operation, the unit support apparatus facilitates the operational unit to move upwards and downwards relative to the main frame.

25. The apparatus as claimed in claim 22, 23 or 24, wherein in said flex mode of operation, a portion of the weight of the operational unit and a portion of the weight of the unit support apparatus is supported with a spring device operationally interconnected to the unit support apparatus.

26. The apparatus as claimed in claim 6, wherein during the upwards and downwards movement of the operational unit relative to the main frame, the spring device provides a counter-acting force to counter-act a portion of the weight of the operational unit and a portion of the weight of the unit support apparatus.

27. The apparatus as claimed in claim 26, wherein during a range of upwards and downwards movement of the operational unit relative to the main frame, the spring device provides a substantially constant counter-acting force to counter a portion of the weight of the operational unit and a portion of the weight of the unit support apparatus.

28. The apparatus as claimed in any one of claims 1 to 27, wherein:
said operational unit comprises a transversely extending cutter bar, and said cutter bar comprising a plurality of cutting devices disposed transversely along said cutter bar and operable for cutting crop material;
said operational unit comprises a cutter bar support apparatus configured to interconnect said transversely extending cutter bar to said main frame and permit upward and downward movement of said cutter bar relative to said main frame; and
said height adjustment apparatus is operable to adjust the magnitude of the vertical separation distance between the cutter bar support apparatus and the terrain surface and thereby adjust the vertical separation distance between the cutter bar and the terrain surface.

29. An apparatus as claimed in claim 28, wherein:
said cutter bar support apparatus is configured and operable to permit for upwards and downwards movement of said cutter bar relative to said main frame during operation of said agricultural apparatus when cutting a crop material.

30. An apparatus as claimed in claim 29, further comprising a propulsion unit operable to support said main frame of said implement, and wherein:
during operation of said agricultural apparatus in cutting crop material such that said propulsion unit and said agricultural implement move over said terrain surface, said at least one terrain contact element of said height adjustment apparatus is configured and operable for upwards and downwards movement relative to said main frame in synchronized upwards and downwards movement with said cutter bar.

31. An apparatus as claimed in any one of claims 1 to 30, wherein:
said height adjustment apparatus is operable to adjust the height of the said at least one terrain contact element of the height adjustment apparatus such that said at least one terrain contact element of the height adjustment apparatus establishes a minimum cutter bar separation distance extending between said cutter bar and the terrain surface beneath the cutter bar.

32. The apparatus as claimed in claim 28, wherein said terrain element contact region of said at least one terrain contact element of said height adjustment apparatus is located longitudinally proximate to said cutter bar.

33. An apparatus as claimed in claim 32 wherein said terrain element contact region of said at least one terrain contact element of said height adjustment apparatus is located longitudinally behind said cutter bar.

34. The apparatus as claimed in claim 2, wherein: said unit support apparatus comprises a plurality of transversely spaced, longitudinally oriented paddles, each of said paddles being rigidly interconnected to said transversely extending cutter bar proximate a forward end region of each of said paddles and pivotally interconnected to said main frame proximate an inward end region of each of said paddles; and wherein said height adjustment apparatus comprises a plurality of terrain contact assemblies each of said terrain contact assemblies mounted to one of a plurality of paddles and each of said terrain contact assemblies having a terrain contact element, the terrain contact element of each of said plurality of terrain contact assemblies being transversely spaced and being interconnected to a respective one of said plurality of paddles, and each of the terrain contact elements of said plurality of terrain contact assemblies operable to be positioned by said height adjustment apparatus at a level below said operational unit at transversely spaced locations, such that each terrain contact element of said plurality of terrain contact elements can be positioned to contact the terrain surface at a level beneath the operational unit;
wherein said agricultural apparatus further comprises a plurality of shock absorbing assemblies, each operationally positioned between said main frame and one of the at least one terrain contact elements of said height adjustment apparatus, each said shock absorbing assembly being capable of at least one of cushioning, absorbing and dampening forces transmitted to at least one component of each of said plurality of height adjustment apparatuses;
wherein, during operation, each of said plurality of shock absorbing assemblies is capable of at least one of cushioning, absorbing and dampening forces transmitted to at least one component of the height adjustment apparatus resulting from contact of a respective at least one terrain contact element with the terrain surface.

35. The apparatus as claimed in claim 34, wherein each of said plurality terrain contact elements is pivotally connected to said operational unit.

36. An apparatus as claimed in claim 35, wherein said height adjustment apparatus comprises a plurality of linkages, and wherein each linkage of said plurality of linkages is mounted to a respective one of said paddles, each said linkage of said plurality of linkages is operable to support and facilitate upwards and downwards movement of each terrain engaging element relative to its respective said paddle, and wherein said height adjustment apparatus further comprises a plurality of actuators, an actuator of each of said plurality of actuators being operably interconnected to each linkage and said terrain engaging element, each said actuator operable to adjust the vertical position of each respective terrain engaging element, to adjust the vertical separation distance between said operational unit and the terrain surface beneath operational unit.

37. An apparatus as claimed in claim 36, wherein each of said actuators is a hydraulic fluid cylinder, which in operation is controlled by a hydraulic fluid control and supply system.

38. The apparatus as claimed in claim 37, wherein each of said plurality of shock absorbing assemblies, is operationally positioned between said main frame and one of the hydraulic fluid cylinders.

39. The apparatus as claimed in claim 1, 2 or 3, further comprising a propulsion unit, and wherein said implement and said propulsion unit are configured and operable for upwards and downwards movement of said main frame of said implement relative to said propulsion unit.

40. The apparatus as claimed in claim 39, further comprising a frame height positioning system operable to control and adjust the height of said main frame relative to said propulsion unit.

41. The apparatus as claimed in claim 40, further comprising a sensor system operable to provide signals to the frame height positioning system indicative of the height of the operational unit above the terrain surface.

42. The apparatus as claimed in claim 4, wherein said operational unit is a transversely extending cutter bar and said unit support apparatus comprises a plurality of transversely spaced, longitudinally oriented paddles, each of said paddles being rigidly interconnected to said transversely extending cutter bar proximate a forward end region of each of said paddles and pivotally interconnected to said main frame proximate an inward end region of each of said paddles.

43. An agricultural apparatus comprising:
(a) a propulsion unit;
(b) an implement interconnected to said propulsion unit, said implement comprising:
(i) a main frame having a main frame weight, said propulsion unit configured and operable to support at least a portion of said main frame weight;
(ii) an operational unit interconnected to said main frame;
(iii) at least one terrain contact element operable to contact the terrain surface level at a terrain contact element contact region such that said at least one terrain contact element supports said operational unit at a vertical separation distance of the operational unit above the terrain surface;
(iv) a shock absorbing assembly located between said main frame and said at least one terrain contact element, said shock absorbing assembly operable to resiliently deform in response to forces transmitted to said at least one terrain contact element from contact of said at least one terrain contact element with the terrain surface.

44. An agricultural apparatus comprising:
(a) a propulsion unit;
(b) an implement interconnected to said propulsion unit, said implement comprising:
(v) a main frame having a main frame weight, said propulsion unit configured and operable to support at least a portion of said main frame weight;
(vi) an operational unit interconnected to said main frame;
(vii) a skid shoe assembly comprising at least one skid shoe which is operable to contact the terrain surface level at skid shoe contact region such that said at least one skid shoe supports said operational unit at a vertical separation distance of the operational unit above the terrain surface;
(viii) a force absorbing assembly operationally located between said main frame and said at least one skid shoe, said shock absorbing assembly operable to provide for resilient and/or elastic deformation of at least one component of said shock absorbing assembly in response to forces transmitted to said at least one skid shoe from contact of said at least one skid shoe with the terrain surface, to thereby cushion and/or absorb the resultant forces transmitted to at least one component of said skid shoe assembly.

45. The apparatus as claimed in claim 44 wherein the at least one component of said skid shoe assembly is an actuator operable to adjust the vertical separation of a contact region of the skid shoe with the terrain surface, and the operational unit.

46. An apparatus as claimed in claim 45, wherein said actuator is a hydraulic fluid cylinder, which in operation is controlled by a hydraulic fluid control and supply system.

47. An agricultural apparatus, comprising an agricultural implement, said agricultural implement comprising:
(i) a transversely extending main frame;
(ii) an operational unit interconnected to said main frame;
(iii) a height adjustment apparatus interconnected to said main frame and said operational unit, said height adjustment apparatus comprising at least one terrain contact element, said at least one terrain contact element operable to be positioned to contact a terrain surface level at a terrain contact element contact region such that said at least one terrain contact element supports said operational unit at a vertical separation distance of the operational unit above the terrain surface, said height adjustment apparatus being operable to adjust the vertical separation distance of said operational unit above the terrain surface;
(iv) a shock absorbing assembly operationally positioned between said main frame and the terrain contact unit of said height adjustment apparatus, said shock absorbing assembly being capable of at least one of cushioning, absorbing and dampening forces transmitted to at least one component of said height adjustment apparatus;
wherein, during operation, said shock absorbing assembly at least one of cushions, absorbs and dampens forces transmitted to at least one component of said height adjustment apparatus resulting from contact of said at least one terrain contact element with the terrain surface.

48. The apparatus as claimed in claim 47 wherein the at least one component of said skid shoe assembly is an actuator operable to adjust the vertical separation of a contact region of the at least one terrain contact element with the terrain surface, and the operational unit.

49. An apparatus as claimed in claim 45, wherein said actuator is a hydraulic fluid cylinder, which in operation is controlled by a hydraulic fluid control and supply system.

50. An agricultural apparatus comprising:
(a) a propulsion unit;
(b) an implement connected to said propulsion unit, said implement comprising:
(i) a main frame having a main frame weight, said propulsion unit configured and operable to support at least a portion of said main frame weight;
(ii) an operational unit;
(iii) a unit support apparatus configured to interconnect said operational unit to said main frame,
(iv) a height adjustment apparatus comprising at least one terrain contact element, said height adjustment apparatus connected to said unit support apparatus, said at least one terrain contact element operable to be positioned to contact the terrain surface level at a terrain contact element contact region such that said at least one terrain contact element supports the unit support apparatus at a vertical separation distance of the unit support apparatus above the terrain surface, said height adjustment apparatus being operable to adjust the vertical separation distance of the unit support apparatus above the terrain surface, and thereby adjust the position of the operational unit to adjust a vertical separation distance of the operational unit above the terrain surface.

51. An apparatus as claimed in claim 50, wherein the main frame is generally transversely extending, and the operational unit is generally transversely extending.

52. An apparatus as claimed in claim 50 or 51 wherein the unit support apparatus has a weight and the operational unit has a weight, and wherein during operation in a flex mode of operation, the terrain surface supports a portion of the weight of the operational unit and a portion of the weight of the unit support apparatus.

53. An apparatus as claimed in claim 50, 51 or 52 wherein during operation in a flex mode of operation, the unit support apparatus supports a portion of the weight of the operational unit.

54. An apparatus as claimed in claim 52 or 53, wherein in said flex mode of operation, the unit support apparatus facilitates the operational unit to move upwards and downwards relative to the main frame.

55. An apparatus as claimed in claim 52, 53, or 54, wherein in said flex mode of operation, a portion of the weight of the operational unit and a portion of the weight of the unit support apparatus is supported with a spring device operationally interconnected to the unit support apparatus.

56. An apparatus as claimed in claim 55, wherein during the upwards and downwards movement of the operational unit relative to the main frame, the spring device provides a counter-acting force to counter-act a portion of the weight of the operational unit and a portion of the weight of the unit support apparatus.

57. An apparatus as claimed in claim 56, wherein during a range of upwards and downwards movement of the operational unit relative to the main frame, the spring device provides a substantially constant counter-acting force to counter a portion of the weight of the operational unit and a portion of the weight of the unit support apparatus.

58. An apparatus as claimed in any one of claims 50 to 57, wherein the operational unit has an operational unit terrain contact region, and wherein said height adjustment apparatus is operable to adjust the vertical separation distance of the unit support apparatus above the terrain surface, and thereby adjust the position of the operational unit to adjust a vertical separation distance between the operational unit terrain contact region of the operational unit and the terrain surface.

59. An apparatus as claimed in any one of claims 50 to 58, wherein:
said operational unit comprises a transversely extending cutter bar, and said cutter bar comprising a plurality of cutting devices disposed transversely along said cutter bar and operable for cutting crop material;
said unit support apparatus comprises a cutter bar support apparatus configured to interconnect said transversely extending cutter bar to said main frame and permit upward and downward movement of said cutter bar relative to said main frame; and
said height adjustment apparatus is operable to adjust the magnitude of the vertical separation distance between the cutter bar support apparatus and the terrain surface and thereby adjust the vertical separation distance between the cutter bar and the terrain surface.

60. An apparatus as claimed in claim 59, wherein:
said cutter bar support apparatus is configured and operable to permit for upwards and downwards movement of said cutter bar relative to said main frame during operation of said agricultural apparatus when cutting a crop material.

61. An apparatus as claimed in claim 60, wherein:
during operation of said agricultural apparatus in cutting crop material such that said propulsion unit and said agricultural implement move over said terrain surface, said at least one terrain contact element of said height adjustment apparatus is configured and operable for upwards and downwards movement relative to said main frame in synchronized upwards and downwards movement with said cutter bar.

62. An apparatus as claimed in any one of claims 50 to 61, wherein:
said height adjustment apparatus is operable to adjust the height of the said terrain contact element of the height adjustment apparatus such that said terrain contact element of the height adjustment apparatus establishes a minimum cutter bar separation distance extending between said cutter bar and the terrain surface beneath the cutter bar.

63. An apparatus as claimed in any one of claims 50 to 62, wherein said terrain element contact region of said at least one terrain contact element of said height adjustment apparatus is located longitudinally proximate to said cutter bar.

64. An apparatus as claimed in claim 63 wherein said terrain element contact region of said at least one terrain contact element of said height adjustment apparatus is located longitudinally behind said cutter bar.

65. An apparatus as claimed in any one of claims 50 to 64, wherein:
said unit support apparatus comprises a plurality of transversely spaced, longitudinally oriented paddles, each of said paddles being rigidly interconnected to said transversely extending cutter bar proximate a forward end region of each of said paddles and pivotally interconnected to said main frame proximate an inward end region of each of said paddles.

66. An apparatus as claimed in claim 65, wherein:
said height adjustment apparatus comprises a plurality of terrain contact assemblies each of said terrain contact assemblies mounted to one of said paddles and each of said terrain contact assemblies having a terrain contact element, the terrain contact element of each of said plurality of terrain contact assemblies being transversely spaced and being interconnected to a respective one of said plurality of paddles, and each of the terrain contact elements of said plurality of terrain contact assemblies operable to be positioned by said height adjustment apparatus at a level below said cutter bar at transversely spaced locations, such that each terrain contact element of said plurality of terrain contact elements can be positioned to contact the terrain surface at a level beneath the cutter bar.

67. An apparatus as claimed in claim 66, wherein said height adjustment apparatus is operable to set the position of each of said plurality of terrain engaging elements below the cutter bar at transversely spaced locations, to establish a minimum cutter bar separation distance extending between said cutter bar and the terrain surface beneath the cutter bar across substantially the entire transverse width of the cutter bar.

68. An apparatus as claimed in any one of claims 50 to 67, wherein said unit support apparatus is pivotally connected to said main frame and fixedly connected to said operational unit.

69. An apparatus as claimed in claim 50, wherein said unit support apparatus comprises a plurality of transversely spaced and longitudinally extending paddles which are pivotally interconnected to said main frame, and wherein said at least one terrain contact element comprises a plurality of terrain contact elements, and wherein each of said plurality of terrain contact elements is at least partially mounted on a paddle of said plurality of paddles.

70. An apparatus as claimed in claim 69 wherein each terrain contact element of said plurality of terrain contact elements is at least partially mounted on said operational unit.

71. An apparatus as claimed in claim 69 or 70, wherein said plurality of terrain contact elements are transversely spaced across said operational unit.

72. An apparatus as claimed in any one of claims 69 to 71 wherein each of said plurality terrain contact elements is pivotally connected to said operational unit.

73. An apparatus as claimed in claim 72, wherein said height adjustment apparatus comprises a plurality of linkages, and wherein each linkage of said plurality of linkages is mounted to a respective one of said paddles, each said linkage of said plurality of linkages is operable to support and facilitate upwards and downwards movement of each terrain engaging element relative to its respective said paddle, and wherein said height adjustment apparatus further comprises a plurality of actuators, an actuator of each of said plurality of actuators being operably interconnected to each linkage and said terrain engaging element, each said actuator operable to adjust the vertical position of each respective terrain engaging element, to adjust the vertical separation distance between said operational unit and the terrain surface beneath operational unit.

74. An apparatus as claimed in claim 73, wherein each of said actuators is a hydraulic fluid cylinder that forms part of a height adjustment hydraulic fluid control and supply system.

75. An apparatus as claimed in claim 74, wherein said height adjustment hydraulic fluid control and supply system circuit is fluidly interconnected to a bi-directional hydraulic fluid circuit of said propulsion unit and said implement.

76. An apparatus as claimed in claim 75, wherein said bi-directional hydraulic fluid circuit of said propulsion unit and said implement comprises a hydraulic fluid supply and control system operable to move a reel of said agricultural apparatus in a forward direction and an aft direction.

77. An apparatus as claimed in any one of claims 50 to 76, wherein said implement and said propulsion unit are configured and operable for upwards and downwards movement of said main frame of said implement relative to said propulsion unit.

78. An apparatus as claimed in claim 77, further comprising a frame height positioning system operable to control and adjust the height of said main frame relative to said propulsion unit.

79. An apparatus as claimed in claim 78, further comprising a sensor system operable to provide signals to the frame height positioning system indicative of the height of the operational unit above the terrain surface.

80. An apparatus as claimed in claim 79, wherein said operational unit is a transversely extending cutter bar and said unit support apparatus comprises a plurality of transversely spaced, longitudinally oriented paddles, each of said paddles being rigidly interconnected to said transversely extending cutter bar proximate a forward end region of each of said paddles and pivotally interconnected to said main frame proximate an inward end region of each of said paddles; and wherein said sensor signals are dependent upon the pivot angle of the paddles relative to a component of the main frame.

81. An apparatus as claimed in claim 79 or 80, wherein said frame height positioning system is calibrated using said sensor system.

82. An apparatus as claimed in claim 79, 80, or 81, wherein a height set point is established by said frame height positioning system and the frame height positioning system is operable to adjust the height of the main frame relative to the propulsion unit to seek the height set point.

83. An apparatus as claimed in claim 82, wherein operation of said height adjustment apparatus does not influence the frame height positioning system in operating to seek the height set point.

84. An apparatus as claimed in claim 82 or 83, wherein the operation of the height adjustment apparatus has the effect of artificially adjusting the level of the terrain surface beneath the cutter bar.

85. An apparatus as claimed in any one of claims 80 to 84, further comprising a pneumatic system comprising a plurality of pressurized cutter bar float gas bags spaced transversely along the cutter bar;
and wherein each of said plurality of paddles each comprises a pivot mechanism comprising a pivot arm mounted for pivotal movement relative to said main frame; wherein each said cutter bar float gas bag is mounted between said paddle device and a component of said main frame, wherein during a flex mode of operation said plurality of cutter bar float air bags are pressurized to a first pressure such when said cutter bar subjected to a downwardly directed force, said pivot arm pivots upward compressing said cutter bar float gas bag to compress said cutter bar gas bag thereby permitting flexing of said cutter bar in at least a region relative to said main frame.

86. An apparatus as claimed in any one of claims 50 to 85, further comprising a hydraulic fluid supply and control system operable to actuate said height adjustment apparatus to adjust the vertical separation distance of the unit support apparatus above the terrain surface.

87. An agricultural implement for use with a propulsion unit, said agricultural implement configured to be connected to said propulsion unit, said agricultural implement comprising:
a main frame having a main frame weight, said propulsion unit configured and operable to support at least a portion of said main frame weight;
an operational unit;
a unit support apparatus configured to interconnect said operational unit to said main frames;
a height adjustment apparatus comprising at least one terrain contact element, said height adjustment apparatus connected to said unit support apparatus, said at least one terrain contact element operable to be positioned to contact the terrain surface level at a terrain contact element contact region such that said at least one terrain contact element supports the unit support apparatus at a vertical separation distance of the unit support apparatus above the terrain surface, said height adjustment apparatus being operable to adjust the vertical separation distance of the unit support apparatus above the terrain surface, and thereby adjust the position of the operational unit to adjust a vertical separation distance of the operational unit above the terrain surface.

88. An agricultural apparatus comprising:
(c) a propulsion unit;
(d) an implement connected to said propulsion unit, said implement comprising:
(v) a main frame having a main frame weight, said propulsion unit configured and operable to support at least a portion of said main frame weight;
(vi) an operational unit;
(vii) a unit support apparatus configured to interconnect said operational unit to said main frame,
(viii) a height adjustment apparatus comprising at least one terrain contact element, said height adjustment apparatus connected to said unit support apparatus, said at least one terrain contact element operable to be positioned to contact the terrain surface level at a terrain contact element contact region such that said at least one terrain contact element supports the unit support apparatus at a first vertical separation distance of the unit support apparatus above the terrain surface and supports said operational unit at a second vertical separation distance above the terrain surface, said height adjustment apparatus being operable to adjust the first vertical separation distance of the unit support apparatus above the terrain surface, and thereby adjust the position of the operational unit to adjust the second vertical separation distance of the operational unit above the terrain surface.

89. A method of operating an agricultural apparatus, said agricultural apparatus comprising:
(a) a propulsion unit;
(b) an implement connected to said propulsion unit, said implement comprising:
(1) a main frame having a main frame weight, said propulsion unit configured and operable to support at least a portion of said main frame weight;
(2) an operational unit;
(3) a unit support apparatus configured to interconnect said operational unit to said main frame;
(4) a height adjustment apparatus comprising at least one terrain contact element, said height adjustment apparatus connected to said unit support apparatus, said at least one terrain contact element operable to be positioned to contact the terrain surface level at a terrain contact element contact region such that said at least one terrain contact element supports the unit support apparatus at a vertical separation distance of the unit support apparatus above the terrain surface, said height adjustment apparatus being operable to adjust the vertical separation distance of the unit support apparatus above the terrain surface, and thereby adjust the position of the operational unit to adjust a vertical separation distance of the operational unit above the terrain surface.
said method comprising operating the height adjustment apparatus to vary the vertical separation distance between the unit support apparatus above the terrain surface and thereby adjust a vertical separation distance between the operational unit and the terrain surface.

90. A method as claimed in claim 89, wherein said apparatus further comprises a frame height positioning system operable to control and adjust the height of said main frame relative to said propulsion unit.

91. A method as claimed in claim 90, wherein said method further comprises operating said frame height positioning system and said height adjustment apparatus contemporaneously.

92. A method as claimed in claim 89, wherein the operation of the height adjustment apparatus has the effect of artificially adjusting the level of the terrain surface beneath the operational unit.

93. An agricultural apparatus comprising:
i. a propulsion unit;
ii. an implement mounted on said propulsion unit, said implement comprising:
(a) a main frame having a main frame weight, said propulsion unit configured and operable to support at least a portion of said main frame weight;
(b) a terrain surface following apparatus comprising at least one terrain contact element having at least one terrain contact region, said terrain contact element being forced towards the terrain surface;
(c) a height adjustment apparatus comprising at least one terrain contact element, said at least one terrain contact element of said height adjustment apparatus having a terrain contact region operable to be positioned to contact the terrain surface level at a terrain contact location such that said terrain contact element of said height adjustment apparatus is operable to support said terrain contact element such that said least one terrain contact region of the terrain following apparatus is positioned at a vertical separation distance above the terrain surface, said height adjustment apparatus operable to adjust the magnitude of said vertical separation distance;
iii. a frame height positioning system operable to control and adjust the height of said main frame relative to said propulsion unit;
iv. a sensor system operable to provide sensor signals to the frame height positioning system dependent upon a position of the terrain contact element of the terrain surface following apparatus and indicative of the level of the terrain surface;
wherein said apparatus is operable:
to determine a height set point for said frame height positioning system;
using the height adjustment apparatus, adjust the position of the terrain contact element of the height adjustment apparatus in relation to the terrain surface such that the terrain contact region of the terrain contact element of the height adjustment apparatus follows the level of the terrain surface and the at least one terrain contact element region of the terrain following apparatus follows a path vertically offset from and above the path of the terrain contact element region of the height adjustment apparatus.

94. An apparatus as claimed in claim 93, wherein at least one terrain surface following apparatus comprises at least one transversely spaced, longitudinally oriented paddle, said at least one of paddle being rigidly interconnected to a transversely extending cutter bar proximate a forward end region and pivotally interconnected to said main frame proximate a rearward end region.

95. An apparatus as claimed in claim 94 wherein said sensor signals are dependent upon a pivot angle of the at least one paddle relative to a component of the main frame; and said paddle is pivotally interconnected to said main frame proximate an interior end region, said terrain surface following apparatus further comprising said at least one paddle having a paddle contact element.

96. A method of operating an agricultural apparatus, said agricultural apparatus comprising:
i. a propulsion unit;
ii. an implement mounted on said propulsion unit, said implement comprising:
(a) a main frame having a main frame weight, said propulsion unit configured and operable to support at least a portion of said main frame weight;
(b) a terrain surface following apparatus comprising at least one terrain contact element;
(c) a height adjustment apparatus comprising at least one terrain contact element, said at least one terrain contact element of said height adjustment apparatus operable to be positioned to contact the terrain surface level at a terrain contact location such that said terrain contact element of said height adjustment apparatus is operable to support said terrain contact element such that said least one terrain contact region is positioned at a vertical separation distance above the terrain surface, said height adjustment apparatus operable to adjust the magnitude of said vertical separation distance;
(d) a frame height positioning system operable to control and adjust the height of said main frame relative to said propulsion unit;
(e) a sensor system operable to provide sensor signals to the frame height positioning system dependent upon a position of the terrain contact element of the terrain following apparatus and indicative of the level of the terrain surface,
wherein said method comprises:
(I) establishing a height set point for said frame height positioning system of the position of the main frame relative to the propulsion unit;
(II) after having established the height set point, then using the height adjustment apparatus to adjust the height of the terrain contact region of the terrain contact element of the height adjustment apparatus above the terrain surface such that the terrain contact region of the terrain contact element of the height adjustment apparatus follows the level of the terrain surface and the terrain contact element of the terrain following apparatus follows a path vertically offset from and above the path of the terrain contact element of the height adjustment apparatus.

97. A method as claimed in claim 96, wherein (II) is performed while moving said implement with said propulsion unit to perform an agricultural operation, and while said frame height positioning system is seeking the height set point.

98. A method of operating an agricultural apparatus, said agricultural apparatus comprising:
i. a propulsion unit;
ii. an implement mounted on said propulsion unit, said implement comprising:
(a) a transversely extending main frame having a main frame weight, said propulsion unit configured and operable to support at least a portion of said main frame weight;
(b) a transversely extending cutter bar, said cutter bar comprising a plurality of cutting devices disposed transversely along said cutter bar and operable for cutting crop material, said cutter bar having a terrain contact surface region;
(c) a cutter bar support apparatus configured to interconnect said transversely extending cutter bar to said main frame, said cutter bar support apparatus comprising a plurality of transversely spaced, longitudinally oriented paddles, each of said paddles being rigidly interconnected to said transversely extending cutter bar proximate one distal end region and pivotally interconnected to said main frame proximate an interior end region;
(d) a height adjustment apparatus comprising at least one terrain contact element, said at least one terrain contact element of said height adjustment apparatus being operable to be positioned to contact the terrain surface level at a terrain contact location such that said terrain contact element will contact the terrain surface to support the cutter bar contact region at a vertical separation distance above the terrain surface, said height adjustment apparatus operable to adjust the magnitude of the vertical separation distance;
iii. a frame height positioning system operable to control and adjust the height of said main frame relative to said propulsion unit;
iv. a sensor system operable to provide signals to the frame height control positioning system indicative of the height of the cutter bar above the terrain surface, wherein said sensor signals are dependent upon the pivot angle of the paddles relative to a component of the main frame;
wherein said method comprises:
establishing a height set point for said frame height positioning system;
while the frame height positioning system is operating to move the main frame towards the height set point and maintain the height set point, then using the height adjustment apparatus to adjust the height of the terrain contact element relative to the terrain surface.

99. A method as claimed in claim 98 wherein said using of said height adjustment apparatus does not impact the operation of the frame height positioning system in seeking the height set point.

100. A method as claimed in claim 99 wherein said using of the height adjustment apparatus has the effect of artificially adjusting the level of the terrain surface beneath the cutter bar.

101. A method of operating an agricultural apparatus, said agricultural apparatus comprising:
i. a propulsion unit;
ii. an implement mounted on said propulsion unit, said implement comprising:
(a) a main frame having a main frame weight, said propulsion unit configured and operable to support at least a portion of said main frame weight;
(b) a terrain surface following apparatus comprising at least one terrain contact element;
(c) a height adjustment apparatus comprising at least one terrain contact element, said at least one terrain contact element of said height adjustment apparatus operable to be positioned to contact the terrain surface level at a terrain contact location such that said terrain contact element of said height adjustment apparatus is operable to support said terrain following apparatus such that said least one terrain contact element of said terrain surface following apparatus is positioned at a vertical separation distance above the terrain surface, said height adjustment apparatus being operable to adjust the magnitude of said vertical separation distance;
(d) a frame height positioning system operable to control and adjust the height of said main frame relative to said propulsion unit;
(e) a sensor system operable to provide sensor signals to the frame height positioning system dependent upon a position of the terrain contact element of the terrain following apparatus and indicative of the level of the terrain surface;
wherein said method comprises:
establishing a height set point for said frame height positioning system;
while the frame height positioning system is operating to move the main frame towards the height set point and maintain the height set point, then using the height adjustment apparatus to adjust the height of the terrain contact element of the height adjustment apparatus relative to the terrain surface.
